(19) United States
(12) Patent Application Publication
(10) Pub. No.: US 2023/0042328 A1
(43) Pub. Date: Feb. 9, 2023

(54) IONIC LIQUID FOR STABILIZING VISCOSITY OF SILICATE-BASED COATINGS

(71) Applicant: BASF SE, Ludwigshafen am Rhein (DE)

(72) Inventor: Ralf BOHLANDER, Düsseldorf-Holthausen (DE)

(21) Appl. No.: 17/785,066

(22) PCT Filed: Dec. 16, 2020
(86) PCT No.: PCT/EP2020/086323

§ 371 Date: Jun. 14, 2022

(30) Foreign Application Priority Data
Dec. 17, 2019 (EP) 19216808.6

(51) Int. Cl. C04B 28/26; C04B 28/00; C04B 24/12; C04B 14/30

(52) U.S. Cl. CPC C04B 28/26; C04B 28/001; C04B 24/128; C04B 14/305; C04B 2103/44

(57) ABSTRACT

The presently claimed invention relates to the use of ionic liquids for stabilizing the viscosity of an aqueous silicate-based coating composition and a method for stabilizing the composition thereof. The presently claimed invention is also directed to an aqueous composition comprising ionic liquids.

### FIELD OF THE INVENTION

The presently claimed invention relates to the use of ionic liquids for stabilizing the viscosity of an aqueous silicate-based coating composition and a method for stabilizing the composition thereof. The presently claimed invention is also directed to an aqueous composition comprising ionic liquids.

### BACKGROUND OF THE INVENTION

Coatings, such as paints, containing inorganic silicate-based binder are known to require little or no biocide and therefore are gaining prominence. Further, the compatibility of silicate-based paints or coatings provide good aqueous compatibility and therefore are economically feasible.

However, viscosity increase in silicate-based coating compositions is noted to be a critical issue, wherein the coating compositions are incapable of being processed. In this regard, stabilizers form a critical part of silicate-based coating compositions.

WO 2000/73237 A1 relates to materials such coatings containing silicate binder and one or more water-soluble nitrogen compound as stabilizer. The nitrogen compounds are selected from quaternized amines.

EP 1 222 234 B1 describes quaternary bishydroxylammonium salts as stabilizers. However, such hydroxide salts are highly toxic. Additionally, such compounds are typically used in the form of dilute formulations, thereby reducing their industrial processability.

US 2019/0177558 A1 relates to stabilizers for reducing the viscosity of silicate paints and 30 dispersion-based silicate paints. Said stabilizers mainly belong to the category of tertiary di-alkylglucamines.

EP 1 431 354 B1 reveals the use of tertiary amine compounds as viscosity stabilizers. Such compounds have low toxicity, however, the stabilization potential of these is markedly lower than the stabilization potential of quaternary ammonium salts.

Therefore, it is an object of the presently claimed invention to provide non-corrosive and easily available compounds that are capable of stabilizing the viscosity of aqueous coating compositions such as paints while being compatible with other commonly used components of aqueous coatings such as fillers and dispersants.

### SUMMARY OF THE INVENTION

Surprisingly, it was found that ionic liquids are capable of stabilizing the viscosity of a silicate-based aqueous coating composition, while being compatible with most commonly used components of aqueous coatings including fillers and dispersants.

Accordingly, the main aspect of the presently claimed invention is directed to the use of an ionic liquid for stabilizing the viscosity of an aqueous coating composition comprising at least one silicate binder, wherein the at least one ionic liquid is selected from the group consisting of
(IL1) salts of the general formula (I)

[A]ₚ^{m+}[Y]_{q}ⁿ⁻ (I),
wherein
   m, n, p, and q are each 1, 2, 3, or 4 and the product of p and m is equal to the product of q and n;
   [A]^{m+} is
   i) a monovalent, divalent, trivalent, or tetravalent cation selected from ammonium groups, oxonium groups, sulfonium groups, and phosphonium groups;
   or
   ii) a cationic compound comprising two or more cationic groups which are selected independently from ammonium groups, oxonium groups, sulfonium groups, and phosphonium groups; and
   [Y]ⁿ⁻ is a monovalent, divalent, trivalent, or tetravalent anion or a mixture of these anions;
(IL2) mixed salts of the general formulae (II.a), (II.b) or (II.c)

[A¹]⁺[A²]⁺[Y]ⁿ⁻ (II.a),
wherein n=2,

[A¹]⁺[A²]⁺[A³]⁺[Y]ⁿ⁻ (II.b),
wherein n=3,

[A¹]⁺[A²]⁺[A³]⁺[A⁴]⁺[Y]ⁿ⁻ (II.c),
wherein n=4, and
   wherein [A¹]⁺, [A²]⁺, [A³]⁺, and [A⁴]⁺ are monovalent cations selected from [A]^{m+}; and
   [Y]ⁿ⁻ is a monovalent, divalent, trivalent, or tetravalent anion or a mixture of these anions;
(IL3) mixed salts of the general formulae (III.a) to (III.h)

[A¹]²⁺[A²]⁺[Y]ⁿ⁻ (III.a),
wherein n=3,

[A¹]²⁺[A²]⁺[A³]⁺[Y]ⁿ⁻ (III.b),
wherein n=4,

[A¹]²⁺[A⁴]²⁺[Y]ⁿ⁻ (III.c),
wherein n=4,

[A⁵]³⁺[A²]⁺[Y]ⁿ⁻ (III.d),
wherein n=4,

[A¹]²⁺[A²]⁺[A³]⁺[A⁶]⁺[Y]ⁿ⁻ (III.e),
wherein n=5,

[A¹]²⁺[A⁴]²⁺[A⁶]⁺[Y]ⁿ⁻ (III.f),
wherein n=5,

[A⁵]³⁺[A²]⁺[A³]⁺[Y]ⁿ⁻ (III.g),
wherein n=5,

[A⁷]⁴⁺[A²]⁺[Y]ⁿ⁻ (III.h),
wherein n=5, and
   wherein [A¹]²⁺, [A²]⁺, [A³]⁺, [A⁴]²⁺, [A⁵]³⁺, [A⁶]⁺, and [A⁷]⁴⁺ are monovalent, divalent, trivalent or tetravalent cations selected from [A]^{m+}; and [Y]ⁿ⁻ is a monovalent, divalent, trivalent, or tetravalent anion; and
(IL4) mixed salts of the general formulae (IV.a) to (IV.j)

[A¹]⁺[A²]⁺[A³]⁺[M¹]⁺[Y]ⁿ⁻ (IV.a),
wherein n=4,

[A¹]⁺[A²]⁺[M¹]⁺[M²]⁺[Y]ⁿ⁻ (IV.b),
wherein n=4,

[A¹]⁺[M¹]⁺[M²]⁺[M³]⁺[Y]ⁿ⁻ (IV.c),
wherein n=4,

[A¹]⁺[A²]⁺[M¹]⁺[Y]ⁿ⁻ (IV.d),
wherein n=3,

[A¹]⁺[M¹]⁺[M²]⁺[Y]ⁿ⁻ (IV.e),
wherein n=3,

[A¹]⁺[M¹]⁺[Y]ⁿ⁻ (IV.f),
wherein n=2,

[A¹]⁺[A²]⁺[M⁴]²⁺[Y]ⁿ⁻ (IV.g),
wherein n=4,

[A¹]⁺[M¹]⁺[M⁴]²⁺[Y]ⁿ⁻ (IV.h),
wherein n=4,

[A¹]⁺[M⁵]³⁺[Y]ⁿ⁻ (IV.i),
wherein n=4,

[A¹]⁺[M⁴]²⁺[Y]ⁿ⁻ (IV.j),
wherein n=3, and

wherein [A¹]⁺, [A²]⁺, and [A³]⁺ are monovalent, divalent, trivalent, or tetravalent cations selected from [A]^{m+}; [Y]ⁿ⁻ is a monovalent, divalent, trivalent, or tetravalent anion; and [M¹]⁺, [M²]⁺, and [M³]⁺ are monovalent metal cations, [M⁴]²⁺ are divalent metal cations and [M⁵]³⁺ are trivalent metal cations.

In another aspect, the presently claimed invention provides a method for stabilizing the viscosity of an aqueous coating composition comprising at least one silicate binder and at least one white pigment, wherein the method comprises at least the step of adding to the aqueous coating composition, at least one ionic liquid selected from the group consisting of
(IL1) salts of the general formula (I)

[A]ₚ^{m+}[Y]_{q}ⁿ⁻ (I),
wherein
   m, n, p, and q are each 1, 2, 3, or 4 and the product of p and m is equal to the product of q and n;
   [A]^{m+} is
   i) a monovalent, divalent, trivalent, or tetravalent cation selected from ammonium groups, oxonium groups, sulfonium groups, and phosphonium groups;
   or
   ii) a cationic compound comprising two or more cationic groups which are selected independently from ammonium groups, oxonium groups, sulfonium groups, and phosphonium groups; and
   [Y]ⁿ⁻ is a monovalent, divalent, trivalent, or tetravalent anion or a mixture of these anions;
(IL2) mixed salts of the general formulae (II.a), (II.b) or (II.c)

[A¹]⁺[A²]⁺[Y]ⁿ⁻ (II.a),
wherein n=2,

[A¹]⁺[A²]⁺[A³]⁺[Y]ⁿ⁻ (II.b),
wherein n=3,

[A¹]⁺[A²]⁺[A³]⁺[A⁴]⁺[Y]ⁿ⁻ (II.c),
wherein n=4, and
   wherein [A¹]⁺, [A²]⁺, [A³]⁺ and [A⁴]⁺ are monovalent cations selected from [A]^{m+}; and [Y]ⁿ⁻ is a monovalent, divalent, trivalent, or tetravalent anion or a mixture of these anions;

(IL3) mixed salts of the general formulae (III.a) to (III.h)

[A¹]²⁺[A²]⁺[Y]ⁿ⁻ (III.a),
wherein n=3,

[A¹]²⁺[A²]⁺[A³]⁺[Y]ⁿ⁻ (III.b),
wherein n=4,

[A]²⁺[A⁴]²⁺[Y]ⁿ⁻ (III.c),
wherein n=4,

[A⁵]³⁺[A²]⁺[Y]ⁿ⁻ (III.d),
wherein n=4,

[A¹]²⁺[A²]⁺[A³]⁺[A⁶]⁺[Y]ⁿ⁻ (III.e),
wherein n=5,

[A¹]²⁺[A⁴]²⁺[A⁶]⁺[Y]ⁿ⁻ (III.f),
wherein n=5,

[A⁵]³⁺[A²]⁺[A³]⁺[Y]ⁿ⁻ (III.g),
wherein n=5,

[A⁷]⁴⁺[A²]⁺[Y]ⁿ⁻ (III.h),
wherein n=5, and
wherein [A¹]²′, [A²]⁺, [A³]-, [A⁴]²⁺, [A⁵]³⁺, [A⁶]⁺, and [A⁷]⁴⁺ are monovalent, divalent, trivalent, or tetravalent cations selected from [A]^{m+}; and [Y]ⁿ⁻ is a monovalent, divalent, trivalent, or tetravalent anion or a mixture of these anions; and
(IL4) mixed salts of the general formulae (IV.a) to (IV.j)

[A¹]⁺[A²]⁺[A³]⁺[M¹]⁺[Y]ⁿ⁻ (IV.a),
wherein n=4,

[A¹]⁺[A²]⁺[M¹]⁺[M²]⁺[Y]ⁿ⁻ (IV.b),
wherein n=4,

[A¹]⁺[M¹]⁺[M²]⁺[M³]⁺[Y]ⁿ⁻ (IV.c),
wherein n=4,

[A¹]⁺[A²]⁺[M¹]⁺[Y]ⁿ⁻ (IV.d),
wherein n=3,

[A¹]⁺[M¹]⁺[M²]⁺[Y]ⁿ⁻ (IV.e),
wherein n=3,

[A¹]⁺[M¹]⁺[Y]ⁿ⁻ (IV.f),
wherein n=2,

[A¹]⁺[A²]⁺[M⁴]²⁺[Y]ⁿ⁻ (IV.g),
wherein n=4,

[A¹]⁺[M¹]⁺[M⁴]²⁺[Y]ⁿ⁻ (IV.h),
wherein n=4,

[A¹]⁺[M⁵]³⁺[Y]ⁿ⁻ (IV.i),
wherein n=4,

[A¹]⁺[M⁴]²⁺[Y]ⁿ⁻ (IV.j),
wherein n=3, and

wherein [A]⁺, [A²]⁺, and [A³]⁺ are monovalent, divalent, trivalent, or tetravalent cations selected from [A]^{m+}; [Y]ⁿ⁻ is a monovalent, divalent, trivalent, or tetravalent anion or a mixture of these anions; and [M¹]⁺, [M²]⁺, and [M³]⁺ are monovalent metal cations, [M⁴]²⁺ are divalent metal cations and [M⁵]³⁺ are trivalent metal cations.

In yet another aspect, the presently claimed invention provides an aqueous composition comprising:
i) at least one ionic liquid selected from the group consisting of (IL1), (IL2), (IL3), and (IL4),
ii) at least one white pigment; and
iii) at least one silicate binder,
wherein
(IL1) salts of the general formula (I)

[A]ₚ^{m+}[Y]_{q}ⁿ⁻ (I),
wherein
m, n, p, and q are each 1, 2, 3, or 4 and the product of p and m is equal to the product of q and n;
[A]^{m+} is
i) a monovalent, divalent, trivalent, or tetravalent cation selected from ammonium groups, oxonium groups, sulfonium groups, and phosphonium groups;
or
ii) a cationic compound comprising two or more cationic groups which are selected independently from ammonium groups, oxonium groups, sulfonium groups, and phosphonium groups; and
[Y]⁺ is a monovalent, divalent, trivalent, or tetravalent anion or a mixture of these anions;
(IL2) mixed salts of the general formulae (II.a), (II.b) or (II.c)

[A¹]⁺[A²]⁺[Y]ⁿ⁻ (II.a),
wherein n=2,

[A¹]⁺[A²]⁺[A³]⁺[Y]ⁿ⁻ (II.b),
wherein n=3,

[A¹]⁺[A²]⁺[A³]⁺[A⁴]⁺[Y]ⁿ⁻ (II.c),
wherein n=4, and
wherein [A¹]⁺, [A²]⁺, [A³]⁺ and [A⁴]⁺ is are monovalent cations selected from [A]^{m+}; and [Y]ⁿ⁻ is a monovalent, divalent, trivalent, or tetravalent anion or a mixture of these anions;
(IL3) mixed salts of the general formulae (III.a) to (III.h)

[A¹]²⁺[A²]⁺[Y]ⁿ⁻ (III.a),
wherein n=3,

[A¹]²⁺[A²]⁺[A³]⁺[Y]ⁿ⁻ (II.b),
wherein n=4,

[A¹]²⁺[A⁴]²⁺[Y]ⁿ⁻ (III.c),
wherein n=4,

[A⁵]³⁺[A²]⁺[Y]ⁿ⁻ (III.d),
wherein n=4,

[A¹]²⁺[A²]⁺[A³]⁺[A⁶]⁺[Y]ⁿ⁻ (III.e),
wherein n=5,

[A¹]²⁺[A⁴]²⁺[A⁶]⁺[Y]ⁿ⁻ (III.f),
wherein n=5,

[A⁵]³⁺[A²]⁺[A³]⁺[Y]ⁿ⁻ (III.g),
wherein n=5,

[A⁷]⁴⁺[A²]⁺[Y]ⁿ⁻ (III.h),
wherein n=5, and
wherein [A¹]²⁺, [A²]⁺, [A³]⁺, [A⁴]²⁺, [A⁵]³⁺, [A⁶]⁺, and [A⁷]⁴⁺ are monovalent, divalent, trivalent, or tetravalent cations selected from [A]^{m+}; and [Y]ⁿ⁻ is a monovalent, divalent, trivalent, or tetravalent anion or a mixture of these anions; and
(IL4) mixed salts of the general formulae (IV.a) to (IV.j)

[A¹]⁺[A²]⁺[A³]⁺[M¹]⁺[Y]ⁿ⁻ (IV.a),
wherein n=4,

[A¹]⁺[A²]⁺[M¹]⁺[M²]⁺[Y]ⁿ⁻ (IV.b),
wherein n=4,

[A¹]⁺[M¹]⁺[M²]⁺[M³]⁺[Y]ⁿ⁻ (IV.c),
wherein n=4,

[A¹]⁺[A²]⁺[M¹]⁺[Y]ⁿ⁻ (IV.d),
wherein n=3,

[A¹]⁺[M¹]⁺[M²]⁺[Y]ⁿ⁻ (IV.e),
wherein n=3,

[A¹]⁺[M¹]⁺[Y]ⁿ⁻ (IV.f),
wherein n=2,

[A¹]⁺[A²]⁺[M⁴]²⁺[Y]ⁿ⁻ (IV.g),
wherein n=4,

[A¹]⁺[M¹]⁺[M⁴]²⁺[Y]ⁿ⁻ (IV.h),
wherein n=4,

[A¹]⁺[M⁵]³⁺[Y]ⁿ⁻ (IV.i),
wherein n=4,

[A¹]⁺[M⁴]²⁺[Y]ⁿ⁻ (IV.j),
wherein n=3, and

wherein [A¹]⁺, [A²]⁺, and [A³]⁺ are monovalent, divalent, trivalent or tetravalent cations selected from [A]^{m+}; [Y]ⁿ⁻ is a monovalent, divalent, trivalent, or tetravalent anion or a mixture of these anions; and [M¹]⁺, [M²]⁺, and [M³]⁺ are monovalent metal cations, [M⁴]²⁺ are divalent metal cations and [M⁵]³⁺ are trivalent metal cations.

### DETAILED DESCRIPTION

Before the present compositions and formulations of the presently claimed invention are described, it is to be understood that this invention is not limited to particular compositions and formulations described, since such compositions and formulation may, of course, vary. It is also to be understood that the terminology used herein is not intended to be limiting, since the scope of the presently claimed invention will be limited only by the appended claims.

If hereinafter a group is defined to comprise at least a certain number of embodiments, this is meant to also encompass a group which preferably consists of these embodiments only. Furthermore, the terms ‘first’, ‘second’, ‘third’ or ‘i’, ‘ii’, ‘iii’, etc. and the like in the description and in the claims, are used for distinguishing between similar elements and not necessarily for describing a sequential or chronological order. It is to be understood that the terms so used are interchangeable under appropriate circumstances and that the embodiments of the presently claimed invention described herein are capable of operation in other sequences than described or illustrated herein. In case the terms ‘first’, ‘second’, ‘third’ or ‘(A)’, ‘(B)’ and ‘(C)’ or ‘(a)’, ‘(b)’, ‘(c)’, ‘(d)’, ‘i’, ‘ii’ etc. relate to steps of a method or use or assay there is no time or time interval coherence between the steps, that is, the steps may be carried out simultaneously or there may be time intervals of seconds, minutes, hours, days, weeks, months or even years between such steps, unless otherwise indicated in the application as set forth herein above or below.

Furthermore, the ranges defined throughout the specification include the end values as well, i.e. a range of 10 to 50 implies that both 10 and 50 are included in the range. For the avoidance of doubt, applicant shall be entitled to any equivalents according to applicable law. Further, the value selectable within the range need not be only integers such as 12, 14, 45, 48, and so on, but also non-integral numbers such as 12.5, 14.2, 45.2, 48.5, and so on.

In the following passages, different aspects of the presently claimed invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

Reference throughout this specification to ‘one embodiment’ or ‘an embodiment’ means that a particular feature, structure or characteristic described in connection with the embodiment is included in at least one embodiment of the presently claimed invention. Thus, appearances of the phrases ‘in one embodiment’ or ‘in an embodiment’ in various places throughout this specification are not necessarily all referring to the same embodiment, but may refer to the same embodiment. Further, as used in the following, the terms “preferably”, “more preferably”, “even more preferably”, “most preferably” and “in particular” or similar terms are used in conjunction with optional features, without restricting alternative possibilities. Thus, features introduced by these terms are optional features and are not intended to restrict the scope of the claims in any way.

Furthermore, the particular features, structures or characteristics may be combined in any suitable manner, as would be apparent to a person skilled in the art from this disclosure, in one or more embodiments. Furthermore, while some embodiments described herein include some, but not other features included in other embodiments, combinations of features of different embodiments are meant to be within the scope of the presently claimed invention, and form different embodiments, as would be understood by those in the art. For example, in the appended claims, any of the claimed embodiments can be used in any combination.

Further, it shall be noted that the terms “at least one”, “one or more” or similar expressions indicating that a feature or element may be present once or more than once typically will be used only once when introducing the respective feature or element. In the following, in most cases, when referring to the respective feature or element, the expressions “at least one” or “one or more” will not be repeated, non-withstanding the fact that the respective feature or element may be present once or more than once.

As mentioned above, the stabilization of silicate-based compositions is typically done using alkaline quaternary hydroxides, which are hazardous and often corrosive. Also, these compounds are used in the form of dilute aqueous solutions, since any increase in strength can lead to unwanted increase in viscosity. However, the usage of dilute solutions leads to an increased cost of processing. Surprisingly, it was found that ionic liquids were capable of stabilizing the viscosity of silicate binder-based aqueous coating compositions. The viscosity*stabilization was found to be comparable to traditional alkaline quaternary hydroxides, however, the ionic liquids only have limited or no hazard classification, thereby making them a non-toxic and environmentally benign choice for the use in paints among others.

Accordingly, one aspect of the presently claimed invention is embodiment 1, which is directed to the use of an ionic liquid for stabilizing the viscosity of an aqueous coating composition comprising at least one silicate binder, wherein the at least one ionic liquid is selected from the group consisting of
(IL1) salts of the general formula (I)

[A]ₚ^{m+}[Y]_{q}ⁿ⁻ (I),
wherein
m, n, p, and q are each 1, 2, 3, or 4 and the product of p and m is equal to the product of q and n;
[A]^{m+} is
i) a monovalent, divalent, trivalent, or tetravalent cation selected from ammonium groups, oxonium groups, sulfonium groups, and phosphonium groups;
or
ii) a cationic compound comprising two or more cationic groups which are selected independently from ammonium groups, oxonium groups, sulfonium groups, and phosphonium groups; and
[Y]ⁿ⁻ is a monovalent, divalent, trivalent, or tetravalent anion or a mixture of these anions;
(IL2) mixed salts of the general formulae (II.a), (II.b) or (II.c)

[A¹]⁺[A²]⁺[Y]ⁿ⁻ (II.a),
wherein n=2,

[A¹]⁺[A²]⁺[A³]⁺[Y]ⁿ⁻ (II.b),
wherein n=3,

[A¹]⁺[A²]⁺[A³]⁺[A⁴]⁺[Y]ⁿ⁻ (II.c),
wherein n=4, and
wherein [A¹]⁺, [A²]⁺, [A³], and [A⁴]⁺ are monovalent cations selected from [A]^{m+}; and
[Y]ⁿ⁻ is a monovalent, divalent, trivalent, or tetravalent anion or a mixture of these anions;
(IL3) mixed salts of the general formulae (III.a) to (III.h)

[A¹]²⁺[A²]⁺[Y]ⁿ⁻ (III.a),
wherein n=3,

[A¹]²⁺[A²]⁺[A³]⁺[Y]ⁿ⁻ (III.b),
wherein n=4,

[A¹]²⁺[A⁴]²⁺[Y]ⁿ⁻ (III.c),
wherein n=4,

[A⁵]³⁺[A²]⁺[Y]ⁿ⁻ (III.d),
wherein n=4,

[A¹]²⁺[A²]⁺[A³]⁺[A⁶]⁺[Y]ⁿ⁻ (III.e),
wherein n=5,

[A¹]²⁺[A⁴]²⁺[A⁶]⁺[Y]ⁿ⁻ (III.f),
wherein n=5,

[A⁵]³⁺[A²]⁺[A³]⁺[Y]ⁿ⁻ (III.g),
wherein n=5,

[A⁷]⁴⁺[A²]⁺[Y]ⁿ⁻ (III.h),
wherein n=5, and
wherein [A¹]²⁺, [A²]⁺, [A³]⁺, [A⁴]²⁺, [A⁵]³⁺, [A⁶]⁺, and [A⁷]⁴⁺ are monovalent, divalent, trivalent or tetravalent cations selected from [A]^{m+}; and [Y]ⁿ⁻ is a monovalent, divalent, trivalent, or tetravalent anion; and
(IL4) mixed salts of the general formulae (IV.a) to (IV.j)

[A¹]⁺[A²]⁺[A³]⁺[M¹]⁺[Y]ⁿ⁻ (IV.a),
wherein n=4,

[A¹]⁺[A²]⁺[M¹]⁺[M²]⁺[Y]ⁿ⁻ (IV.b),
wherein n=4,

[A¹]⁺[M¹]⁺[M²]⁺[M³]⁺[Y]ⁿ⁻ (IV.c),
wherein n=4,

[A¹]⁺[A²]⁺[M¹]⁺[Y]ⁿ⁻ (IV.d),
wherein n=3,

[A¹]⁺[M¹]⁺[M²]⁺[Y]ⁿ⁻ (IV.e),
wherein n=3,

[A¹]⁺[M¹]⁺[Y]ⁿ⁻ (IV.f),
wherein n=2,

[A¹]⁺[A²]⁺[M⁴]²⁺[Y]ⁿ⁻ (IV.g),
wherein n=4,

[A¹]⁺[M¹]⁺[M⁴]²⁺[Y]ⁿ⁻ (IV.h),
wherein n=4,

[A¹]⁺[M⁵]³⁺[Y]ⁿ⁻ (IV.i),
wherein n=4,

[A¹]⁺[M⁴]²⁺[Y]ⁿ⁻ (IV.j),
wherein n=3, and

wherein [A¹]⁺, [A²]⁺, and [A³]⁺ are monovalent, divalent, trivalent, or tetravalent cations selected from [A]^{m+}; [Y]ⁿ⁻ is a monovalent, divalent, trivalent, or tetravalent anion; and [M¹]⁺, [M²]⁺, and [M³]⁺ are monovalent metal cations, [M⁴]²⁺ are divalent metal cations and [M⁵]³⁺ are trivalent metal cations.

Another aspect of the presently claimed invention is embodiment 2 which is directed to a method for stabilizing the viscosity of an aqueous coating composition comprising at least one silicate binder and at least one white pigment, wherein the method comprises at least the step of adding to the aqueous coating composition, at least one ionic liquid of embodiment 1, selected from the group consisting of
(IL1) salts of the general formula (I)

[A]ₚ^{m+}[Y]_{q}ⁿ⁻ (I),
wherein
m, n, p, and q are each 1, 2, 3, or 4 and the product of p and m is equal to the product of q and n;
[A]^{m+} is
i) a monovalent, divalent, trivalent, or tetravalent cation selected from ammonium groups, oxonium groups, sulfonium groups, and phosphonium groups; or
ii) a cationic compound comprising two or more cationic groups which are selected independently from ammonium groups, oxonium groups, sulfonium groups, and phosphonium groups; and
[Y]ⁿ⁻ is a monovalent, divalent, trivalent, or tetravalent anion or a mixture of these anions;
(IL2) mixed salts of the general formulae (II.a), (II.b) or (II.c)

[A¹]⁺[A²]⁺[Y]ⁿ⁻ (II.a),
wherein n=2,

[A¹]⁺[A²]⁺[A³]⁺[Y]ⁿ⁻ (II.b),
wherein n=3,

[A¹]⁺[A²]⁺[A³]⁺[A⁴]⁺[Y]ⁿ⁻ (II.c),
wherein n=4, and
wherein [A¹]⁺, [A²]⁺, [A³]⁺ and [A⁴]⁺ are monovalent cations selected from [A]^{m+}; and [Y]ⁿ⁻ is a monovalent, divalent, trivalent, or tetravalent anion or a mixture of these anions;
(IL3) mixed salts of the general formulae (III.a) to (III.h)

[A¹]²⁺[A²]⁺[Y]ⁿ⁻ (III.a),
wherein n=3,

[A¹]²⁺[A²]⁺[A³]⁺[Y]ⁿ⁻ (III.b),
wherein n=4,

[A¹]²⁺[A⁴]²⁺[Y]ⁿ⁻ (III.c),
wherein n=4,

[A⁵]³⁺[A²]⁺[Y]ⁿ⁻ (III.d),
wherein n=4,

[A¹]²⁺[A²]⁺[A³]⁺[A⁶]⁺[Y]ⁿ⁻ (III.e),
wherein n=5,

[A¹]²⁺[A⁴]²⁺[A⁶]⁺[Y]ⁿ⁻ (III.f),
wherein n=5,

[A⁵]³⁺[A²]⁺[A³]⁺[Y]ⁿ⁻ (III.g),
wherein n=5,

[A⁷]⁴⁺[A²]⁺[Y]ⁿ⁻ (III.h),
wherein n=5, and
wherein [A¹]²⁺, [A²]⁺, [A³]⁺, [A⁴]²⁺, [A⁵]³⁺, [A⁶]⁺, and [A⁷]⁴⁺ are monovalent, divalent, trivalent, or tetravalent cations selected from [A]^{m+}; and [Y]ⁿ⁻ is a monovalent, divalent, trivalent, or tetravalent anion or a mixture of these anions; and
(IL4) mixed salts of the general formulae (IV.a) to (IV.j)

[A¹]⁺[A²]⁺[A³]⁺[M¹]⁺[Y]ⁿ⁻ (IV.a),
wherein n=4,

[A¹]⁺[A²]⁺[M¹]⁺[M²]⁺[Y]ⁿ⁻ (IV.b),
wherein n=4,

[A¹]⁺[M¹]⁺[M²]⁺[M³]⁺[Y]ⁿ⁻ (IV.c),
wherein n=4,

[A¹]⁺[A²]⁺[M¹]⁺[Y]ⁿ⁻ (IV.d),
wherein n=3,

[A¹]⁺[M¹]⁺[M²]⁺[Y]ⁿ⁻ (IV.e),
wherein n=3,

[A¹]⁺[M¹]⁺[Y]ⁿ⁻ (IV.f),
wherein n=2,

[A¹]⁺[A²]⁺[M⁴]²⁺[Y]ⁿ⁻ (IV.g),
wherein n=4,

[A¹]⁺[M¹]⁺[M⁴]²⁺[Y]ⁿ⁻ (IV.h),
wherein n=4,

[A¹]⁺[M⁵]³⁺[Y]ⁿ⁻ (IV.i),
wherein n=4,

[A¹]⁺[M⁴]²⁺[Y]ⁿ⁻ (IV.j),
wherein n=3, and

wherein [A¹]⁺, [A²]⁺, and [A³]⁺ are monovalent, divalent, trivalent, or tetravalent cations selected from [A]^{m+}; [Y]ⁿ⁻ is a monovalent, divalent, trivalent, or tetravalent anion or a mixture of these anions; and [M¹]⁺, [M²]⁺, and [M³]⁺ are monovalent metal cations, [M⁴]²⁺ are divalent metal cations and [M⁵]³⁺ are trivalent metal cations.

Within the context of the presently claimed invention, the term “ionic liquid”, as used herein, refers to organic salts which are liquid at temperatures below 180° C. In general, the melting points of the ionic liquids are in the range from −50° C. to 180° C., preferably in the range from −20° C. to 100° C., in particular in the range from −10° C. to 70° C. and especially in the range from 0° C. to 30° C.

Cations and anions are present in the ionic liquids. Here, a proton or an alkyl radical can be transferred from the cation to the anion in an ionic liquid, resulting in two uncharged molecules. An equilibrium of anions, cations and uncharged molecules formed therefrom can thus be present in the ionic liquids used according to the presently claimed invention.

The term “alkyl”, as used herein, comprises linear or branched alkyl. The alkyl group is preferably linear or branched C₁-C₃₀-alkyl, in particular C₁-C₁₂-alkyl and very particularly preferably C₁-C₅-alkyl. Examples of alkyl groups are, in particular, methyl, ethyl, n-propyl, isopropyl, n-butyl, Isobutyl, sec-butyl, tert-butyl, n-pentyl, isopentyl, 1-methylbutyl, tert-pentyl, neopentyl, n-hexyl, 3-hexyl, 2-methyl-1-pentyl, 3-methyl-1-pentyl, 4-methyl-1-pentyl, 2-methyl-2-pentyl, 3-methyl-2-pentyl, 4-methyl-2-pentyl, 2-methyl-3-pentyl, 3-methyl-3-pentyl, 2,2-dimethyl-1-butyl, 2,3-dimethyl-1-butyl, 3,3-dimethyl-1-butyl, 2-ethyl-1-butyl, 2,3-dimethyl-2-butyl, 3,3-dimethyl-2-butyl, n-heptyl, n-octyl, 1-methylheptyl, 2-ethylhexyl, 2,4,4-trimethylpentyl, 1,1,3,3-tetramethylbutyl, n-nonyl, n-decyl, n-undecyl, n-dodecyl, n-tridecyl, ntetradecyl, n-pentadecyl, n-hexadecyl, n-heptadecyl, n-octadecyl and n-eicosyl.

The term alkyl also comprises alkyl radicals whose carbon chain can be interrupted by one or more nonadjacent heteroatoms or heteroatom comprising groups which are preferably selected from among —O—, —S—, —NR^{a}—, —PR^{a}—, —SiR^{a}R^{aa}—, —OSi(R^{a})(R^{aa})—, —OSi(R^{a})(R^{aa})O—, —SO₂—, —SO₄— and/or —OP(═O)(OR^{a})O—. R^{a} is preferably hydrogen, alkyl, cycloalkyl, heterocycloalkyl, aryl or hetaryl. R^{aa} is preferably hydrogen, alkyl, cycloalkyl, heterocycloalkyl or aryl.

Examples of alkyl radicals whose carbon chains are interrupted by one or two nonadjacent heteroatoms —O— are the following: methoxymethyl, diethoxymethyl, 2-methoxyethyl, 2-ethoxyethyl, 2-propoxyethyl, diethoxyethyl, 2-butoxyethyl, 2-octyloxyethyl, 2-methoxypropyl, 3-methoxypropyl, 3-ethoxypropyl, 3-propoxypropyl, 2-isopropoxyethyl, 2-butoxypropyl, 3-butoxypropyl, 4-methoxybutyl, 4-ethoxybutyl, 4-propoxybutyl, 6-methoxyhexyl, 3,6-dioxaheptyl (5-methoxy-3-oxapentyl), 3,6-dioxaoctyl (7-methoxy-4-oxaheptyl), 4,8-dioxanonyl (7-methoxy-4-oxaheptyl), 3,7-dioxaoctyl, 3,7-dioxanonyl, 4,7-dioxaoctyl, 4,7-dioxanonyl, 2- and 4-butoxybutyl, 4,8-dioxadecyl, 9-ethoxy-5-oxa-nonyl.

Examples of alkyl radicals whose carbon chains are interrupted by three or more than three nonadjacent heteroatoms —O— are also oligooxyalkylenes and polyoxyalkylenes, i.e. compounds having repeating units which are preferably selected from among (CH₂CH₂O)ₓ₁, (CH(CH₃)CH₂O)ₓ₂ and ((CH₂)₄O)ₓ₃, where x1, x2 and x3 are each, independently of one another, an integer from 3 to 100, preferably from 3 to 80. The sum of x1, x2 and x3 is an integer from 3 to 300, in particular from 3 to 100. In polyoxyalkylenes which have two or three different repeating units, the order is immaterial, i.e. the repeating units can be arranged randomly, alternately or in blocks. Examples are 3,6,9-trioxadecyl, 3,6,9-trioxaundecyl, 3,6,9-trioxadodecyl, 4,8,12-trioxatridecyl (11-methoxy-4,8-dioxaundecyl), 4,8,12-trioxatetradecyl, 14-methoxy-5,10-dioxatetradecyl, 5,10,15-trioxaheptadecyl, 3,6,9,12-tetraoxatridecyl, 3,6,9,12-tetraoxatetradecyl, 4,8,12,16-tetraoxaheptadecyl (15-methoxy-4,8,12-trioxa-pentadecyl), 4,8,12,16-tetraoxaoctadecyl and the like.

Examples of alkyl radicals whose carbon chains are interrupted by one or more, e.g. 1, 2, 3, 4 or more than 4, nonadjacent heteroatoms —S— are the following: butylthiomethyl, 2-methylthioethyl, 2-ethylthioethyl, 2-propylthioethyl, 2-butylthioethyl, 2-dodecylthioethyl, 3-methylthiopropyl, 3-ethylthiopropyl, 3-propylthiopropyl, 3-butylthiopropyl, 4-methylthiobutyl, 4-ethylthiobutyl, 4-propylthiobutyl, 3,6-dithiaheptyl, 3,6-dithiaoctyl, 4,8-dithianonyl, 3,7-dithiaoctyl, 3,7-dithianonyl, 2- and 4-butylthiobutyl, 4,8-dithiadecyl, 3,6,9-trithiadecyl, 3,6,9-trithiaundecyl, 3,6,9-trithiadodecyl, 3,6,9,12-tetrathiatridecyl and 3,6,9,12-tetrathiatetradecyl.

Examples of alkyl radicals whose carbon chains are interrupted by one or two nonadjacent heteroatom-comprising groups —NR^{a}— are the following: 2-monomethyl- and 2-monoethylaminoethyl, 2-dimethylaminoethyl, 3-methylaminopropyl, 2- and 3-dimethylaminopropyl, 3-monoisopropylaminopropyl, 2- and 4-monopropylaminobutyl, 2- and 4-dimethylaminobutyl, 6-methylaminohexyl, 6-dimethylaminohexyl, 6-methyl-3,6-diazaheptyl, 3,6-dimethyl-3,6-diazaheptyl, 3,6-diazaoctyl and 3,6-dimethyl-3,6-diazaoctyl.

Examples of alkyl radicals whose carbon chains are interrupted by three or more than three nonadjacent heteroatom-comprising groups —NR^{a}— are also oligoalkyleneimines and polyalkyleneimines. What has been said above with regard to polyoxyalkylenes applies analogously to polyalkyleneimines, with the oxygen atom being in each case replaced by an NR^{a} group in which R^{a} is preferably hydrogen or C₁-C₄-alkyl. Examples are 9-methyl-3,6,9-triazadecyl, 3,6,9-trimethyl-3,6,9-triazadecyl, 3,6,9-triazaundecyl, 3,6,9-trimethyl-3,6,9-triazaundecyl, 12-methyl-3,6,9,12-tetraazatridecyl, 3,6,9,12-tetramethyl-3,6,9,12-tetraazatridecyl and the like.

Examples of alkyl radicals whose carbon chains are interrupted by one or more, e.g. 1 or 2, nonadjacent groups —SO₂— are 2-methylsulfonylethyl, 2-ethylsulfonylethyl, 2-propylsulfonylethyl, 2-isopropylsulfonylethyl, 2-butylsulfonylethyl, 2-methylsulfonylpropyl, 3-methylsulfonylpropyl, 2-ethylsulfonylpropyl, 3-ethylsulfonylpropyl, 2-propylsulfonylpropyl, 3-propylsulfonylpropyl, 2-butylsulfonylpropyl, 3-butylsulfonylpropyl, 2-methylsulfonylbutyl, 4-methylsulfonylbutyl, 2-ethylsulfonylbutyl, 4-ethylsulfonylbutyl, 2-propylsulfonylbutyl, 4-propylsulfonylbutyl and 4-butylsulfonylbutyl.

The term alkyl also comprises substituted alkyl radicals. Substituted alkyl groups can have, depending on the length of the alkyl chain, one or more (e.g. 1, 2, 3, 4, 5 or more than 5) substituents. These are preferably selected independently from among cycloalkyl, cycloalkyloxy, polycyclyl, polycyclyloxy, heterocycloalkyl, aryl, aryloxy, arylthio, hetaryl, halogen, hydroxy, SH, ═O, ═S, ═NR^{a}, COOH, carboxylate, SO₃H, sulfonate, NE¹E², nitro and cyano, where E¹ and E² are each, independently of one another, hydrogen, alkyl, cycloalkyl, heterocycloalkyl, aryl or hetaryl. Cycloalkyl, cycloalkyloxy, polycycloalkyl, polycycloalkyloxy, heterocycloalkyl, aryl and hetaryl substituents of the alkyl groups may in turn be unsubstituted or substituted; suitable substituents are those mentioned below for these groups.

What has been said above with regard to alkyl also applies in principle to the alkyl parts of alkoxy, alkylamino, dialkylamino, alkylthio (alkylsulfanyl), alkylsulfinyl, alkylsulfonyl, etc.

Suitable substituted alkyl radicals are the following:
alkyl which is substituted by carboxy, e.g. carboxymethyl, 2-carboxyethyl, 3-carboxypropyl, 4-carboxybutyl, 5-carboxypentyl, 6-carboxyhexyl, 7-carboxyheptyl, 8-carboxyoctyl, 9-carboxynonyl, 10-carboxydecyl, 12-carboxydodecyl and 14-carboxytetradecyl;

alkyl which is substituted by SO₃R, where R is H, a cation equivalent or an alkyl radical. Examples of SO₃R-substituted alkyl are sulfomethyl, 2-sulfoethyl, 3-sulfopropyl, 4-sulfobutyl, 5-sulfopentyl, 6-sulfohexyl, 7-sulfoheptyl, 8-sulfooctyl, 9-sulfononyl, 10-sulfodecyl, 12-sulfododecyl, 14-sulfotetradecyl, methylsulfomethyl, methylsulfopropyl and sodium sulfoethyl; where a cation equivalent is, for the purposes of the invention, a monovalent cation or the part of a polyvalent cation corresponding to a single positive charge. The cation M+ serves merely as counter ion to neutralize the sulfonate group and can in principle be selected freely. Preference is therefore given to using alkali metal ions, in particular Na+, K+−, Li+ ions, or onium ions such as ammonium, monoalkylammonium, dialkylammonium, trialkylammonium, tetraalkylammonium, phosphonium, tetraalkylphosphonium or tetraarylphosphonium ions; alkyl which is substituted by carboxylate, for example alkoxycarbonylalkyl, e.g. methoxycarbonylmethyl, ethoxycarbonylmethyl, n-butoxycarbonylmethyl, 2-methoxycarbonylethyl, 2-ethoxycarbonylethyl, 2-methoxycarbonylpropyl, 2-ethoxycarbonylpropyl, 2-(n-butoxycarbonyl)propyl, 2-(4-n-butoxycarbonyl)propyl, 3-methoxycarbonylpropyl, 3-ethoxycarbonylpropyl, 3-(n-butoxycarbonyl)propyl, 3-(4-n-butoxycarbonyl)propyl, aminocarbonylalkyl, e.g. aminocarbonylmethyl, aminocarbonylethyl, aminocarbonylpropyl and the like, alkylaminocarbonylalkyl such as methylaminocarbonylmethyl, methylaminocarbonylethyl, ethylcarbonylmethyl, ethylcarbonylethyl and the like or dialkylaminocarbonylalkyl such as dimethylaminocarbonylmethyl, dimethylaminocarbonylethyl, dimethylcarbonylpropyl, diethylaminocarbonylmethyl, diethylaminocarbonylethyl, diethylcarbonylpropyl and the like;

alkyl which is substituted by hydroxyl, e.g. 2-hydroxyethyl, 2-hydroxypropyl, 3-hydroxypropyl, 3-hydroxybutyl, 4-hydroxybutyl, 2-hydroxy-2,2-dimethylethyl, 5-hydroxy-3-oxapentyl, 6-hydroxyhexyl, 7-hydroxy-4-oxaheptyl, 8-hydroxy-4-oxaoctyl, 8-hydroxy-3,6-dioxaoctyl, 9-hydroxy-5-oxanonyl, 11-hydroxy-4,8-dioxaundecyl, 11-hydroxy-3,6,9-trioxaundecyl, 14-hydroxy-5,10-dioxatetradecyl, 15-hydroxy-4,8,12-trioxapentadecyl and the like; alkyl which is substituted by amino, e.g. 2-aminoethyl, 2-aminopropyl, 3-aminopropyl, 4-aminobutyl, 6-aminohexyl and the like.

alkyl which is substituted by cyano, e.g. 2-cyanoethyl, 3-cyanopropyl, 3-cyanobutyl and 4-cyanobutyl;

alkyl which is substituted by halogen as defined below, where the hydrogen atoms in the alkyl group can be partly or completely replaced by halogen atoms, for example C₁-C₁₈-fluoroalkyl, e.g. trifluoromethyl, difluoromethyl, fluoromethyl, pentafluoroethyl, heptafluoropropyl, heptafluoroisopropyl, nonafluorobutyl, nonafluoroisobutyl, undecylfluoropentyl, undecylfluoroisopentyl and the like, C₁-C₁₈-chloroalkyl, e.g. chloromethyl, dichloromethyl, trichloromethyl, 2-chloroethyl, 2- and 3-chloropropyl, 2-, 3- and 4-chlorobutyl, 1,1-dimethyl-2-chloroethyl and the like, C₁-C₁₈-bromoalkyl, e.g. bromoethyl, 2-bromoethyl, 2- and 3-bromopropyl and 2-, 3- and 4-bromobutyl and the like;

alkyl which is substituted by nitro, e.g. 2-nitroethyl, 2- and 3-nitropropyl and 2-, 3- and 4-nitrobutyl and the like;

alkyl which is substituted by amino, e.g. 2-aminoethyl, 2-aminopropyl, 3-aminopropyl, 4-aminobutyl, 6-aminohexyl and the like;

alkyl which is substituted by cycloalkyl, e.g. cyclopentylmethyl, 2-cyclopentylethyl, 3-cyclopentylpropyl, cyclohexylmethyl, 2-cyclohexylethyl, 3-cyclohexylpropyl and the like; alkyl which is substituted by ═O (oxo group), e.g. 2-oxopropyl, 2-oxobutyl, 3-oxobutyl, 1-methyl-2-oxopropyl, 2-oxopentyl, 3-oxopentyl, 1-methyl-2-oxobutyl, 1-methyl-3-oxobutyl, 2-oxohexyl, 3-oxohexyl, 4-oxohexyl, 2-oxoheptyl, 3-oxoheptyl, 4-oxoheptyl, 4-oxoheptyl and the like;

alkyl which is substituted by ═S (thioxo group), e.g. 2-thioxopropyl, 2-thioxobutyl, 3-thioxobutyl, 1-methyl-2-thioxopropyl, 2-thioxopentyl, 3-thioxopentyl, 1-methyl-2-thioxobutyl, 1-methyl-3-thioxobutyl, 2-thioxohexyl, 3-thioxohexyl, 4-thioxohexyl, 2-thioxoheptyl, 3-thioxoheptyl, 4-thioxoheptyl, 4-thioxoheptyl and the like;

alkyl which is substituted by ═NR^{a}—, preferably one in which R^{a} is hydrogen or C₁-C₄-alkyl, e.g. 2-iminopropyl, 2-iminobutyl, 3-iminobutyl, 1-methyl-2-iminopropyl, 2-iminopentyl, 3-iminopentyl, 1-methyl-2-iminobutyl, 1-methyl-3-iminobutyl, 2-iminohexyl, 3-iminohexyl, 4-iminohexyl, 2-iminoheptyl, 3-iminoheptyl, 4-iminoheptyl, 4-iminoheptyl, 2-methyliminopropyl, 2-methyliminobutyl, 3-methyliminobutyl, 1-methyl-2-methyliminopropyl, 2-methyliminopentyl, 3-methyliminopentyl, 1-methyl-2-methyliminobutyl, 1-methyl-3-methyliminobutyl, 2-methyliminohexyl, 3-methyliminohexyl, 4-methyliminohexyl, 2-methyliminoheptyl, 3-methyliminoheptyl, 4-methyliminoheptyl, 4-methyliminoheptyl, 2-ethyliminopropyl, 2-ethyliminobutyl, 3-ethyliminobutyl, 1-methyl-2-ethyliminopropyl, 2-ethyliminopentyl, 3-ethyliminopentyl, 1-methyl-2-ethyliminobutyl, 1-methyl-3-ethyliminobutyl, 2-ethyliminohexyl, 3-ethyliminohexyl, 4-ethyliminohexyl, 2-ethyliminoheptyl, 3-ethyliminoheptyl, 4-ethyliminoheptyl, 4-ethyliminoheptyl, 2-propyliminopropyl, 2-propyliminobutyl, 3-propyliminobutyl, 1-methyl-2-propyliminopropyl, 2-propyliminopentyl, 3-propyliminopentyl, 1-methyl-2-propyliminobutyl, 1-methyl-3-propyliminobutyl, 2-propyliminohexyl, 3-propyliminohexyl, 4-propyliminohexyl, 2-propyliminoheptyl, 3-propyliminoheptyl, 4-propyliminoheptyl, 4-propyliminoheptyl and the like.

Alkoxy is an alkyl group bound via an oxygen atom. Examples of alkoxy are: methoxy, ethoxy, n-propoxy, 1-methylethoxy, butoxy, 1-methylpropoxy, 2-methylpropoxy, 1,1-dimethylethoxy, n-pentoxy, 1-methylbutoxy, 2-methylbutoxy, 3-methylbutoxy, 1,1-dimethylpropoxy, 1,2-dimethylpropoxy, 2,2-dimethylpropoxy, 1-ethylpropoxy, hexoxy, 1-methylpentoxy, 2-methylpentoxy, 3-methylpentoxy, 4-methylpentoxy, 1,1-dimethylbutoxy, 1,2-dimethylbutoxy, 1,3-dimethylbutoxy, 2,2-dimethylbutoxy, 2,3-dimethylbutoxy, 3,3-dimethylbutoxy, 1-ethylbutoxy, 2-ethylbutoxy, 1,1,2-trimethylpropoxy, 1,2,2-trimethylpropoxy, 1-ethyl-1-methylpropoxy or 1-ethyl-2-methylpropoxy, hexoxy and also R^{A}O—(CH₂CH₂CH₂CH₂O)ₙ—CH₂CH₂CH₂CH₂O— where R^{A} is hydrogen or C₁-C₄-alkyl, preferably hydrogen, methyl or ethyl and n is from 0 to 10, preferably from 0 to 3.

Alkylthio (alkylsulfanyl) is an alkyl group bound via a sulfur atom. Examples of alkylthio are methylthio, ethylthio, propylthio, butylthio, pentylthio and hexylthio.

Alkylsulfinyl is an alkyl group bound via an S(═O) group.

Alkylsulfonyl is an alkyl group bound via an S(═O)₂ group.

Aryl-substituted alkyl radicals (“arylalkyl”) have at least one unsubstituted or substituted aryl group as defined below. Suitable substituents on the aryl group are those mentioned below.

Here, the alkyl group in “arylalkyl” can bear at least one further substituent as defined above and/or be interrupted by one or more nonadjacent heteroatoms or heteroatom-comprising groups selected from among —O—, —S—, —NR^{a}— and/or —SO₂—. Arylalkyl is preferably phenyl-C₁-C₁₀-alkyl, particularly preferably phenyl-C₁-C₄-alkyl, e.g. benzyl, 1-phenethyl, 2-phenethyl, 1-phenprop-1-yl, 2-phenprop-1-yl, 3-phenprop-1-yl, 1-phenbut-1-yl, 2-phenbut-1-yl, 3-phenbut-1-yl, 4-phenbut-1-yl, 1-phenbut-2-yl, 2-phenbut-2-yl, 3-phenbut-2-yl, 4-phenbut-2-yl, 1-(phenmeth)eth-1-yl, 1-(phenmethyl)-1-(methyl)eth-1-yl or -(phenmethyl)-1-(methyl)prop-1-yl; preferably benzyl and 2-phenethyl.

The term “alkenyl”, as used herein, comprises linear and branched alkenyl groups which, depending on the chain length, can bear one or more double bonds (e.g. 1, 2, 3, 4 or more than 4). Preference is given to C₂-C₁₈—, particularly preferably C₂-C₁₂-alkenyl groups. The expression “alkenyl” also comprises substituted alkenyl groups which can bear one or more (e.g. 1, 2, 3, 4, 5 or more than 5) substituents. Suitable substituents are, for example, selected from among ═O, ═S, ═NR^{a}, cycloalkyl, cycloalkyloxy, polycyclyl, polycyclyloxy, heterocycloalkyl, aryl, aryloxy, arylthio, hetaryl, halogen, hydroxy, SH, COOH, carboxylate, SO₃H, sulfonate, alkylsulfinyl, alkylsulfonyl, NE³E⁴, nitro and cyano, where E³ and E⁴ are each, independently of one another, hydrogen, alkyl, cycloalkyl, heterocycloalkyl, aryl or hetaryl.

The term alkenyl also comprises alkenyl radicals whose carbon chain can be interrupted by one or more nonadjacent heteroatoms or heteroatom-comprising groups which are preferably selected from among —O—, —S—, —NR^{a}— and —SO₂—.

Alkenyl is then, for example, ethenyl (vinyl), 1-propenyl, 2-propenyl, 1-methylethenyl, 1-butenyl, 2-butenyl, 3-butenyl, 1-pentenyl, 2-pentenyl, 3-pentenyl, 4-pentenyl, 1-hexenyl, 2-hexenyl, 3-hexenyl, 4-hexenyl, 5-hexenyl, penta-1,3-dien-1-yl, hexa-1,4-dien-1-yl, hexa-1,4-dien-3-yl, hexa-1,4-dien-6-yl, hexa-1,5-dien-1-yl, hexa-1,5-dien-3-yl, hexa-1,5-dien-4-yl, hepta-1,4-dien-1-yl, hepta-1,4-dien-3-yl, hepta-1,4-dien-6-yl, hepta-1,4-dien-7-yl, hepta-1,5-dien-1-yl, hepta-1,5-dien-3-yl, hepta-1,5-dien-4-yl, hepta-1,5-dien-7-yl, hepta-1,6-dien-1-yl, hepta-1,6-dien-3-yl, hepta-1,6-dien-4-yl, hepta-1,6-dien-5-yl, hepta-1,6-dien-2-yl, octa-1,4-dien-1-yl, octa-1,4-dien-2-yl, octa-1,4-dien-3-yl, octa-1,4-dien-6-yl, octa-1,4-dien-7-yl, octa-1,5-dien-1-yl, octa-1,5-dien-3-yl, octa-1,5-dien-4-yl, octa-1,5-dien-7-yl, octa-1,6-dien-1-yl, octa-1,6-dien-3-yl, octa-1,6-dien-4-yl, octa-1,6-dien-5-yl, octa-1,6-dien-2-yl, deca-1,4-dienyl, deca-1,5-dienyl, deca-1,6-dienyl, deca-1,7-dienyl, deca-1,8-dienyl, deca-2,5-dienyl, deca-2,6-dienyl, deca-2,7-dienyl, deca-2,8-dienyl and the like.

The term “cycloalkyl”, as used herein, comprises both unsubstituted and substituted monocyclic saturated hydrocarbon groups which generally have from 3 to 12 ring carbons, preferably C₃-C₁₂-cycloalkyl groups such as cyclopropyl, cyclobutyl, cyclopentyl, cyclohexyl, cycloheptyl, cyclooctyl, cyclononyl, cyclodecyl, cycloundecyl or cyclododecyl, in particular C₅-C₁₂-cycloalkyl. Suitable substituents are generally selected from among alkyl, the substituents mentioned above for the alkyl groups, alkoxy and alkylthio. Substituted cycloalkyl groups can have one or more (e.g. 1, 2, 3, 4, 5 or more than 5) substituents, in the case of halogen the cycloalkyl radical being partially or completely substituted by halogen.

Examples of cycloalkyl groups are cyclopentyl, 2- and 3-methylcyclopentyl, 2- and 3-ethylcyclopentyl, chloropentyl, dichloropentyl, dimethylcyclopentyl, cyclohexyl, 2-, 3- and 4-methylcyclohexyl, 2-, 3- and 4-ethylcyclohexyl, 3- and 4-propylcyclohexyl, 3- and 4-isopropylcyclohexyl, 3- and 4-butylcyclohexyl, 3- and 4-sec-butylcyclohexyl, 3- and 4-tert-butylcyclohexyl, chlorohexyl, dimethylcyclohexyl, diethylcyclohexyl, methoxycyclohexyl, dimethoxycyclohexyl, diethoxycyclohexyl, butoxycyclohexyl, methylthiocyclohexyl, chlorocyclohexyl, dichlorocyclohexyl, cycloheptyl, 2-, 3- and 4-methylcycloheptyl, 2-, 3- and 4-ethylcycloheptyl, 3- and 4-propylcycloheptyl, 3- and 4-isopropylcycloheptyl, 3- and 4-butylcycloheptyl, 3- and 4-secbutylcycloheptyl, 3- and 4-tert-butylcycloheptyl, cyclooctyl, 2-, 3-, 4- and 5-methylcyclooctyl, 2-, 3-, 4- and 5-ethylcyclooctyl, 3-, 4- and 5-propylcyclooctyl, partially fluorinated cycloalkyl and perfluorinated cycloalkyl of the formula CₙF_{2(n-a)-(1-b)}H_{2a-b} where n=5 to 12, 0<a<n and b=0 or 1, where n and a are integers and in the case of a=0, b is also 0.

Cycloalkyloxy is a cycloalkyl group as defined above bound via oxygen.

The term “cycloalkenyl”, as used herein, comprises unsubstituted and substituted, monounsaturated or doubly unsaturated hydrocarbon groups having from 3 to 5, from 3 to 8, from 3 to 12, preferably from 5 to 12, ring carbons, e.g. cyclopent-1-en-1-yl, cyclopent-2-en-1-yl, cyclopent-3-en-1-yl, cyclohex-1-en-1-yl, cyclohex-2-en-1-yl, cyclohex-3-en-1-yl, cyclohexa-2,5-dien-1-yl and the like. Suitable substituents are those mentioned above for cycloalkyl.

Cycloalkenyloxy is a cycloalkenyl group as defined above bound via oxygen.

The term “polycyclyl”, as used herein, comprises in the widest sense compounds which comprise at least two rings, regardless of how these rings are linked. The rings can be carbocyclic and/or heterocyclic rings. The rings can be saturated or unsaturated. The rings can be linked via a single or double bond (“multiring systems”), be joined by fusion (“fused ring systems”) or be bridged (“bridged ring systems”, “cage compounds”). Preferred polycyclic compounds are bridged ring systems and fused ring systems. Fused ring systems can be aromatic, hydroaromatic and cyclic compounds joined by fusion (fused compounds). Fused ring systems comprise two, three or more than three rings. Depending on the way in which the rings are linked in fused ring systems, a distinction is made between ortho-fusion, i.e. each ring shares an edge or two atoms with each adjacent ring, and peri-fusion in which a carbon atom belongs to more than two rings. Among fused ring systems, preference is given to ortho-fused ring systems. Bridged ring systems include, for the purposes of the present invention, ones which do not belong to the multiring systems and not to the fused ring systems and in which at least two ring atoms belong to at least two different rings. In the case of bridged ring systems, a distinction is made according to the number of ring-opening reactions which are formally required to arrive at an open-chain compound between bicyclo, tricyclo, tetracyclo compounds, etc., which comprise two, three, four, etc. rings. For example, the expression “bicycloalkyl” comprises bicyclic hydrocarbon radicals which preferably have from 5 to 10 carbon atoms, e.g. bicyclo[2.2.1]hept-1-yl, bicyclo[2.2.1]hept-2-yl, bicyclo[2.2.1]hept-7-yl, bicyclo[2.2.2]oct-1-yl, bicyclo[2.2.2]oct-2-yl, bicyclo[3.3.0]octyl, bicyclo[4.4.0]decyl and the like. A further example is the expression “bicycloalkenyl” which comprises monounsaturated, bicyclic hydrocarbon radicals which preferably have from 5 to 10 carbon atoms, e.g. bicyclo[2.2.1]hept-2-en-1-yl.

Polycyclyloxy is a polycyclyl group as defined above bound via oxygen.

The term “aryl”, as used herein, comprises aromatic hydrocarbon radicals which have one or more rings and can be unsubstituted or substituted. Aryl generally refers to hydrocarbon radicals having from 6 to 10, up to 14, up to 18, preferably from 6 to 10, ring carbons. Aryl is preferably unsubstituted or substituted phenyl, naphthyl, anthracenyl, phenanthrenyl, naphthacenyl, chrysenyl, pyrenyl, etc., and particularly preferably phenyl or naphthyl. Substituted aryls can, depending on the number and size of their ring systems, have one or more (e.g. 1, 2, 3, 4, 5 or more than 5) substituents. These are preferably selected independently from among alkyl, alkoxy, cycloalkyl, cycloalkyloxy, heterocycloalkyl, aryl, aryloxy, arylthio, hetaryl, halogen, hydroxy, SH, alkylthio, alkylsulfinyl, alkylsulfonyl, COOH, carboxylate, SO₃H, sulfonate, NE⁵E⁶, nitro and cyano, where E⁵ and E⁶ are each, independently of one another, hydrogen, alkyl, cycloalkyl, cycloalkyloxy, polycyclyl, polycyclyloxy, heterocycloalkyl, aryl, aryloxy or hetaryl. Particular preference is given to aryl being phenyl which, if it is substituted, can generally bear 1, 2, 3, 4 or 5, preferably 1, 2 or 3, substituents.

Aryl which bears one or more radicals is, for example, 2-, 3- and 4-methylphenyl, 2,4-, 2,5-, 3,5- and 2,6-dimethylphenyl, 2,4,6-trimethylphenyl, 2-, 3- and 4-ethylphenyl, 2,4-, 2,5-, 3,5- and 2,6-diethylphenyl, 2,4,6-triethylphenyl, 2-, 3- and 4-propylphenyl, 2,4-, 2,5-, 3,5- and 2,6-dipropylphenyl, 2,4,6-tripropylphenyl, 2-, 3- and 4-isopropylphenyl, 2,4-, 2,5-, 3,5- and 2,6-diisopropylphenyl, 2,4,6-triisopropylphenyl, 2-, 3- and 4-butylphenyl, 2,4-, 2,5-, 3,5- and 2,6-dibutylphenyl, 2,4,6-tributylphenyl, 2-, 3- and 4-isobutylphenyl, 2,4-, 2,5-, 3,5- and 2,6-diisobutylphenyl, 2,4,6-triisobutylphenyl, 2-, 3- and 4-sec-butylphenyl, 2,4-, 2,5-, 3,5- and 2,6-di-sec-butylphenyl, 2,4,6-tri-sec-butylphenyl, 2-, 3- and 4-tert.-butylphenyl, 2,4-, 2,5-, 3,5- and 2,6-di-tert-butylphenyl, 2,4,6-tri-tert-butylphenyl and 2-, 3-, 4-dodecylphenyl; 2-, 3- and 4-methoxyphenyl, 2,4-, 2,5-, 3,5- and 2,6-dimethoxyphenyl, 2,4,6-trimethoxyphenyl, 2-, 3- and 4-ethoxyphenyl, 2,4-, 2,5-, 3,5- and 2,6-diethoxyphenyl, 2,4,6-triethoxyphenyl, 2-, 3- and 4-propoxyphenyl, 2,4-, 2,5-, 3,5- and 2,6-dipropoxyphenyl, 2-, 3- and 4-isopropoxyphenyl, 2,4-, 2,5-, 3,5- and 2,6-diisopropoxyphenyl, 2-, 3- and 4-butoxyphenyl, 2-, 3-, 4-hexyloxyphenyl; 2-, 3-, 4-chlorophenyl, 2,4-, 2,5-, 3,5- and 2,6-dichlorophenyl, trichlorophenyl, 2-, 3-, 4-fluorophenyl, 2,4-, 2,5-, 3,5- and 2,6-difluorophenyl, trifluorophenyl, e.g. 2,4,6-trifluorophenyl, tetrafluorophenyl, pentafluorophenyl, 2-, 3- and 4-cyanophenyl; 2-nitrophenyl, 4-nitrophenyl, 2,4-dinitrophenyl, 2,6-dinitrophenyl; 4-dimethylaminophenyl; 4-acetylphenyl; methoxyethylphenyl, ethoxymethylphenyl; methylthiophenyl, isopropylthiophenyl or tert-butylthiophenyl; methylnaphthyl; isopropylnaphthyl or ethoxynaphthyl. Examples of substituted aryl in which two substituents which are bound to adjacent carbon atoms of the aryl ring form a fused-on ring or fused ring system are indenyl and fluoroenyl.

The term “aryloxy”, as used herein, refers to aryl bound via an oxygen atom.

The term “arylthio”, as used herein, refers to aryl bound via a sulfur atom.

The term “heterocycloalkyl”, as used herein, comprises nonaromatic, unsaturated or fully saturated, cycloaliphatic groups which generally have from 5 to 8 ring atoms, preferably 5 or 6 ring atoms, and in which 1, 2 or 3 of the ring carbons have been replaced by heteroatoms selected from among oxygen, nitrogen, sulfur and an —NR^{a}— group and which is unsubstituted or substituted by one or more, for example, 1, 2, 3, 4, 5 or 6, C₁-C₆-alkyl groups. Examples of such heterocycloaliphatic groups are pyrrolidinyl, piperidinyl, 2,2,6,6-tetramethylpiperidinyl, imidazolidinyl, pyrazolidinyl, oxazolidinyl, morpholidinyl, thiazolidinyl, isothiazolidinyl, isoxazolidinyl, piperazinyl, tetrahydrothienyl, dihydrothienyl, tetrahydrofuranyl, dihydrofuranyl, tetrahydropyranyl, 1,2-oxazolin-5-yl, 1,3-oxazolin-2-yl and dioxanyl. Nitrogen-comprising heterocycloalkyl can in principle be bound either via a carbon atom or via a nitrogen atom.

The term “heteroaryl (hetaryl)” as used herein comprises unsubstituted or substituted, heteroaromatic groups which have one or more rings and generally have from 5 to 14 ring atoms, preferably 5 or 6 ring atoms, and in which 1, 2 or 3 of the ring carbons have been replaced by one, two, three or four heteroatoms selected from among 0, N, —NR^{a}— and S, for example furyl, thienyl, oxazolyl, isoxazolyl, thiazolyl, isothiazolyl, benzofuranyl, benzthiazolyl, benzimidazolyl, pyridyl, quinolinyl, acridinyl, pyridazinyl, pyrimidinyl, pyrazinyl, pyrrolyl, imidazolyl, pyrazolyl, indolyl, purinyl, indazolyl, benzotriazolyl, 1,2,3-triazolyl, 1,3,4-triazolyl and carbazolyl, where these heterocycloaromatic groups can, if they are substituted, generally bear 1, 2 or 3 substituents. The substituents are generally selected from among C₁-C₆-alkyl, C₁-C₆-alkoxy, hydroxy, carboxy, halogen and cyano.

5- to 7-membered nitrogen-comprising heterocycloalkyl or heteroaryl radicals, which may optionally comprise further heteroatoms, are, for example, pyrrolyl, pyrazolyl, imidazolyl, triazolyl, pyrrolidinyl, pyrazolinyl, pyrazolidinyl, imidazolinyl, imidazolidinyl, pyridinyl, pyridazinyl, pyrimidinyl, pyrazinyl, triazinyl, piperidinyl, piperazinyl, oxazolyl, isooxazolyl, thiazolyl, isothiazolyl, indolyl, quinolinyl, isoquinolinyl or quinaldinyl, which can be unsubstituted or substituted as mentioned above.

Halogen is fluorine, chlorine, bromine or iodine.

In the context of the present invention the terms “carboxylate” and “sulfonate” preferably denote derivatives of a carboxylic acid function or a sulfonic acid function, in particular a metal carboxylate or sulfonate, a carboxylic acid ester or sulfonic ester function or a carboxamide or sulfonamide function. These include, for example, esters with C₁-C₄-alkanols such as methanol, ethanol, n-propanol, isopropanol, n-butanol, sec-butanol and tert-butanol.

The term “acyl”, as used herein, refers to alkanoyl, hetaroyl or aroyl groups which generally have from 1 to 11, preferably from 2 to 8, carbon atoms, for example formyl, acetyl, propanoyl, butanoyl, pentanoyl, hexanoyl, heptanoyl, 2-ethylhexanoyl, 2-propylheptanoyl, benzoyl or naphthoyl group.

The radicals E¹, E², E³ and E⁴ are selected independently from among hydrogen, alkyl, cycloalkyl, heterocycloalkyl, aryl and hetaryl. The groups NE¹E² and NE³E⁴ are preferably N,N-dimethylamino, N,N-diethylamino, N,N-dipropylamino, N,N-diisopropylamino, N,N-di-n-butylamino, N,N-di-tert-butylamino, N,N-dicyclohexylamino or N,N-diphenylamino.

The metal cations [M¹]⁺, [M²]⁺, [M³]⁺, [M⁴]²⁺ and [M⁵]³⁺ mentioned in the formulae (III.a) to (III.j) are generally metal cations of groups 1, 2, 3, 4, 5, 6, 7, 8, 9, 10, 11, 12, 13 and 14 of the Periodic Table. Suitable metal cations are, for example, Li⁺, Na⁺, K⁺, Cs⁺, Mg²⁺, Ca²⁺, Ba²⁺, Sc³⁺, Ti⁴⁺, Zr⁴⁺, V⁵⁺, Cr³⁺, Fe²⁺, Fe³⁺, CO²⁺, Ni²⁺, Cu²⁺, Ag⁺, Zn²⁺ and Al³⁺.

The positive charge of a cation of the ionic liquids can be localized on one atom in the molecule of the cation or, according to a further possibility, be partially or completely delocalized over the molecule of the cation. For example, a nitrogen atom is a suitable carrier of the positive charge in the cation of the ionic liquids. When the nitrogen atom is the carrier of the positive charge in the cation of the ionic liquids, a cation can firstly be produced by quaternization of the nitrogen atom of, for instance, an amine or a nitrogen heterocycle in the synthesis of the ionic liquids. The quaternization can be effected by protonation of the nitrogen atom. Depending on the protonating reagent used, salts having different anions are obtained. In cases in which it is not possible to form the desired anion in the quaternization, it can be formed in a further synthetic step. Starting from, for example, an ammonium halide, the halide can be reacted with a Lewis acid, forming a complex anion of halide and Lewis acid. As an alternative, a halide ion can be replaced by the desired anion. This can be achieved by addition of a metal salt with precipitation of the metal halide formed, by means of an ion exchanger or by displacement of the halide ion by a strong acid (with liberation of the hydrohalic acid). Suitable processes are described, for example, in Angew. Chem. 2000, 112, pp. 3926-3945 and the references cited therein.

Preference is given to compounds which comprise at least one five- or six-membered heterocycle, in particular a five-membered heterocycle, which has at least one nitrogen atom and, if appropriate, an oxygen or sulfur atom, with particular preference being given to compounds which comprise at least one five- or six-membered heterocycle which has one, two or three nitrogen atoms and a sulfur or oxygen atom, particularly preferably ones having two nitrogen atoms. Further preference is given to aromatic heterocycles.

Particularly preferred compounds are those which have a molar mass of less than 1500 g/mol, very particularly preferably less than 1000 g/mol and in particular less than 800 g/mol.

Post synthesis, the viscosity of compositions is known to increase for a few days. The composition is considered “stable”, if the increase in viscosity is minimal and a constant viscosity should be reached within 3 weeks. In other words, the increase in viscosity should be a factor of not more than 3, better a factor of only 2, above the initial value.

Herein, the viscosity of aqueous coating composition was measured using a Haake Rotovisco viscometer, wherein the viscosity was measured in Stromer Krebs units (SKT). Said units may be converted to centipoise using the procedure outlined in ASTM D562. Furthermore, the viscosity of said compositions were determined at two different shear rates, as an indication of in-can stability, over a period of 4 weeks in order to test the effectiveness of the stabilizers.

Considering a typical initial value in the range of 20 to 40 SKT, preference is given to stabilizers (such as ionic liquids described herein) that can stabilize the aqueous composition, such that the composition yields viscosity of <120 SKT, preferably <100 SKT, more preferably 80 SKT, after three weeks of measurement.

Further, compositions that show minimal increase are considered suitable. In other words, preference is given to compositions that reveal an increase in viscosity by a factor of up to 5 versus the initial viscosity. More preferably, the compositions reveal an increase in viscosity by a factor of up to 4 versus the initial viscosity. Most preferably, the compositions reveal an increase in viscosity by a factor of up to 3 versus the initial viscosity.

In a preferred embodiment of the presently claimed invention, the aqueous composition has a viscosity in the range of 20 to 120 SKT, after three weeks of measurement, in embodiment 1 or embodiment 2.

In a more preferred embodiment of the presently claimed invention, the aqueous composition has a viscosity in the range of 30 to 100 SKT, after three weeks of measurement, in embodiment 1 or embodiment 2.

In a most preferred embodiment of the presently claimed invention, the aqueous composition has a viscosity in the range of 30 to 80 SKT, after three weeks of measurement, in embodiment 1 or embodiment 2.

In a preferred embodiment of the presently claimed invention, m, n, p, and q are each 1, 2, 3, or 4 and the product of p and m is equal to the product of q and n; and [A]^{m+} is a monovalent, divalent, trivalent or tetravalent cation selected from ammonium groups, oxonium groups, sulfonium groups, and phosphonium groups, in embodiment 1 or embodiment 2.

In a more preferred embodiment of the presently claimed invention, m, n, p, and q are each 1, 2, 3, or 4 and the product of p and m is equal to the product of q and n; [A]^{m+} is a monovalent cation selected from ammonium groups, oxonium groups, sulfonium groups, and phosphonium groups, in embodiment 1 or 2.

In a preferred embodiment of the presently claimed invention, [A]^{m+} is selected from the group consisting of compounds of the formulae (V.a) to (V.z),

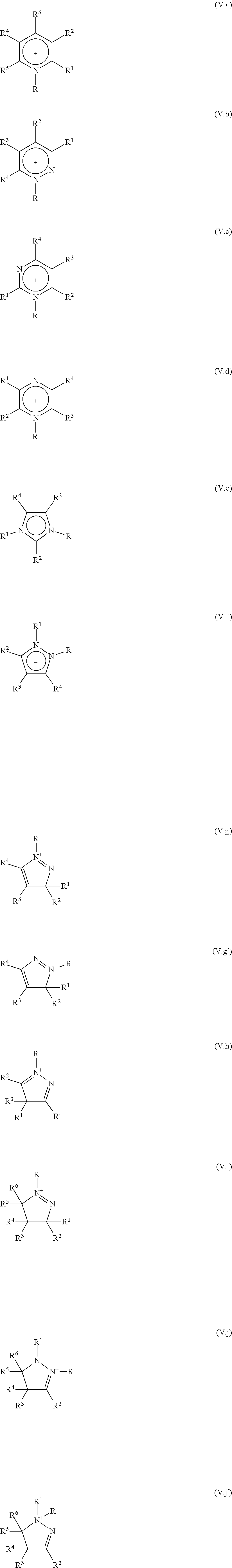

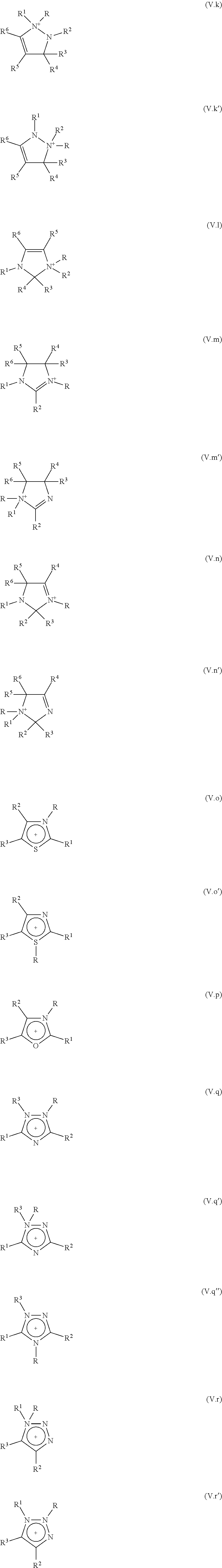

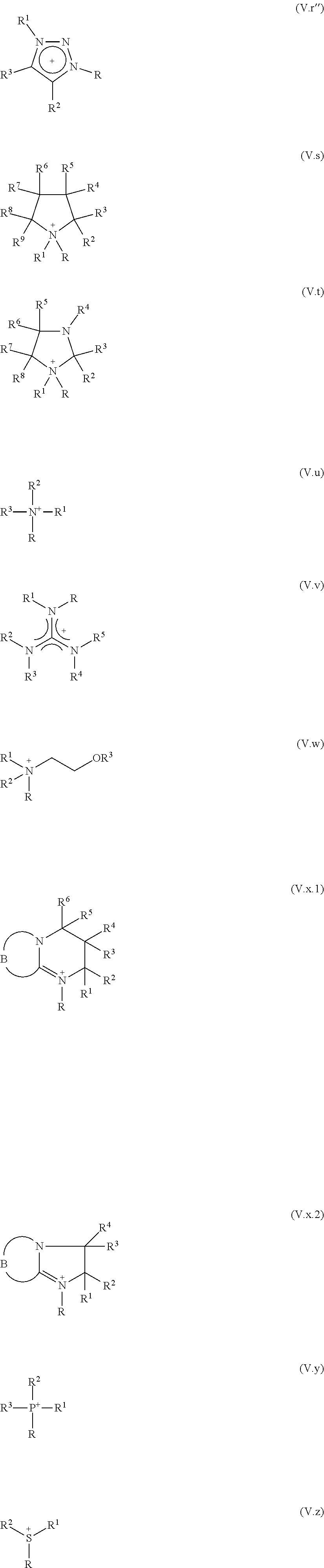

and oligomers comprising these structures, wherein
R is hydrogen, alkyl, alkenyl, cycloalkyl, cycloalkenyl, polycyclyl, heterocycloalkyl, aryl, or heteroaryl;
radicals R¹, R², R³, R⁴, R⁵, R⁶, R⁷, R⁸ and R⁹ which are bound to a ring carbon are each, independently of one another, hydrogen, a sulfo group, COOH, carboxylate, sulfonate, acyl, alkoxycarbonyl, CO(NE¹E²), cyano, halogen, hydroxyl, SH, nitro, NE³E⁴, alkyl, alkoxy, alkylthio, alkylsulfinyl, alkylsulfonyl, alkenyl, cycloalkyl, cycloalkyloxy, cycloalkenyl, cycloalkenyloxy, polycyclyl, polycyclyloxy, heterocycloalkyl, aryl, aryloxy, or heteroaryl, wherein E¹, E², E³ and E⁴ are each, independently of one another, hydrogen, alkyl, cycloalkyl, heterocycloalkyl, aryl, or hetaryl,
radicals R¹, R², R³, R⁴, R⁵, R⁶, R⁷, R⁸ and R⁹ which are bound to a heteroatom are each, independently of one another, hydrogen, a sulfo group, NE¹E², sulfonate, alkyl, alkoxy, alkenyl, cycloalkyl, cycloalkenyl, polycyclyl, heterocycloalkyl, aryl, or heteroaryl, wherein E¹ and E² are each, independently of one another, hydrogen, alkyl, cycloalkyl, heterocycloalkyl, aryl, or heteroaryl,
   or
two adjacent radicals R¹ to R⁹ together with the ring atoms to which they are bound form at least one fused-on, saturated, unsaturated, or aromatic ring or a ring system having from 1 to 12 carbon atoms, wherein the ring or the ring system optionally has from 1 to 5 nonadjacent heteroatoms or heteroatom-comprising groups and the ring or the ring system is unsubstituted or substituted,
wherein two geminal radicals R¹ to R⁹ together are ═O, ═S or ═NR^{b}, wherein R^{b} is hydrogen, alkyl, cycloalkyl, aryl, or heteroaryl,
   and
R¹ and R³ or R³ and R⁵ in the compounds of the formula (V.x.1) together represent the second bond of a double bond between the ring atoms bearing these radicals, or

the radicals R, R¹, R², R³, R⁴, R⁵, R⁶, R⁷, R⁸ and R⁹ are alkanediyl, cycloalkanediyl, alkenediyl or cycloalkenediyl which links a cation of one of the formulae (V.a) to (V.z) to a further cation of one of the formulae (V.a) to (V.z); wherein these radicals additionally function, via their second point of bonding, as radical R, R¹, R², R³, R⁴, R⁵, R⁶, R⁷, R^{a} or R⁹ of said further cation; and the radicals alkanediyl, cycloalkanediyl, alkenediyl and cycloalkenediyl are branched or linear, substituted and/or interrupted by at least one heteroatom or heteroatom-comprising group; B in the compounds of the formulae (V.x.1) and (V.x.2) together with the C—N group to which it is bound forms a 4- to 8-membered saturated or unsaturated or aromatic ring which is optionally substituted and/or is optionally containing further heteroatoms or heteroatomc-omprising groups and/or optionally comprise the further fused-on saturated, unsaturated or aromatic carbocycles or heterocycles, in embodiment 1 or embodiment 2.

In a more preferred embodiment of the presently claimed invention, [A]^{m+} is selected from the group consisting of compounds of the formulae (V.e), (V.u), (V.y) and (V.z),

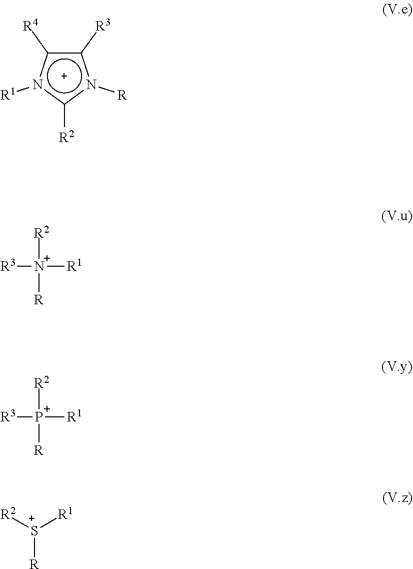

wherein R is hydrogen, alkyl, alkenyl, cycloalkyl, cycloalkenyl, polycyclyl, heterocycloalkyl, aryl, or heteroaryl;

radicals R², R³ and R⁴ which are bound to a ring carbon are each, independently of one another, hydrogen, a sulfo group, COOH, carboxylate, sulfonate, acyl, alkoxycarbonyl, CO(NE¹E²), cyano, halogen, hydroxyl, SH, nitro, NE³E⁴, alkyl, alkoxy, alkylthio, alkylsulfinyl, alkylsulfonyl, alkenyl, cycloalkyl, cycloalkyloxy, cycloalkenyl, cycloalkenyloxy, polycyclyl, polycyclyloxy, heterocycloalkyl, aryl, aryloxy, or heteroaryl, wherein E¹, E², E³ and E⁴ are each, independently of one another, hydrogen, alkyl, cycloalkyl, heterocycloalkyl, aryl, or hetaryl; and

radicals R¹, R² and R³ which are bound to a heteroatom are each, independently of one another, hydrogen, a sulfo group, NE¹E², sulfonate, alkyl, alkoxy, alkenyl, cycloalkyl, cycloalkenyl, polycyclyl, heterocycloalkyl, aryl, or heteroaryl, wherein E¹ and E² are each, independently of one another, hydrogen, alkyl, cycloalkyl, heterocycloalkyl, aryl, or hetaryl, in embodiment 1 or embodiment 2.

In an even more preferred embodiment of the presently claimed invention, the radicals R, R¹, R² and R³ which are bound to a heteroatom are each, independently of one another, C₁-C₈-alkyl, or cycloalkyl, and the radicals R², R³ and R⁴ which are bound to a carbon atom are each hydrogen, in embodiment 1 or embodiment 2.

In a particularly preferred embodiment of the presently claimed invention, the radicals R, R¹, R² and R³ which are bound to a heteroatom are each, independently of one another, C₁-C₅-alkyl, or cycloalkyl, and the radicals R², R³ and R⁴ which are bound to a carbon atom are each hydrogen, in embodiment 1 or embodiment 2.

In another particularly preferred embodiment of the presently claimed invention, the radicals R, R¹, R² and R³ which are bound to a heteroatom are each, independently of one another, C₁-C₅-alkyl, and the radicals R², R³ and R⁴ which are bound to a carbon atom are each hydrogen, in embodiment 1 or embodiment 2.

In a most preferred embodiment of the presently claimed invention, the compound of formula (V.e) is 1-ethyl-3-methylimidazolium, in embodiment 1 or embodiment 2.

In another preferred embodiment of the presently claimed invention, the compounds of the formula (V.u), are selected from the group consisting of methyltriethanolammonium, and dimethylcyclohexylammonium, in embodiment 1 or embodiment 2.

In a most preferred embodiment of the presently claimed invention, the compound of the formula (V.u), is methyltriethanolammonium, in embodiment 1 or embodiment 2.

In another most preferred embodiment of the presently claimed invention, the compound of the formula (V.u), is dimethylcyclohexylammonium, in embodiment 1 or embodiment 2.

In yet another preferred embodiment of the presently claimed invention, the compounds of formula (V.y), are selected from the group consisting of tributylethylphosphonium, and tetrakis(hydroxymethyl)phosphonium, in embodiment 1 or embodiment 2.

In a most preferred embodiment of the presently claimed invention, the compound of the formula (V.y) is tributylethylphosphonium, in embodiment 1 or embodiment 2.

In another particularly preferred embodiment of the presently claimed invention, the compound of the formula (V.y) is tetrakis(hydroxymethyl)phosphonium, in embodiment 1 or embodiment 2.

In a preferred embodiment of the presently claimed invention, [Y]ⁿ⁻ is selected from anions of:
the group of sulfates, sulfites and sulfonates of the general formulae:

SO₄²⁻,HSO₄⁻,SO₃²⁻,HSO₃⁻,R^{c}OSO₃⁻,R^{c}SO₃⁻;
the group of phosphates of the general formulae:

PO₄³⁻,HPO₄²⁻,H₂PO₄⁻,R^{c}PO₄²⁻,HR^{c}PO₄⁻,R^{c}R^{d}PO₄⁻;
the group of phosphonates and phosphinates of the general formulae:

R^{c}HPO₃⁻,R^{c}R^{d}PO₂⁻,R^{c}R^{d}PO₃⁻;
the group of phosphites of the general formulae:

PO₃³⁻,HPO₃²⁻,H₂PO₃⁻,R^{c}PO₃²⁻,R^{c}HPO₃⁻,R^{c}R^{d}PO₃⁻;
the group of phosphonites and phosphinites of the general formulae:

R^{c}R^{d}PO₂⁻,R^{c}HPO₂⁻,R^{c}R^{d}PO⁻,R^{c}HPO⁻;
the group of carboxylates of the general formula:

R^{c}COO⁻;
anions of hydroxycarboxylic acids and sugar acids;
the group of carbonates and carbonic esters of the general formulae:

HCO₃⁻,CO₃²⁻,R^{c}CO₃⁻;

wherein the radicals R^{c} and R^{d} are selected independently from each other from hydrogen, alkyl, cycloalkyl, heterocycloalkyl, aryl and heteroaryl, in embodiment 1 or embodiment 2.

In a particularly preferred embodiment of the presently claimed invention, [A]^{m+} is selected from the group consisting of compounds of the formulae (V.e), (V.u), (V.y) and (V.z),

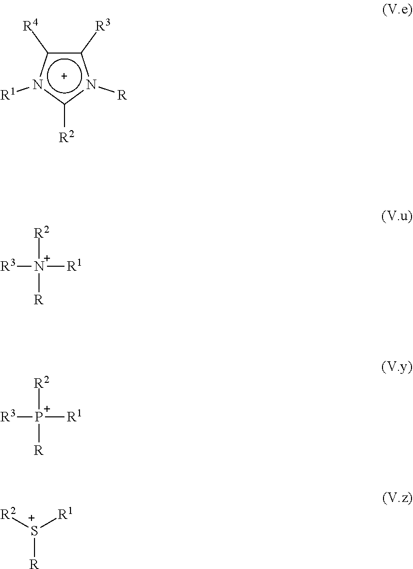

wherein R is hydrogen, alkyl, alkenyl, cycloalkyl, cycloalkenyl, polycyclyl, heterocycloalkyl, aryl, or heteroaryl;

radicals R², R³ and R⁴ which are bound to a ring carbon are each, independently of one another, hydrogen, a sulfo group, COOH, carboxylate, sulfonate, acyl, alkoxycarbonyl, CO(NE¹E²), cyano, halogen, hydroxyl, SH, nitro, NE³E⁴, alkyl, alkoxy, alkylthio, alkylsulfinyl, alkylsulfonyl, alkenyl, cycloalkyl, cycloalkyloxy, cycloalkenyl, cycloalkenyloxy, polycyclyl, polycyclyloxy, heterocycloalkyl, aryl, aryloxy, or heteroaryl, wherein E¹, E², E³ and E⁴ are each, independently of one another, hydrogen, alkyl, cycloalkyl, heterocycloalkyl, aryl, or hetaryl; and

radicals R¹, R² and R³ which are bound to a heteroatom are each, independently of one another, hydrogen, a sulfo group, NE¹E², sulfonate, alkyl, alkoxy, alkenyl, cycloalkyl, cycloalkenyl, polycyclyl, heterocycloalkyl, aryl, or heteroaryl, wherein E¹ and E² are each, independently of one another, hydrogen, alkyl, cycloalkyl, heterocycloalkyl, aryl, or hetaryl and wherein

[Y]ⁿ⁻ is selected from anions of:
the group of sulfates, sulfites and sulfonates of the general formulae:

SO₄²⁻,HSO₄⁻,SO₃²⁻,HSO₃⁻,R^{c}OSO₃⁻,R^{c}SO₃⁻;
the group of phosphates of the general formulae:

PO₄³⁻,HPO₄²⁻,H₂PO₄⁻,R^{c}PO₄²⁻,HR^{c}PO₄⁻,R^{c}R^{d}PO₄⁻;
the group of phosphonates and phosphinates of the general formulae:

R^{c}HPO₃⁻,R^{c}R^{d}PO₂⁻,R^{c}R^{d}PO₃⁻;
the group of phosphites of the general formulae:

PO₃³⁻,HPO₃²⁻,H₂PO₃⁻,R^{c}PO₃²⁻,R^{c}HPO₃⁻,R^{c}R^{d}PO₃⁻;

the group of phosphonites and phosphinites of the general formulae:

R^{c}R^{d}PO₂⁻,R^{c}HPO₂⁻,R^{c}R^{d}PO⁻,R^{c}HPO⁻;

the group of carboxylates of the general formula:

R^{c}COO⁻;
anions of hydroxycarboxylic acids and sugar acids;
the group of carbonates and carbonic esters of the general formulae:

HCO₃⁻,CO₃²⁻,R^{c}CO₃⁻;

wherein the radicals R^{c} and R^{d} are selected independently from each other from hydrogen, alkyl, cycloalkyl, heterocycloalkyl, aryl and heteroaryl, in embodiment 1 or embodiment 2.

In another particularly preferred embodiment of the presently claimed invention, [Y]ⁿ⁻ is selected from anions of:
the group of sulfates, sulfites and sulfonates of the general formulae:

SO₄²⁻,HSO₄⁻,SO₃²⁻,HSO₃⁻,R^{c}OSO₃⁻,R^{c}SO₃⁻;

the group of phosphates of the general formulae:

PO₄³⁻,HPO₄²⁻,H₂PO₄⁻,R^{c}PO₄²⁻,HR^{c}PO₄⁻,R^{c}R^{d}PO₄⁻;

the group of carboxylates of the general formula:

R^{c}COO⁻;

wherein the radicals R^{c} and R^{d} are selected independently from each other from hydrogen, alkyl, cycloalkyl, heterocycloalkyl, aryl and heteroaryl, in embodiment 1 or embodiment 2.

In another particularly preferred embodiment of the presently claimed invention, [Y]ⁿ⁻ is selected from anions of:
the group of sulfates, sulfites and sulfonates of the general formulae:

SO₄²⁻,HSO₄⁻,SO₃²⁻,HSO₃⁻,R^{c}OSO₃⁻,R^{c}SO₃⁻;

the group of phosphates of the general formulae:

PO₄³⁻,HPO₄²⁻,H₂PO₄⁻,R^{c}PO₄²⁻,HR^{c}PO₄⁻,R^{c}R^{d}PO₄⁻;

the group of carboxylates of the general formula:

R^{c}COO⁻;

wherein the radicals R^{c} and R^{d} are selected independently from each other from hydrogen, alkyl, cycloalkyl, heterocycloalkyl, aryl and heteroaryl, in embodiment 1 or embodiment 2.

In yet another particularly preferred embodiment of the presently claimed invention, [A]^{m+} is selected from the group consisting of compounds of the formulae (V.e), (V.u), (V.y) and (V.z),

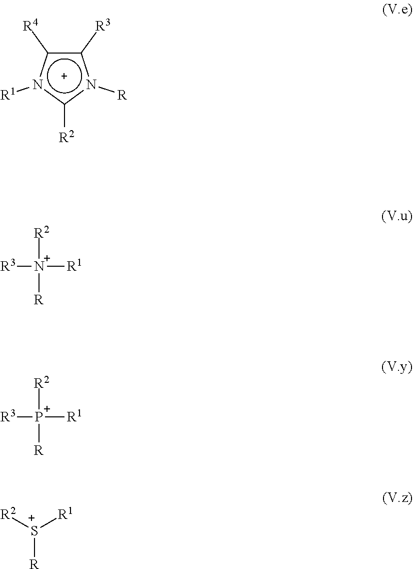

in which R is hydrogen, alkyl, alkenyl, cycloalkyl, cycloalkenyl, polycyclyl, heterocycloalkyl, aryl, or heteroaryl;

radicals R², R³ and R⁴ which are bound to a ring carbon are each, independently of one another, hydrogen, a sulfo group, COOH, carboxylate, sulfonate, acyl, alkoxycarbonyl, CO(NE¹E²), cyano, halogen, hydroxyl, SH, nitro, NE³E⁴, alkyl, alkoxy, alkylthio, alkylsulfinyl, alkylsulfonyl, alkenyl, cycloalkyl, cycloalkyloxy, cycloalkenyl, cycloalkenyloxy, polycyclyl, polycyclyloxy, heterocycloalkyl, aryl, aryloxy, or heteroaryl, wherein E¹, E², E³ and E⁴ are each, independently of one another, hydrogen, alkyl, cycloalkyl, heterocycloalkyl, aryl, or hetaryl; and

[Y]ⁿ⁻ is selected from anions of:
the group of sulfates, sulfites and sulfonates of the general formulae:

SO₄²⁻,HSO₄⁻,SO₃²⁻,HSO₃⁻,R^{c}OSO₃⁻,R^{c}SO₃⁻;
the group of phosphates of the general formulae:

PO₄³⁻,HPO₄²⁻,H₂PO₄⁻,R^{c}PO₄²⁻,HR^{c}PO₄⁻,R^{c}R^{d}PO₄⁻;

the group of carboxylates of the general formula:

R^{c}COO⁻;

wherein the radicals R^{c} and R^{d} are selected independently from each other from hydrogen, alkyl, cycloalkyl, heterocycloalkyl, aryl and heteroaryl, in embodiment 1 or embodiment 2.

In another more preferred embodiment of the presently claimed invention, [Y]ⁿ⁻ is selected from R^{c}OSO₃⁻, R^{c}R^{d}PO₄⁻ and R^{c}COO⁻;

wherein the radicals R^{c} and R^{d} are selected independently from each other from hydrogen, alkyl, cycloalkyl, heterocycloalkyl, aryl, and heteroaryl, in embodiment 1 or embodiment 2.

In yet another more preferred embodiment of the presently claimed invention, R^{c} and R^{d} are selected independently from each other from hydrogen and C₁-C₈-alkyl, in embodiment 1 or embodiment 2.

In a most preferred embodiment of the presently claimed invention, R^{c} and R^{d} selected independently from each other from hydrogen and C₁-C₅-alkyl, in embodiment 1 or embodiment 2.

In a preferred embodiment of the presently claimed invention, [Y]ⁿ⁻ is selected from anions of:
the group of sulfates, sulfites and sulfonates of the general formulae:

SO₄²⁻,HSO₄⁻,SO₃²⁻,HSO₃⁻,R^{c}OSO₃⁻,R^{c}SO₃⁻;

the group of phosphates of the general formulae:

PO₄³⁻,HPO₄²⁻,H₂PO₄⁻,R^{c}PO₄²⁻,HR^{c}PO₄⁻,R^{c}R^{d}PO₄⁻;

the group of phosphonates and phosphinates of the general formulae:

R^{c}HPO₃⁻,R^{c}R^{d}PO₂⁻,R^{c}R^{d}PO₃⁻;
the group of phosphites of the general formulae:

PO₃³⁻,HPO₃²⁻,H₂PO₃⁻,R^{c}PO₃²⁻,R^{c}HPO₃⁻,R^{c}R^{d}PO₃⁻;
the group of phosphonites and phosphinites of the general formulae:

R^{c}R^{d}PO₂⁻,R^{c}HPO₂⁻,R^{c}R^{d}PO⁻,R^{c}HPO⁻;
the group of carboxylates of the general formula:

R^{c}COO⁻;
anions of hydroxycarboxylic acids and sugar acids;
the group of carbonates and carbonic esters of the general formulae:

HCO₃⁻,CO₃²⁻,R^{c}CO₃⁻;

wherein the radicals R^{c} and R^{d} are selected independently from each other from hydrogen and C₁-C₈-alkyl, in embodiment 1 or embodiment 2.

In yet another preferred embodiment of the presently claimed invention, [Y]ⁿ⁻ is selected from R^{c}OSO₃⁻, R^{c}R^{d}PO₄⁻ and R^{c}COO⁻;

wherein the radicals R^{c} and R^{d} are selected independently from each other from hydrogen and C₁-C₈-alkyl, in embodiment 1 or embodiment 2.

In a more preferred embodiment of the presently claimed invention, [Y]ⁿ⁻ is selected from anions of:
the group of sulfates, sulfites and sulfonates of the general formulae:

SO₄²⁻,HSO₄⁻,SO₃²⁻,HSO₃⁻,R^{c}OSO₃⁻,R^{c}SO₃⁻;
the group of phosphates of the general formulae:

PO₄³⁻,HPO₄²⁻,H₂PO₄⁻,R^{c}PO₄²⁻,HR^{c}PO₄⁻,R^{c}R^{d}PO₄⁻;
the group of phosphonates and phosphinates of the general formulae:

R^{c}HPO₃⁻,R^{c}R^{d}PO₂⁻,R^{c}R^{d}PO₃⁻;
the group of phosphites of the general formulae:

PO₃³⁻,HPO₃²⁻,H₂PO₃⁻,R^{c}PO₃²⁻,R^{c}HPO₃⁻,R^{c}R^{d}PO₃⁻;
the group of phosphonites and phosphinites of the general formulae:

R^{c}R^{d}PO₂⁻,R^{c}HPO₂⁻,R^{c}R^{d}PO⁻,R^{c}HPO⁻;
the group of carboxylates of the general formula:

R^{c}COO⁻;

anions of hydroxycarboxylic acids and sugar acids;
the group of carbonates and carbonic esters of the general formulae:

HCO₃⁻,CO₃²⁻,R^{c}CO₃⁻;

wherein the radicals R^{c} and R^{d} are selected independently from each other from hydrogen and C₁-C₅-alkyl, in embodiment 1 or embodiment 2.

In a most preferred embodiment of the presently claimed invention, [Y]ⁿ⁻ is selected from R^{c}OSO₃⁻, R^{c}R^{d}PO₄⁻ and R^{c}COO⁻;

wherein the radicals R^{c} and R^{d} are selected independently from each other from hydrogen and C₁-C₅-alkyl, in embodiment 1 or embodiment 2.

In a preferred embodiment of the presently claimed invention, the at least one ionic liquid contains 2 to 16 carbon atoms, in embodiment 1 or embodiment 2.

In a particularly preferred embodiment of the presently claimed invention, [A]^{m+} is selected from the group consisting of compounds of the formulae (V.e), (V.u), (V.y) and (V.z),

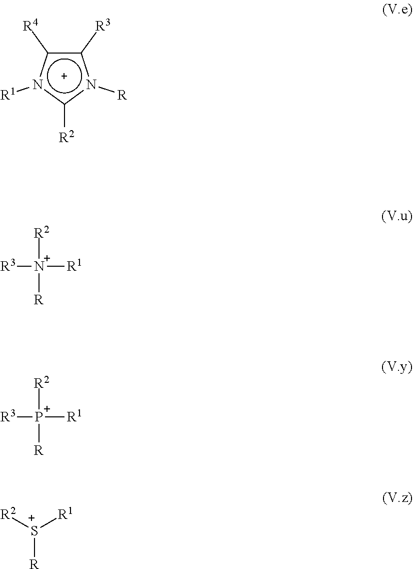

in which R is hydrogen, alkyl, alkenyl, cycloalkyl, cycloalkenyl, polycyclyl, heterocycloalkyl, aryl, or heteroaryl;

radicals R², R³ and R⁴ which are bound to a ring carbon are each, independently of one another, hydrogen, a sulfo group, COOH, carboxylate, sulfonate, acyl, alkoxycarbonyl, CO(NE¹E²), cyano, halogen, hydroxyl, SH, nitro, NE³E⁴, alkyl, alkoxy, alkylthio, alkylsulfinyl, alkylsulfonyl, alkenyl, cycloalkyl, cycloalkyloxy, cycloalkenyl, cycloalkenyloxy, polycyclyl, polycyclyloxy, heterocycloalkyl, aryl, aryloxy, or heteroaryl, wherein E¹, E², E³ and E⁴ are each, independently of one another, hydrogen, alkyl, cycloalkyl, heterocycloalkyl, aryl, or hetaryl; and radicals R¹, R² and R³ which are bound to a heteroatom are each, independently of one another, hydrogen, a sulfo group, NE¹E², sulfonate, alkyl, alkoxy, alkenyl, cycloalkyl, cycloalkenyl, polycyclyl, heterocycloalkyl, aryl, or heteroaryl, wherein E¹ and E² are each, independently of one another, hydrogen, alkyl, cycloalkyl, heterocycloalkyl, aryl, or hetaryl, and

[Y]ⁿ⁻ is selected from anions of:
the group of sulfates, sulfites and sulfonates of the general formulae:

SO₄²⁻,HSO₄⁻,SO₃²⁻,HSO₃⁻,R^{c}OSO₃⁻,R^{c}SO₃⁻;
the group of phosphates of the general formulae:

PO₄³⁻,HPO₄²⁻,H₂PO₄⁻,R^{c}PO₄²⁻,HR^{c}PO₄⁻,R^{c}R^{d}PO₄⁻;
the group of phosphonates and phosphinates of the general formulae:

R^{c}HPO₃⁻,R^{c}R^{d}PO₂⁻,R^{c}R^{d}PO₃⁻;
the group of phosphites of the general formulae:

PO₃³⁻,HPO₃²⁻,H₂PO₃⁻,R^{c}PO₃²⁻,R^{c}HPO₃⁻,R^{c}R^{d}PO₃⁻;
the group of phosphonites and phosphinites of the general formulae:

R^{c}R^{d}PO₂⁻,R^{c}HPO₂⁻,R^{c}R^{d}PO⁻,R^{c}HPO⁻;
the group of carboxylates of the general formula:

R^{c}COO⁻;
anions of hydroxycarboxylic acids and sugar acids;
the group of carbonates and carbonic esters of the general formulae:

HCO₃⁻,CO₃²⁻,R^{c}CO₃⁻;

wherein the radicals R^{c} and R^{d} are selected independently from each other from hydrogen, alkyl, cycloalkyl, heterocycloalkyl, aryl and heteroaryl, and the at least one ionic liquid contains 2 to 16 carbon atoms, in embodiment 1 or embodiment 2.

In another particularly preferred embodiment of the presently claimed invention, [A]^{m+} is selected from the group consisting of compounds of the formulae (V.e), (V.u), (V.y) and (V.z),

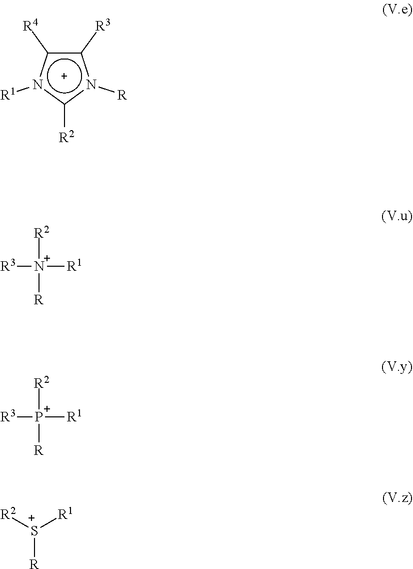

in which R is hydrogen, alkyl, alkenyl, cycloalkyl, cycloalkenyl, polycyclyl, heterocycloalkyl, aryl, or heteroaryl;

radicals R², R³ and R⁴ which are bound to a ring carbon are each, independently of one another, hydrogen, a sulfo group, COOH, carboxylate, sulfonate, acyl, alkoxycarbonyl, CO(NE¹E²), cyano, halogen, hydroxyl, SH, nitro, NE³E⁴, alkyl, alkoxy, alkylthio, alkylsulfinyl, alkylsulfonyl, alkenyl, cycloalkyl, cycloalkyloxy, cycloalkenyl, cycloalkenyloxy, polycyclyl, polycyclyloxy, heterocycloalkyl, aryl, aryloxy, or heteroaryl, wherein E¹, E², E³ and E⁴ are each, independently of one another, hydrogen, alkyl, cycloalkyl, heterocycloalkyl, aryl, or hetaryl; and the at least one ionic liquid contains 2 to 16 carbon atoms, in embodiment 1 or embodiment 2.

In another particularly preferred embodiment of the presently claimed invention, [Y]ⁿ⁻ is selected from anions of:
the group of sulfates, sulfites and sulfonates of the general formulae:

SO₄²⁻,HSO₄⁻,SO₃²⁻,HSO₃⁻,R^{c}OSO₃⁻,R^{c}SO₃⁻;
the group of phosphates of the general formulae:

PO₄³⁻,HPO₄²⁻,H₂PO₄⁻,R^{c}PO₄²⁻,HR^{c}PO₄⁻,R^{c}R^{d}PO₄⁻;
the group of carboxylates of the general formula:

R^{c}COO⁻;

wherein the radicals R^{c} and R^{d} are selected independently from each other from hydrogen, alkyl, cycloalkyl, heterocycloalkyl, aryl and heteroaryl, and the at least one ionic liquid contains 2 to 16 carbon atoms, in embodiment 1 or embodiment 2.

In yet another particularly preferred embodiment of the presently claimed invention, [A]^{m+} is selected from the group consisting of compounds of the formulae (V.e), (V.u), (V.y) and (V.z),

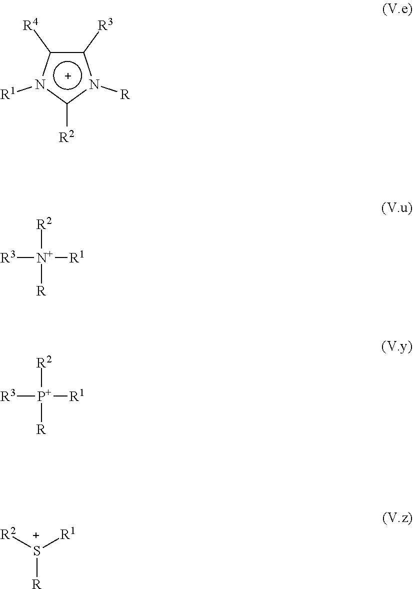

in which R is hydrogen, alkyl, alkenyl, cycloalkyl, cycloalkenyl, polycyclyl, heterocycloalkyl, aryl, or heteroaryl;

radicals R², R³ and R⁴ which are bound to a ring carbon are each, independently of one another, hydrogen, a sulfo group, COOH, carboxylate, sulfonate, acyl, alkoxycarbonyl, CO(NE¹E²), cyano, halogen, hydroxyl, SH, nitro, NE³E⁴, alkyl, alkoxy, alkylthio, alkylsulfinyl, alkylsulfonyl, alkenyl, cycloalkyl, cycloalkyloxy, cycloalkenyl, cycloalkenyloxy, polycyclyl, polycyclyloxy, heterocycloalkyl, aryl, aryloxy, or heteroaryl, wherein E¹, E², E³ and E⁴ are each, independently of one another, hydrogen, alkyl, cycloalkyl, heterocycloalkyl, aryl, or hetaryl; and

[Y]ⁿ⁻ is selected from anions of:
the group of sulfates, sulfites and sulfonates of the general formulae:

SO₄²⁻,HSO₄⁻,SO₃²⁻,HSO₃⁻,R^{c}OSO₃⁻,R^{c}SO₃⁻;
the group of phosphates of the general formulae:

PO₄³⁻,HPO₄²⁻,H₂PO₄⁻,R^{c}PO₄²⁻,HR^{c}PO₄⁻,R^{c}R^{d}PO₄⁻;
the group of carboxylates of the general formula:

R^{c}COO⁻;

wherein the radicals R^{c} and R^{d} are selected independently from each other from hydrogen, alkyl, cycloalkyl, heterocycloalkyl, aryl and heteroaryl, and the at least one ionic liquid contains 2 to 16 carbon atoms, in embodiment 1 or embodiment 2.

In a more preferred embodiment of the presently claimed invention, the at least one ionic liquid contains 1 to 8 carbon atoms, in embodiment 1 or embodiment 2.

In a preferred embodiment of the presently claimed invention, the at least one ionic liquid is selected from the group consisting of 1-ethyl-3-methylimidazolium acetate, methyltriethanolammonium methosulfate, tributylethylphosphonium diethylphosphate, bis(dimethylcyclohexylammonium) sulfate, and tetrakis(hydroxymethyl)phosphonium sulfate, in embodiment 1 or embodiment 2.

In a more preferred embodiment of the presently claimed invention, the at least one ionic liquid is 1-ethyl-3-methylimidazolium acetate, in embodiment 1 or embodiment 2.

In a particularly preferred embodiment of the presently claimed invention, the at least one ionic liquid is methyltriethanolammonium methosulfate, in embodiment 1 or embodiment 2.

In another particularly preferred embodiment of the presently claimed invention, the at least one ionic liquid is tributylethylphosphonium diethylphosphate, in embodiment 1 or embodiment 2.

In yet another particularly preferred embodiment of the presently claimed invention, the at least one ionic liquid is bis(dimethylcyclohexylammonium) sulfate, in embodiment 1 or embodiment 2.

In a another particularly preferred embodiment of the presently claimed invention, the at least one ionic liquid is tetrakis(hydroxymethyl)phosphonium sulfate, in embodiment 1 or embodiment 2.

In a preferred embodiment of the presently claimed invention, the at least one ionic liquid is present in an amount in the range from ≥0.05 wt. % to ≤5.0 wt. %, based on the total weight of the aqueous coating composition, in embodiment 1 or embodiment 2.

In another particularly preferred embodiment of the presently claimed invention, [A]^{m+} is selected from the group consisting of compounds of the formulae (V.e), (V.u), (V.y) and (V.z),

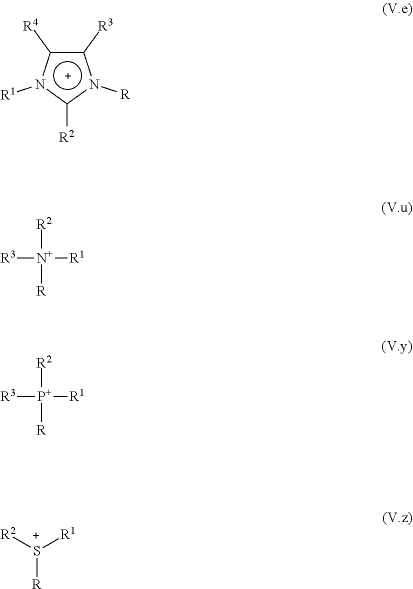

in which R is hydrogen, alkyl, alkenyl, cycloalkyl, cycloalkenyl, polycyclyl, heterocycloalkyl, aryl, or heteroaryl;

radicals R², R³ and R⁴ which are bound to a ring carbon are each, independently of one another, hydrogen, a sulfo group, COOH, carboxylate, sulfonate, acyl, alkoxycarbonyl, CO(NE¹E²), cyano, halogen, hydroxyl, SH, nitro, NE³E⁴, alkyl, alkoxy, alkylthio, alkylsulfinyl, alkylsulfonyl, alkenyl, cycloalkyl, cycloalkyloxy, cycloalkenyl, cycloalkenyloxy, polycyclyl, polycyclyloxy, heterocycloalkyl, aryl, aryloxy, or heteroaryl, wherein E¹, E², E³ and E⁴ are each, independently of one another, hydrogen, alkyl, cycloalkyl, heterocycloalkyl, aryl, or hetaryl; and the at least one ionic liquid contains 2 to 16 carbon atoms, and the at least one ionic liquid is present in an amount in the range from ≥0.05 wt. % to ≤5.0 wt. %, based on the total weight of the aqueous coating composition, in embodiment 1 or embodiment 2.

In another particularly preferred embodiment of the presently claimed invention, [Y]ⁿ⁻ is selected from anions of:
the group of sulfates, sulfites and sulfonates of the general formulae:

SO₄²⁻,HSO₄⁻,SO₃²⁻,HSO₃⁻,R^{c}OSO₃⁻,R^{c}SO₃⁻;
the group of phosphates of the general formulae:

PO₄³⁻,HPO₄²⁻,H₂PO₄⁻,R^{c}PO₄²⁻,HR^{c}PO₄⁻,R^{c}R^{d}PO₄⁻;
the group of carboxylates of the general formula:

R^{c}COO⁻;

wherein the radicals R^{c} and R^{d} are selected independently from each other from hydrogen, alkyl, cycloalkyl, heterocycloalkyl, aryl and heteroaryl, and the at least one ionic liquid contains 2 to 16 carbon atoms, and at least one ionic liquid is present in an amount in the range from ≥0.05 wt. % to ≤5.0 wt. %, based on the total weight of the aqueous coating composition, in embodiment 1 or embodiment

2.

In a more preferred embodiment of the presently claimed invention, the at least one ionic liquid is present in an amount in the range from ≥0.2 wt. % to ≤2.0 wt. %, based on the total weight of the aqueous coating composition, in embodiment 1 or embodiment 2.

In another particularly preferred embodiment of the presently claimed invention, [A]^{m+} is selected from the group consisting of compounds of the formulae (V.e), (V.u), (V.y) and (V.z),

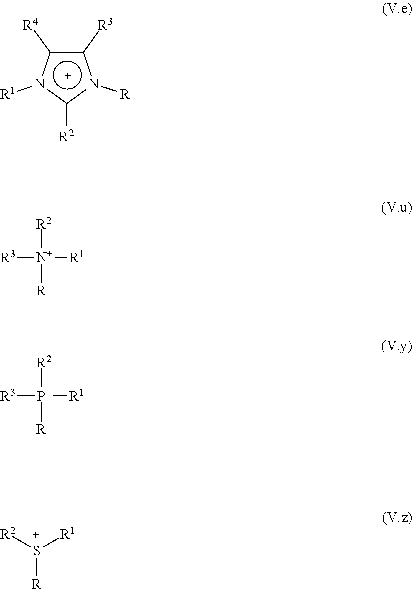

in which R is hydrogen, alkyl, alkenyl, cycloalkyl, cycloalkenyl, polycyclyl, heterocycloalkyl, aryl, or heteroaryl;

radicals R², R³ and R⁴ which are bound to a ring carbon are each, independently of one another, hydrogen, a sulfo group, COOH, carboxylate, sulfonate, acyl, alkoxycarbonyl, CO(NE¹E²), cyano, halogen, hydroxyl, SH, nitro, NE³E⁴, alkyl, alkoxy, alkylthio, alkylsulfinyl, alkylsulfonyl, alkenyl, cycloalkyl, cycloalkyloxy, cycloalkenyl, cycloalkenyloxy, polycyclyl, polycyclyloxy, heterocycloalkyl, aryl, aryloxy, or heteroaryl, wherein E¹, E², E³ and E⁴ are each, independently of one another, hydrogen, alkyl, cycloalkyl, heterocycloalkyl, aryl, or hetaryl; and the at least one ionic liquid contains 2 to 16 carbon atoms, and the at least one ionic liquid is present in an amount in the range from ≥0.2 wt. % to ≤2.0 wt. %, based on the total weight of the aqueous coating composition, in embodiment 1 or embodiment 2.

In another particularly preferred embodiment of the presently claimed invention, [Y]ⁿ⁻ is selected from anions of:
the group of sulfates, sulfites and sulfonates of the general formulae:

SO₄²⁻,HSO₄⁻,SO₃²⁻,HSO₃⁻,R^{c}OSO₃⁻,R^{c}SO₃⁻;
the group of phosphates of the general formulae:

PO₄³⁻,HPO₄²⁻,H₂PO₄⁻,R^{c}PO₄²⁻,HR^{c}PO₄⁻,R^{c}R^{d}PO₄⁻;
the group of carboxylates of the general formula:

R^{c}COO⁻;

wherein the radicals R^{c} and R^{d} are selected independently from each other from hydrogen, alkyl, cycloalkyl, heterocycloalkyl, aryl and heteroaryl, and the at least one ionic liquid contains 2 to 16 carbon atoms, and

at least one ionic liquid is present in an amount in the range from ≥0.2 wt. % to ≤2.0 wt. %, based on the total weight of the aqueous coating composition, in embodiment 1 or embodiment 2.

In a most preferred embodiment of the presently claimed invention, the at least one ionic liquid is present in an amount in the range from ≥0.4 wt. % to ≤1.2 wt. %, based on the total weight of the aqueous coating composition, in embodiment 1 or embodiment 2.

In another particularly preferred embodiment of the presently claimed invention, [A]^{m+} is selected from the group consisting of compounds of the formulae (V.e), (V.u), (V.y) and (V.z),

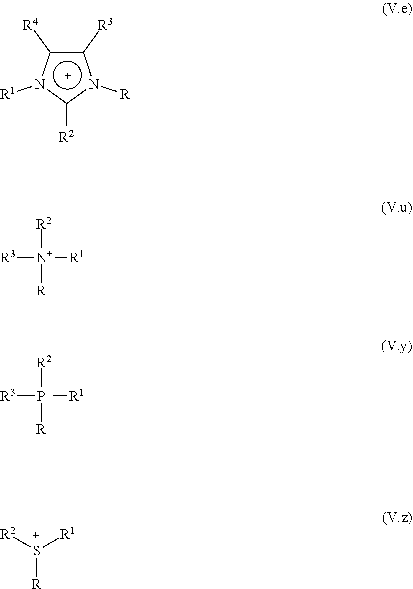

in which R is hydrogen, alkyl, alkenyl, cycloalkyl, cycloalkenyl, polycyclyl, heterocycloalkyl, aryl, or heteroaryl;

radicals R², R³ and R⁴ which are bound to a ring carbon are each, independently of one another, hydrogen, a sulfo group, COOH, carboxylate, sulfonate, acyl, alkoxycarbonyl, CO(NE¹E²), cyano, halogen, hydroxyl, SH, nitro, NE³E⁴, alkyl, alkoxy, alkylthio, alkylsulfinyl, alkylsulfonyl, alkenyl, cycloalkyl, cycloalkyloxy, cycloalkenyl, cycloalkenyloxy, polycyclyl, polycyclyloxy, heterocycloalkyl, aryl, aryloxy, or heteroaryl, wherein E¹, E², E³ and E⁴ are each, independently of one another, hydrogen, alkyl, cycloalkyl, heterocycloalkyl, aryl, or hetaryl; and

the at least one ionic liquid contains 2 to 16 carbon atoms, and the at least one ionic liquid is present in an amount in the range from ≥0.4 wt. % to ≤1.2 wt. %, based on the total weight of the aqueous coating composition, in embodiment 1 or embodiment 2.

In another particularly preferred embodiment of the presently claimed invention, [Y]ⁿ⁻ is selected from anions of:
the group of sulfates, sulfites and sulfonates of the general formulae:

SO₄²⁻,HSO₄⁻,SO₃²⁻,HSO₃⁻,R^{c}OSO₃⁻,R^{c}SO₃⁻;
the group of phosphates of the general formulae:

PO₄³⁻,HPO₄²⁻,H₂PO₄⁻,R^{c}PO₄²⁻,HR^{c}PO₄⁻,R^{c}R^{d}PO₄⁻;
the group of carboxylates of the general formula:

R^{c}COO⁻;

wherein the radicals R^{c} and R^{d} are selected independently from each other from hydrogen, alkyl, cycloalkyl, heterocycloalkyl, aryl and heteroaryl, and the at least one ionic liquid contains 2 to 16 carbon atoms, and

at least one ionic liquid is present in an amount in the range from ≥0.4 wt. % to ≤1.2 wt. %, based on the total weight of the aqueous coating composition, in embodiment 1 or embodiment 2.

In a preferred embodiment of the presently claimed invention, the at least one silicate binder is selected from the group consisting of colloidal silica, potassium silicate, sodium silicate, lithium silicate, and combinations thereof, in embodiment 1 or embodiment 2.

In a more preferred embodiment of the presently claimed invention, the at least one silicate binder is colloidal silica, in embodiment 1 or embodiment 2.

In a preferred embodiment of the presently claimed invention, the at least one silicate binder is present in an amount in the range from ≥10.0 wt. % to ≤50.0 wt. %, based on the total weight of the aqueous coating composition, in embodiment 1 or embodiment 2.

In another particularly preferred embodiment of the presently claimed invention, [A]^{m+} is selected from the group consisting of compounds of the formulae (V.e), (V.u), (V.y) and (V.z),

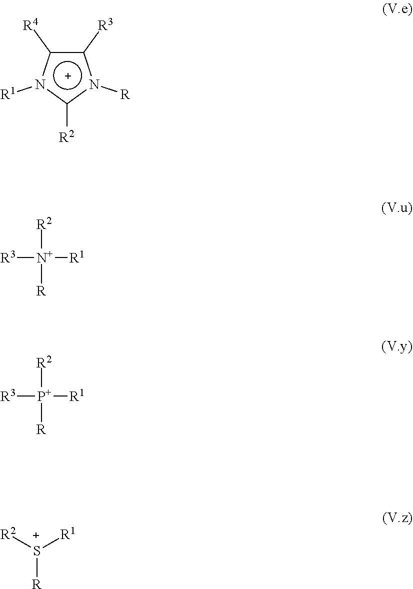

in which R is hydrogen, alkyl, alkenyl, cycloalkyl, cycloalkenyl, polycyclyl, heterocycloalkyl, aryl, or heteroaryl;

radicals R², R³ and R⁴ which are bound to a ring carbon are each, independently of one another, hydrogen, a sulfo group, COOH, carboxylate, sulfonate, acyl, alkoxycarbonyl, CO(NE¹E²), cyano, halogen, hydroxyl, SH, nitro, NE³E⁴, alkyl, alkoxy, alkylthio, alkylsulfinyl, alkylsulfonyl, alkenyl, cycloalkyl, cycloalkyloxy, cycloalkenyl, cycloalkenyloxy, polycyclyl, polycyclyloxy, heterocycloalkyl, aryl, aryloxy, or heteroaryl, wherein E¹, E², E³ and E⁴ are each, independently of one another, hydrogen, alkyl, cycloalkyl, heterocycloalkyl, aryl, or hetaryl; and the at least one ionic liquid contains 2 to 16 carbon atoms, and the at least one silicate binder is present in an amount in the range from ≥10.0 wt. % to ≤50.0 wt. %, based on the total weight of the aqueous coating composition, in embodiment 1 or embodiment 2.

In another particularly preferred embodiment of the presently claimed invention, [Y]ⁿ⁻ is selected from anions of:
the group of sulfates, sulfites and sulfonates of the general formulae:

SO₄²⁻,HSO₄⁻,SO₃²⁻,HSO₃⁻,R^{c}OSO₃⁻,R^{c}SO₃⁻;
the group of phosphates of the general formulae:

PO₄³⁻,HPO₄²⁻,H₂PO₄⁻,R^{c}PO₄²⁻,HR^{c}PO₄⁻,R^{c}R^{d}PO₄⁻;
the group of carboxylates of the general formula:

R^{c}COO⁻;

wherein the radicals R^{c} and R^{d} are selected independently from each other from hydrogen, alkyl, cycloalkyl, heterocycloalkyl, aryl and heteroaryl,

and the at least one ionic liquid contains 2 to 16 carbon atoms, and

the at least one silicate binder is present in an amount in the range from ≥10.0 wt. % to ≤50.0 wt. %, based on the total weight of the aqueous coating composition, in embodiment 1 or embodiment 2.

In a more preferred embodiment of the presently claimed invention, the at least one silicate binder is present in an amount in the range from ≥15.0 wt. % to ≤30.0 wt. %, based on the total weight of the aqueous coating composition, in embodiment 1 or embodiment 2.

In another particularly preferred embodiment of the presently claimed invention, [A]^{m+} is selected from the group consisting of compounds of the formulae (V.e), (V.u), (V.y) and (V.z),

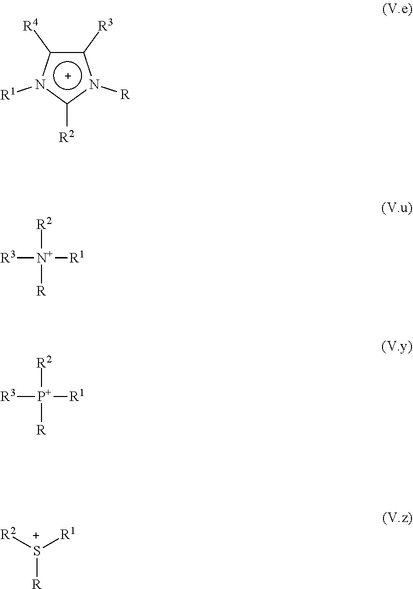

in which R is hydrogen, alkyl, alkenyl, cycloalkyl, cycloalkenyl, polycyclyl, heterocycloalkyl, aryl, or heteroaryl;

radicals R², R³ and R⁴ which are bound to a ring carbon are each, independently of one another, hydrogen, a sulfo group, COOH, carboxylate, sulfonate, acyl, alkoxycarbonyl, CO(NE¹E²), cyano, halogen, hydroxyl, SH, nitro, NE³E⁴, alkyl, alkoxy, alkylthio, alkylsulfinyl, alkylsulfonyl, alkenyl, cycloalkyl, cycloalkyloxy, cycloalkenyl, cycloalkenyloxy, polycyclyl, polycyclyloxy, heterocycloalkyl, aryl, aryloxy, or heteroaryl, wherein E¹, E², E³ and E⁴ are each, independently of one another, hydrogen, alkyl, cycloalkyl, heterocycloalkyl, aryl, or hetaryl; and

the at least one ionic liquid contains 2 to 16 carbon atoms, and the at least one silicate binder is present in an amount in the range from ≥15.0 wt. % to ≤30.0 wt. %, based on the total weight of the aqueous coating composition, in embodiment 1 or embodiment 2.

In another particularly preferred embodiment of the presently claimed invention, [Y]ⁿ⁻ is selected from anions of:
the group of sulfates, sulfites and sulfonates of the general formulae:

SO₄²⁻,HSO₄⁻,SO₃²⁻,HSO₃⁻,R^{c}OSO₃⁻,R^{c}SO₃⁻;
the group of phosphates of the general formulae:

PO₄³⁻,HPO₄²⁻,H₂PO₄⁻,R^{c}PO₄²⁻,HR^{c}PO₄⁻,R^{c}R^{d}PO₄⁻;
the group of carboxylates of the general formula:

R^{c}COO⁻;

wherein the radicals R^{c} and R^{d} are selected independently from each other from hydrogen, alkyl, cycloalkyl, heterocycloalkyl, aryl and heteroaryl,

and the at least one ionic liquid contains 2 to 16 carbon atoms, and the at least one silicate binder is present in an amount in the range from ≥15.0 wt. % to ≤30.0 wt. %, based on the total weight of the aqueous coating composition, in embodiment 1 or embodiment 2.

In a most preferred embodiment of the presently claimed invention, the at least one silicate binder is present in an amount in the range from ≥15.0 wt. % to ≤22.0 wt. %, based on the total weight of the aqueous coating composition, in embodiment 1 or embodiment 2.

In another particularly preferred embodiment of the presently claimed invention, [A]^{m+} is selected from the group consisting of compounds of the formulae (V.e), (V.u), (V.y) and (V.z),

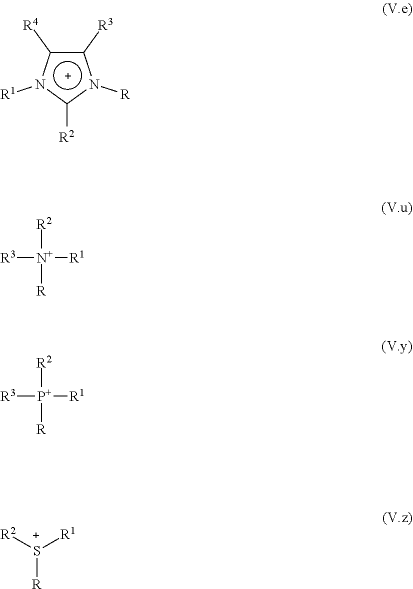

in which R is hydrogen, alkyl, alkenyl, cycloalkyl, cycloalkenyl, polycyclyl, heterocycloalkyl, aryl, or heteroaryl;

radicals R², R³ and R⁴ which are bound to a ring carbon are each, independently of one another, hydrogen, a sulfo group, COOH, carboxylate, sulfonate, acyl, alkoxycarbonyl, CO(NE¹E²), cyano, halogen, hydroxyl, SH, nitro, NE³E⁴, alkyl, alkoxy, alkylthio, alkylsulfinyl, alkylsulfonyl, alkenyl, cycloalkyl, cycloalkyloxy, cycloalkenyl, cycloalkenyloxy, polycyclyl, polycyclyloxy, heterocycloalkyl, aryl, aryloxy, or heteroaryl, wherein E¹, E², E³ and E⁴ are each, independently of one another, hydrogen, alkyl, cycloalkyl, heterocycloalkyl, aryl, or hetaryl; and

the at least one ionic liquid contains 2 to 16 carbon atoms, and the at least one silicate binder is present in an amount in the range from ≥15.0 wt. % to ≤22.0 wt. %, based on the total weight of the aqueous coating composition, in embodiment 1 or embodiment 2.

In another particularly preferred embodiment of the presently claimed invention, [Y]ⁿ⁻ is selected from anions of:
the group of sulfates, sulfites and sulfonates of the general formulae:

SO₄²⁻,HSO₄⁻,SO₃²⁻,HSO₃⁻,R^{c}OSO₃⁻,R^{c}SO₃⁻;
the group of phosphates of the general formulae:

PO₄³⁻,HPO₄²⁻,H₂PO₄⁻,R^{c}PO₄²⁻,HR^{c}PO₄⁻,R^{c}R^{d}PO₄⁻;
the group of carboxylates of the general formula:

R^{c}COO⁻;

wherein the radicals R^{c} and R^{d} are selected independently from each other from hydrogen, alkyl, cycloalkyl, heterocycloalkyl, aryl and heteroaryl,

and the at least one ionic liquid contains 2 to 16 carbon atoms, and the at least one silicate binder is present in an amount in the range from ≥15.0 wt. % to ≤22.0 wt. %, based on the total weight of the aqueous coating composition, in embodiment 1 or embodiment 2.

In a preferred embodiment of the presently claimed invention, the weight ratio of the at least one ionic liquid to the at least one silicate binder is in the range from 1:1000 to 1:2, in embodiment 1 or embodiment 2.

In a more preferred embodiment of the presently claimed invention, the weight ratio of the at least one ionic liquid to the at least one silicate binder is in the range from 1:150 to 1:7.5, in embodiment 1 or embodiment 2.

In a most preferred embodiment of the presently claimed invention, the weight ratio of the at least one ionic liquid to the at least one silicate binder is in the range from 1:48 to 1:15, in embodiment 1 or embodiment 2.

In another particularly preferred embodiment of the presently claimed invention, [A]^{m+} is selected from the group consisting of compounds of the formulae (V.e), (V.u), (V.y) and (V.z),

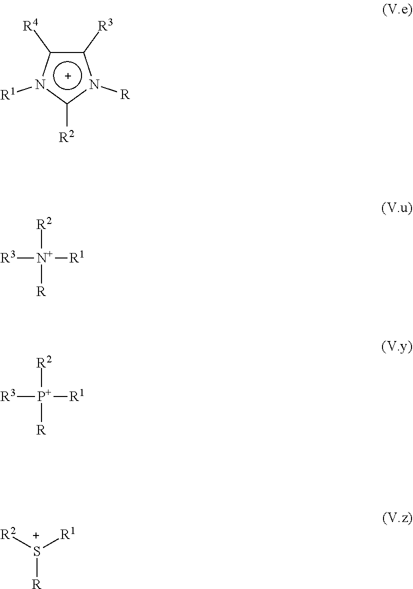

in which R is hydrogen, alkyl, alkenyl, cycloalkyl, cycloalkenyl, polycyclyl, heterocycloalkyl, aryl, or heteroaryl;

radicals R², R³ and R⁴ which are bound to a ring carbon are each, independently of one another, hydrogen, a sulfo group, COOH, carboxylate, sulfonate, acyl, alkoxycarbonyl, CO(NE¹E²), cyano, halogen, hydroxyl, SH, nitro, NE³E⁴, alkyl, alkoxy, alkylthio, alkylsulfinyl, alkylsulfonyl, alkenyl, cycloalkyl, cycloalkyloxy, cycloalkenyl, cycloalkenyloxy, polycyclyl, polycyclyloxy, heterocycloalkyl, aryl, aryloxy, or heteroaryl, wherein E¹, E², E³ and E⁴ are each, independently of one another, hydrogen, alkyl, cycloalkyl, heterocycloalkyl, aryl, or hetaryl; and

the at least one ionic liquid contains 2 to 16 carbon atoms, and

the weight ratio of the at least one ionic liquid to the at least one silicate binder is in the range from 1:150 to 1:7.5, in embodiment 1 or embodiment 2.

In another particularly preferred embodiment of the presently claimed invention, [Y]ⁿ⁻ is selected from anions of:
the group of sulfates, sulfites and sulfonates of the general formulae:

SO₄²⁻,HSO₄⁻,SO₃²⁻,HSO₃⁻,R^{c}OSO₃⁻,R^{c}SO₃⁻;
the group of phosphates of the general formulae:

PO₄³⁻,HPO₄²⁻,H₂PO₄⁻,R^{c}PO₄²⁻,HR^{c}PO₄⁻,R^{c}R^{d}PO₄⁻;
the group of carboxylates of the general formula:

R^{c}COO⁻;

wherein the radicals R^{c} and R^{d} are selected independently from each other from hydrogen, alkyl, cycloalkyl, heterocycloalkyl, aryl and heteroaryl,

and the at least one ionic liquid contains 2 to 16 carbon atoms, and

the weight ratio of the at least one ionic liquid to the at least one silicate binder is in the range from 1:1000 to 1:2, in embodiment 1 or embodiment 2.

In another particularly preferred embodiment of the presently claimed invention, [A]^{m+} is selected from the group consisting of compounds of the formulae (V.e), (V.u), (V.y) and (V.z),

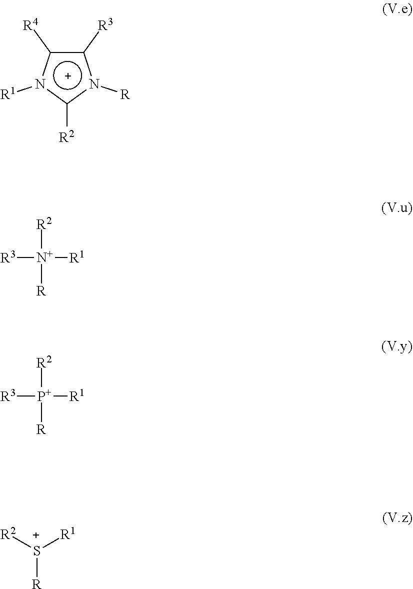

in which R is hydrogen, alkyl, alkenyl, cycloalkyl, cycloalkenyl, polycyclyl, heterocycloalkyl, aryl, or heteroaryl;

radicals R², R³ and R⁴ which are bound to a ring carbon are each, independently of one another, hydrogen, a sulfo group, COOH, carboxylate, sulfonate, acyl, alkoxycarbonyl, CO(NE¹E²), cyano, halogen, hydroxyl, SH, nitro, NE³E⁴, alkyl, alkoxy, alkylthio, alkylsulfinyl, alkylsulfonyl, alkenyl, cycloalkyl, cycloalkyloxy, cycloalkenyl, cycloalkenyloxy, polycyclyl, polycyclyloxy, heterocycloalkyl, aryl, aryloxy, or heteroaryl, wherein E¹, E², E³ and E⁴ are each, independently of one another, hydrogen, alkyl, cycloalkyl, heterocycloalkyl, aryl, or hetaryl; and

the at least one ionic liquid contains 2 to 16 carbon atoms, and

the weight ratio of the at least one ionic liquid to the at least one silicate binder is in the range from 1:150 to 1:7.5, in embodiment 1 or embodiment 2.

In another particularly preferred embodiment of the presently claimed invention, [Y]ⁿ⁻ is selected from anions of:
the group of sulfates, sulfites and sulfonates of the general formulae:

SO₄²⁻,HSO₄⁻,SO₃²⁻,HSO₃⁻,R^{c}OSO₃⁻,R^{c}SO₃⁻;
the group of phosphates of the general formulae:

PO₄³⁻,HPO₄²⁻,H₂PO₄⁻,R^{c}PO₄²⁻,HR^{c}PO₄⁻,R^{c}R^{d}PO₄⁻;
the group of carboxylates of the general formula:

R^{c}COO⁻;

wherein the radicals R^{c} and R^{d} are selected independently from each other from hydrogen, alkyl, cycloalkyl, heterocycloalkyl, aryl and heteroaryl,

and the at least one ionic liquid contains 2 to 16 carbon atoms, and

the weight ratio of the at least one ionic liquid to the at least one silicate binder is in the range from 1:150 to 1:7.5, in embodiment 1 or embodiment 2.

In another particularly preferred embodiment of the presently claimed invention, [A]^{m+} is selected from the group consisting of compounds of the formulae (V.e), (V.u), (V.y) and (V.z),

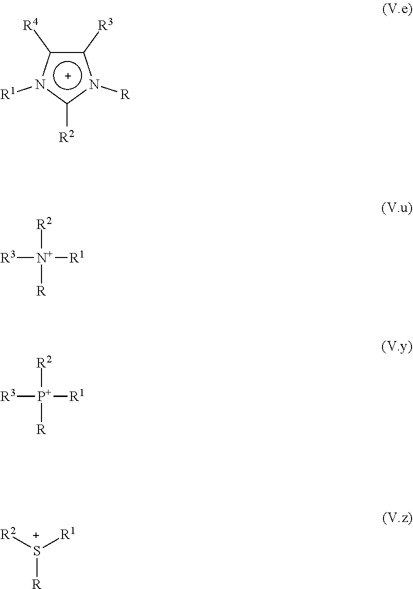

in which R is hydrogen, alkyl, alkenyl, cycloalkyl, cycloalkenyl, polycyclyl, heterocycloalkyl, aryl, or heteroaryl;

radicals R², R³ and R⁴ which are bound to a ring carbon are each, independently of one another, hydrogen, a sulfo group, COOH, carboxylate, sulfonate, acyl, alkoxycarbonyl, CO(NE¹E²), cyano, halogen, hydroxyl, SH, nitro, NE³E⁴, alkyl, alkoxy, alkylthio, alkylsulfinyl, alkylsulfonyl, alkenyl, cycloalkyl, cycloalkyloxy, cycloalkenyl, cycloalkenyloxy, polycyclyl, polycyclyloxy, heterocycloalkyl, aryl, aryloxy, or heteroaryl, wherein E¹, E², E³ and E⁴ are each, independently of one another, hydrogen, alkyl, cycloalkyl, heterocycloalkyl, aryl, or hetaryl; and

the at least one ionic liquid contains 2 to 16 carbon atoms, and

the weight ratio of the at least one ionic liquid to the at least one silicate binder is in the range from 1:48 to 1:15, in embodiment 1 or embodiment 2.

In another particularly preferred embodiment of the presently claimed invention, [Y]ⁿ⁻ is selected from anions of:
the group of sulfates, sulfites and sulfonates of the general formulae:

SO₄²⁻,HSO₄⁻,SO₃²⁻,HSO₃⁻,R^{c}OSO₃⁻,R^{c}SO₃⁻;
the group of phosphates of the general formulae:

PO₄³⁻,HPO₄²⁻,H₂PO₄⁻,R^{c}PO₄²⁻,HR^{c}PO₄⁻,R^{c}R^{d}PO₄⁻;
the group of carboxylates of the general formula:

R^{c}COO⁻;

wherein the radicals R^{c} and R^{d} are selected independently from each other from hydrogen, alkyl, cycloalkyl, heterocycloalkyl, aryl and heteroaryl,

and the at least one ionic liquid contains 2 to 16 carbon atoms, and

the weight ratio of the at least one ionic liquid to the at least one silicate binder is in the range from 1:48 to 1:15, in embodiment 1 or embodiment 2.

Another aspect of the presently claimed invention is embodiment 3, directed to an aqueous composition comprising:
i) at least one ionic liquid of embodiment 1 or embodiment 2, selected from the group consisting of (IL1), (IL2), (IL3), and (IL4),
ii) at least one white pigment; and
iii) at least one silicate binder,
wherein
(IL1) salts of the general formula (I)

[A]ₚ^{m+}[Y]_{q}ⁿ⁻ (I),
wherein
m, n, p, and q are each 1, 2, 3, or 4 and the product of p and m is equal to the product of q and n;
[A]^{m+} is
i) a monovalent, divalent, trivalent, or tetravalent cation selected from ammonium groups, oxonium groups, sulfonium groups, and phosphonium groups; or
ii) a cationic compound comprising two or more cationic groups which are selected independently from ammonium groups, oxonium groups, sulfonium groups, and phosphonium groups; and
[Y]ⁿ⁻ is a monovalent, divalent, trivalent, or tetravalent anion or a mixture of these anions;
(IL2) mixed salts of the general formulae (II.a), (II.b) or (II.c)

[A¹]⁺[A²]⁺[Y]ⁿ⁻ (II.a),
wherein n=2,

[A¹]⁺[A²]⁺[A³]⁺[Y]ⁿ⁻ (II.b),
wherein n=3,

[A¹]⁺[A²]⁺[A³]⁺[A⁴]⁺[Y]ⁿ⁻ (II.c),
wherein n=4, and
wherein [A¹]⁺, [A²]⁺, [A³]⁺ and [A⁴]⁺ is are monovalent cations selected from [A]^{m+}; and [Y]ⁿ⁻ is a monovalent, divalent, trivalent, or tetravalent anion or a mixture of these anions;
(IL3) mixed salts of the general formulae (III.a) to (III.h)

[A¹]²⁺[A²]⁺[Y]ⁿ⁻ (III.a),
wherein n=3,

[A¹]²⁺[A²]⁺[A³]⁺[Y]ⁿ⁻ (III.b),
wherein n=4,

[A¹]²⁺[A⁴]²⁺[Y]ⁿ⁻ (III.c),
wherein n=4,

[A⁵]³⁺[A²]⁺[Y]ⁿ⁻ (III.d),
wherein n=4,

[A¹]²⁺[A²]⁺[A³]⁺[A⁶]⁺[Y]ⁿ⁻ (III.e),
wherein n=5,

[A¹]²⁺[A⁴]²⁺[A⁶]⁺[Y]ⁿ⁻ (III.f),
wherein n=5,

[A⁵]³⁺[A²]⁺[A³]⁺[Y]ⁿ⁻ (III.g),
wherein n=5,

[A⁷]⁴⁺[A²]⁺[Y]ⁿ⁻ (III.h),
wherein n=5, and
wherein [A¹]²⁺, [A²]⁺, [A³]⁺, [A⁴]²⁺, [A⁵]³⁺, [A⁶]⁺, and [A⁷]⁴⁺ are monovalent, divalent, trivalent, or tetravalent cations selected from [A]^{m+}; and [Y]ⁿ⁻ is a monovalent, divalent, trivalent, or tetravalent anion or a mixture of these anions; and
(IL4) mixed salts of the general formulae (IV.a) to (IV.j)

[A¹]⁺[A²]⁺[A³]⁺[M¹]⁺[Y]ⁿ⁻ (IV.a),
wherein n=4,

[A¹]⁺[A²]⁺[M¹]⁺[M²]⁺[Y]ⁿ⁻ (IV.b),
wherein n=4,

[A¹]⁺[M¹]⁺[M²]⁺[M³]⁺[Y]ⁿ⁻ (IV.c),
wherein n=4,

[A¹]⁺[A²]⁺[M¹]⁺[Y]ⁿ⁻ (IV.d),
wherein n=3,

[A¹]⁺[M¹]⁺[M²]⁺[Y]ⁿ⁻ (IV.e),
wherein n=3,

[A¹]⁺[M¹]⁺[Y]ⁿ⁻ (IV.f),
wherein n=2,

[A¹]⁺[A²]⁺[M⁴]²⁺[Y]ⁿ⁻ (IV.g),
wherein n=4,

[A¹]⁺[M¹]⁺[M⁴]²⁺[Y]ⁿ⁻ (IV.h),
wherein n=4,

[A¹]⁺[M⁵]³⁺[Y]ⁿ⁻ (IV.i),
wherein n=4,

[A¹]⁺[M⁴]²⁺[Y]ⁿ⁻ (IV.j),
wherein n=3, and
wherein [A¹]⁺, [A²]⁺, and [A³]⁺ are monovalent, divalent, trivalent or tetravalent cations selected from [A]^{m+}; [Y]ⁿ⁻ is a monovalent, divalent, trivalent, or tetravalent anion or a mixture of these anions; and [M¹]⁺, [M²], and [M³]⁺ are monovalent metal cations, [M⁴]²⁺ are divalent metal cations and [M⁵]³⁺ are trivalent metal cations.

In a preferred embodiment of the presently claimed invention, the aqueous composition of embodiment 3 comprises the ionic liquid of embodiment 1 or 2. Therefore, all the preferred limitations, embodiments and definitions defined hereinabove, are applicable to embodiment 3.

In a preferred embodiment of the presently claimed invention, the aqueous coating composition further comprises at least one dispersant selected from the group of alkoxylated polycarboxylates, based on the total weight of the aqueous coating composition, in embodiment 3.

In a more preferred embodiment of the presently claimed invention, the alkoxylated polycarboxylate is an ammonium polyacrylate, in embodiment 3.

In a preferred embodiment of the presently claimed invention, the at least one dispersant is present in an amount in the range from ≥0.05 wt. % to ≤2.0 wt. %, based on the total weight of the aqueous coating composition, in embodiment 3.

In another particularly preferred embodiment of the presently claimed invention, [A]^{m+} is selected from the group consisting of compounds of the formulae (V.e), (V.u), (V.y) and (V.z),

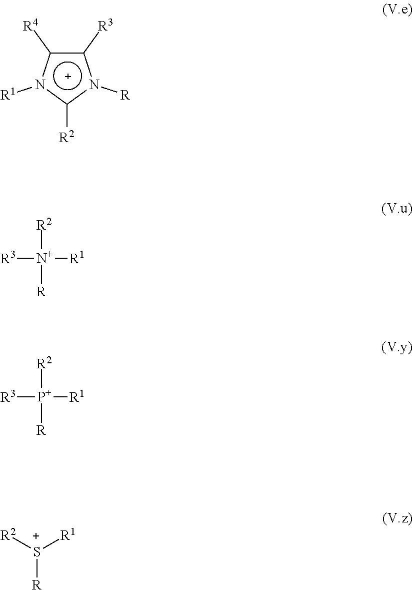

in which R is hydrogen, alkyl, alkenyl, cycloalkyl, cycloalkenyl, polycyclyl, heterocycloalkyl, aryl, or heteroaryl;

radicals R², R³ and R⁴ which are bound to a ring carbon are each, independently of one another, hydrogen, a sulfo group, COOH, carboxylate, sulfonate, acyl, alkoxycarbonyl, CO(NE¹E²), cyano, halogen, hydroxyl, SH, nitro, NE³E⁴, alkyl, alkoxy, alkylthio, alkylsulfinyl, alkylsulfonyl, alkenyl, cycloalkyl, cycloalkyloxy, cycloalkenyl, cycloalkenyloxy, polycyclyl, polycyclyloxy, heterocycloalkyl, aryl, aryloxy, or heteroaryl, wherein E¹, E², E³ and E⁴ are each, independently of one another, hydrogen, alkyl, cycloalkyl, heterocycloalkyl, aryl, or hetaryl; and

the at least one ionic liquid contains 2 to 16 carbon atoms, and the at least one dispersant is present in an amount in the range from ≥0.05 wt. % to ≤2.0 wt. %, based on the total weight of the aqueous coating composition, in embodiment 3.

In another particularly preferred embodiment of the presently claimed invention, [Y]ⁿ⁻ is selected from anions of:
the group of sulfates, sulfites and sulfonates of the general formulae:

SO₄²⁻,HSO₄⁻,SO₃²⁻,HSO₃⁻,R^{c}OSO₃⁻,R^{c}SO₃⁻;
the group of phosphates of the general formulae:

PO₄³⁻,HPO₄²⁻,H₂PO₄⁻,R^{c}PO₄²⁻,HR^{c}PO₄⁻,R^{c}R^{d}PO₄⁻;
the group of carboxylates of the general formula:

R^{c}COO⁻;

wherein the radicals R^{c} and R^{d} are selected independently from each other from hydrogen, alkyl, cycloalkyl, heterocycloalkyl, aryl and heteroaryl,

and the at least one ionic liquid contains 2 to 16 carbon atoms, and

the at least one dispersant is present in an amount in the range from ≥0.05 wt. % to ≤2.0 wt. %, based on the total weight of the aqueous coating composition, in embodiment 3.

In a more preferred embodiment of the presently claimed invention, the at least one dispersant is present in an amount in the range from ≥0.1 wt. % to ≤1.0 wt. %, based on the total weight of the aqueous coating composition, in embodiment 3.

In another particularly preferred embodiment of the presently claimed invention, [A]^{m+} is selected from the group consisting of compounds of the formulae (V.e), (V.u), (V.y) and (V.z),

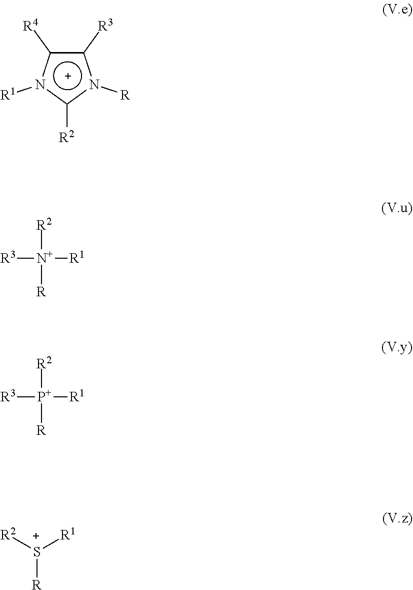

in which R is hydrogen, alkyl, alkenyl, cycloalkyl, cycloalkenyl, polycyclyl, heterocycloalkyl, aryl, or heteroaryl;

radicals R², R³ and R⁴ which are bound to a ring carbon are each, independently of one another, hydrogen, a sulfo group, COOH, carboxylate, sulfonate, acyl, alkoxycarbonyl, CO(NE¹E²), cyano, halogen, hydroxyl, SH, nitro, NE³E⁴, alkyl, alkoxy, alkylthio, alkylsulfinyl, alkylsulfonyl, alkenyl, cycloalkyl, cycloalkyloxy, cycloalkenyl, cycloalkenyloxy, polycyclyl, polycyclyloxy, heterocycloalkyl, aryl, aryloxy, or heteroaryl, wherein E¹, E², E³ and E⁴ are each, independently of one another, hydrogen, alkyl, cycloalkyl, heterocycloalkyl, aryl, or hetaryl; and

the at least one ionic liquid contains 2 to 16 carbon atoms, and the at least one dispersant is present in an amount in the range from ≥0.1 wt. % to ≤1.0 wt. %, based on the total weight of the aqueous coating composition, in embodiment 3.

In another particularly preferred embodiment of the presently claimed invention, [Y]ⁿ⁻ is selected from anions of:
the group of sulfates, sulfites and sulfonates of the general formulae:

SO₄²⁻,HSO₄⁻,SO₃²⁻,HSO₃⁻,R^{c}OSO₃⁻,R^{c}SO₃⁻;
the group of phosphates of the general formulae:

PO₄³⁻,HPO₄²⁻,H₂PO₄⁻,R^{c}PO₄²⁻,HR^{c}PO₄⁻,R^{c}R^{d}PO₄⁻;
the group of carboxylates of the general formula:

R^{c}COO⁻;

wherein the radicals R^{c} and R^{d} are selected independently from each other from hydrogen, alkyl, cycloalkyl, heterocycloalkyl, aryl and heteroaryl,

and the at least one ionic liquid contains 2 to 16 carbon atoms, and the at least one dispersant is present in an amount in the range from ≥0.1 wt. % to ≤1.0 wt. %, based on the total weight of the aqueous coating composition, in embodiment 3.

In a preferred embodiment of the presently claimed invention, the aqueous coating composition further comprises at least one filler selected from the group consisting of natural calcium carbonate, calcite, marble, chalk, mica, feldspar, beryl, wollastonite, quartz, talc, kaolin, pozzolanic earth, calcium silicate, aluminum silicate, magnesium silicate, zinc silicate, barium sulfate, and combinations thereof, in embodiment 3.

In a more preferred embodiment of the presently claimed invention, the aqueous coating composition further comprises at least one filler selected from natural calcium carbonate, in embodiment 3. Synthetic or precipitated calcium carbonate was found to be less suited in comparison to natural carbonate.

In a preferred embodiment of the presently claimed invention, the at least one filler is present in an amount in the range from ≥5.0 wt. % to ≤80.0 wt. %, based on the total weight of the aqueous coating composition, in embodiment 3.

In another particularly preferred embodiment of the presently claimed invention, [A]^{m+} is selected from the group consisting of compounds of the formulae (V.e), (V.u), (V.y) and (V.z),

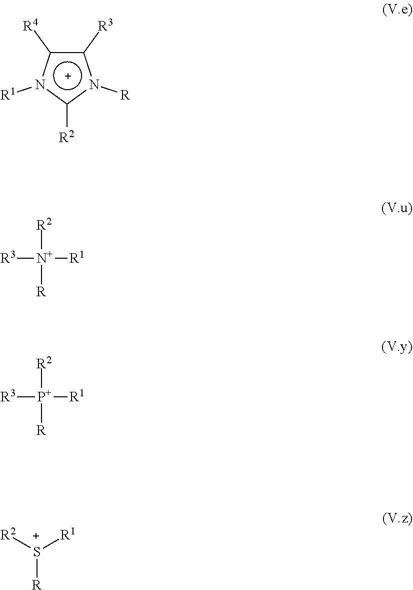

in which R is hydrogen, alkyl, alkenyl, cycloalkyl, cycloalkenyl, polycyclyl, heterocycloalkyl, aryl, or heteroaryl;

radicals R², R³ and R⁴ which are bound to a ring carbon are each, independently of one another, hydrogen, a sulfo group, COOH, carboxylate, sulfonate, acyl, alkoxycarbonyl, CO(NE¹E²), cyano, halogen, hydroxyl, SH, nitro, NE³E⁴, alkyl, alkoxy, alkylthio, alkylsulfinyl, alkylsulfonyl, alkenyl, cycloalkyl, cycloalkyloxy, cycloalkenyl, cycloalkenyloxy, polycyclyl, polycyclyloxy, heterocycloalkyl, aryl, aryloxy, or heteroaryl, wherein E¹, E², E³ and E⁴ are each, independently of one another, hydrogen, alkyl, cycloalkyl, heterocycloalkyl, aryl, or hetaryl; and

the at least one ionic liquid contains 2 to 16 carbon atoms, and the at least one filler is present in an amount in the range from ≥5.0 wt. % to ≤80.0 wt. %, based on the total weight of the aqueous coating composition, in embodiment 3.

In another particularly preferred embodiment of the presently claimed invention, [Y]ⁿ⁻ is selected from anions of:
the group of sulfates, sulfites and sulfonates of the general formulae:

SO₄²⁻,HSO₄⁻,SO₃²⁻,HSO₃⁻,R^{c}OSO₃⁻,R^{c}SO₃⁻;
the group of phosphates of the general formulae:

PO₄³⁻,HPO₄²⁻,H₂PO₄⁻,R^{c}PO₄²⁻,HR^{c}PO₄⁻,R^{c}R^{d}PO₄⁻;
the group of carboxylates of the general formula:

R^{c}COO⁻;

wherein the radicals R^{c} and R^{d} are selected independently from each other from hydrogen, alkyl, cycloalkyl, heterocycloalkyl, aryl and heteroaryl,

and the at least one ionic liquid contains 2 to 16 carbon atoms, and

the at least one filler is present in an amount in the range from ≥5.0 wt. % to ≤80.0 wt. %, based on the total weight of the aqueous coating composition, in embodiment 3.

In a more preferred embodiment of the presently claimed invention, the at least one filler is present in an amount in the range from ≥30.0 wt. % to ≤60.0 wt. %, based on the total weight of the aqueous coating composition, in embodiment 3.

In another particularly preferred embodiment of the presently claimed invention, [A]^{m+} is selected from the group consisting of compounds of the formulae (V.e), (V.u), (V.y) and (V.z),

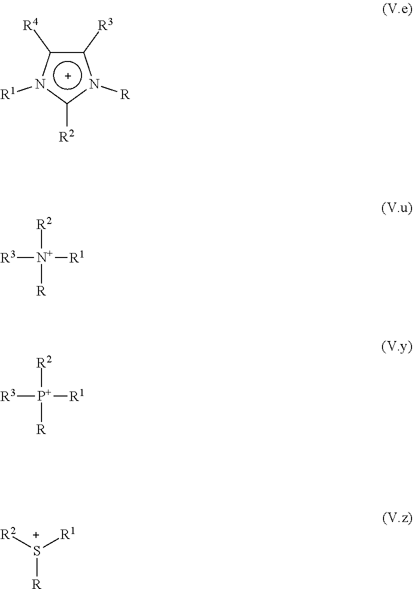

in which R is hydrogen, alkyl, alkenyl, cycloalkyl, cycloalkenyl, polycyclyl, heterocycloalkyl, aryl, or heteroaryl;

radicals R², R³ and R⁴ which are bound to a ring carbon are each, independently of one another, hydrogen, a sulfo group, COOH, carboxylate, sulfonate, acyl, alkoxycarbonyl, CO(NE¹E²), cyano, halogen, hydroxyl, SH, nitro, NE³E⁴, alkyl, alkoxy, alkylthio, alkylsulfinyl, alkylsulfonyl, alkenyl, cycloalkyl, cycloalkyloxy, cycloalkenyl, cycloalkenyloxy, polycyclyl, polycyclyloxy, heterocycloalkyl, aryl, aryloxy, or heteroaryl, wherein E¹, E², E³ and E⁴ are each, independently of one another, hydrogen, alkyl, cycloalkyl, heterocycloalkyl, aryl, or hetaryl; and

the at least one ionic liquid contains 2 to 16 carbon atoms, and the at least one filler is present in an amount in the range from ≥30.0 wt. % to ≤60.0 wt. %, based on the total weight of the aqueous coating composition, in embodiment 3.

In another particularly preferred embodiment of the presently claimed invention, [Y]ⁿ⁻ is selected from anions of:
the group of sulfates, sulfites and sulfonates of the general formulae:

SO₄²⁻,HSO₄⁻,SO₃²⁻,HSO₃⁻,R^{c}OSO₃⁻,R^{c}SO₃⁻;
the group of phosphates of the general formulae:

PO₄³⁻,HPO₄²⁻,H₂PO₄⁻,R^{c}PO₄²⁻,HR^{c}PO₄⁻,R^{c}R^{d}PO₄⁻;
the group of carboxylates of the general formula:

R^{c}COO⁻;

wherein the radicals R^{c} and R^{d} are selected independently from each other from hydrogen, alkyl, cycloalkyl, heterocycloalkyl, aryl and heteroaryl,

and the at least one ionic liquid contains 2 to 16 carbon atoms, and

the at least one filler is present in an amount in the range from ≥30.0 wt. % to ≤60.0 wt. %, based on the total weight of the aqueous coating composition, in embodiment 3.

In a preferred embodiment of the presently claimed invention, the at least one white pigment is selected from the group consisting of titanium dioxide, rutile, anatase, barium sulfate, zinc oxide, zinc sulfide, and combinations thereof, in embodiment 3.

In a more preferred embodiment of the presently claimed invention, the at least one white pigment is titanium dioxide, in embodiment 3.

In a preferred embodiment of the presently claimed invention, the at least one white pigment is present in an amount in the range from ≥1.0 wt. % to ≤10.0 wt. %, based on the total weight of the aqueous coating composition, in embodiment 3.

In another particularly preferred embodiment of the presently claimed invention, [A]^{m+} is selected from the group consisting of compounds of the formulae (V.e), (V.u), (V.y) and (V.z),

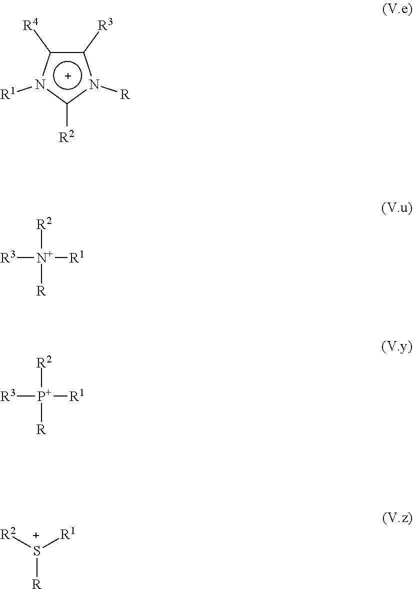

in which R is hydrogen, alkyl, alkenyl, cycloalkyl, cycloalkenyl, polycyclyl, heterocycloalkyl, aryl, or heteroaryl;

radicals R², R³ and R⁴ which are bound to a ring carbon are each, independently of one another, hydrogen, a sulfo group, COOH, carboxylate, sulfonate, acyl, alkoxycarbonyl, CO(NE¹E²), cyano, halogen, hydroxyl, SH, nitro, NE³E⁴, alkyl, alkoxy, alkylthio, alkylsulfinyl, alkylsulfonyl, alkenyl, cycloalkyl, cycloalkyloxy, cycloalkenyl, cycloalkenyloxy, polycyclyl, polycyclyloxy, heterocycloalkyl, aryl, aryloxy, or heteroaryl, wherein E¹, E², E³ and E⁴ are each, independently of one another, hydrogen, alkyl, cycloalkyl, heterocycloalkyl, aryl, or hetaryl; and

the at least one ionic liquid contains 2 to 16 carbon atoms, and the at least one white pigment is present in an amount in the range from ≥1.0 wt. % to ≤10.0 wt. %, based on the total weight of the aqueous coating composition, in embodiment 3.

In another particularly preferred embodiment of the presently claimed invention, [Y]ⁿ⁻ is selected from anions of:
the group of sulfates, sulfites and sulfonates of the general formulae:

SO₄²⁻,HSO₄⁻,SO₃²⁻,HSO₃⁻,R^{c}OSO₃⁻,R^{c}SO₃⁻;
the group of phosphates of the general formulae:

PO₄³⁻,HPO₄²⁻,H₂PO₄⁻,R^{c}PO₄²⁻,HR^{c}PO₄⁻,R^{c}R^{d}PO₄⁻;
the group of carboxylates of the general formula:

R^{c}COO⁻;

wherein the radicals R^{c} and R^{d} are selected independently from each other from hydrogen, alkyl, cycloalkyl, heterocycloalkyl, aryl and heteroaryl,

and the at least one ionic liquid contains 2 to 16 carbon atoms, and

the at least one white pigment is present in an amount in the range from ≥1.0 wt. % to ≤10.0 wt. %, based on the total weight of the aqueous coating composition, in embodiment 3.

In a more preferred embodiment of the presently claimed invention, the at least one white pigment is present in an amount in the range from ≥3.0 wt. % to ≤9.0 wt. %, based on the total weight of the aqueous coating composition, in embodiment 3.

In another particularly preferred embodiment of the presently claimed invention, [A]^{m+} is selected from the group consisting of compounds of the formulae (V.e), (V.u), (V.y) and (V.z),

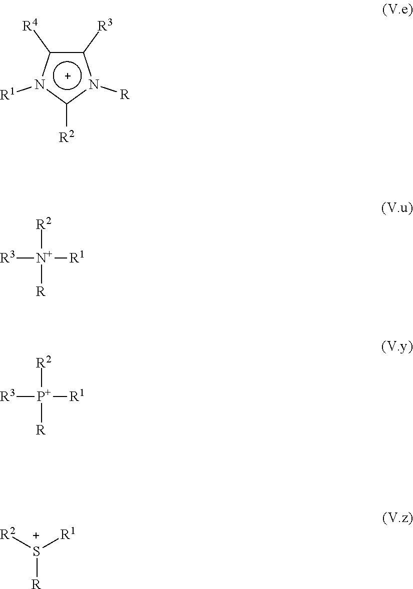

in which R is hydrogen, alkyl, alkenyl, cycloalkyl, cycloalkenyl, polycyclyl, heterocycloalkyl, aryl, or heteroaryl;

radicals R², R³ and R⁴ which are bound to a ring carbon are each, independently of one another, hydrogen, a sulfo group, COOH, carboxylate, sulfonate, acyl, alkoxycarbonyl, CO(NE¹E²), cyano, halogen, hydroxyl, SH, nitro, NE³E⁴, alkyl, alkoxy, alkylthio, alkylsulfinyl, alkylsulfonyl, alkenyl, cycloalkyl, cycloalkyloxy, cycloalkenyl, cycloalkenyloxy, polycyclyl, polycyclyloxy, heterocycloalkyl, aryl, aryloxy, or heteroaryl, wherein E¹, E², E³ and E⁴ are each, independently of one another, hydrogen, alkyl, cycloalkyl, heterocycloalkyl, aryl, or hetaryl; and

the at least one ionic liquid contains 2 to 16 carbon atoms, and the at least one white pigment is present in an amount in the range from ≥3.0 wt. % to ≤9.0 wt. %, based on the total weight of the aqueous coating composition, in embodiment 3.

In another particularly preferred embodiment of the presently claimed invention, [Y]ⁿ⁻ is selected from anions of:
the group of sulfates, sulfites and sulfonates of the general formulae:

SO₄²⁻,HSO₄⁻,SO₃²⁻,HSO₃⁻,R^{c}OSO₃⁻,R^{c}SO₃⁻;
the group of phosphates of the general formulae:

PO₄³⁻,HPO₄²⁻,H₂PO₄⁻,R^{c}PO₄²⁻,HR^{c}PO₄⁻,R^{c}R^{d}PO₄⁻;
the group of carboxylates of the general formula:

R^{c}COO⁻;

wherein the radicals R^{c} and R^{d} are selected independently from each other from hydrogen, alkyl, cycloalkyl, heterocycloalkyl, aryl and heteroaryl,

and the at least one ionic liquid contains 2 to 16 carbon atoms, and

the at least one white pigment is present in an amount in the range from ≥3.0 wt. % to ≤9.0 wt. %, based on the total weight of the aqueous coating composition, in embodiment 3.

In a preferred embodiment of the presently claimed invention, the at least one silicate binder is selected from the group consisting of colloidal silica, potassium silicate, sodium silicate, lithium silicate, and combinations thereof, in embodiment 3.

In a more preferred embodiment of the presently claimed invention, the at least one silicate binder is colloidal silica, in embodiment 3.

In a preferred embodiment of the presently claimed invention, the at least one silicate binder is present in an amount in the range from ≥10.0 wt. % to ≤50.0 wt. %, based on the total weight of the aqueous coating composition, in embodiment 3.

In another particularly preferred embodiment of the presently claimed invention, [A]^{m+} is selected from the group consisting of compounds of the formulae (V.e), (V.u), (V.y) and (V.z),

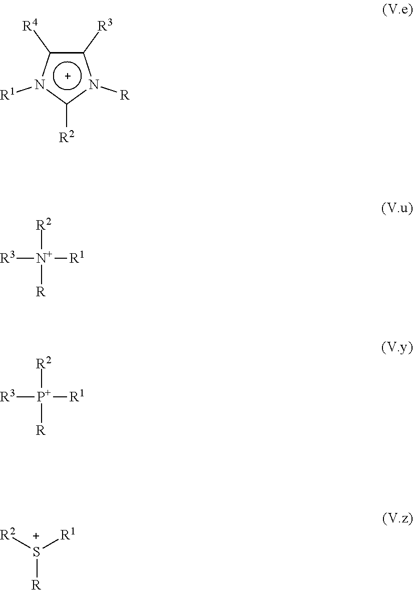

in which R is hydrogen, alkyl, alkenyl, cycloalkyl, cycloalkenyl, polycyclyl, heterocycloalkyl, aryl, or heteroaryl;

radicals R², R³ and R⁴ which are bound to a ring carbon are each, independently of one another, hydrogen, a sulfo group, COOH, carboxylate, sulfonate, acyl, alkoxycarbonyl, CO(NE¹E²), cyano, halogen, hydroxyl, SH, nitro, NE³E⁴, alkyl, alkoxy, alkylthio, alkylsulfinyl, alkylsulfonyl, alkenyl, cycloalkyl, cycloalkyloxy, cycloalkenyl, cycloalkenyloxy, polycyclyl, polycyclyloxy, heterocycloalkyl, aryl, aryloxy, or heteroaryl, wherein E¹, E², E³ and E⁴ are each, independently of one another, hydrogen, alkyl, cycloalkyl, heterocycloalkyl, aryl, or hetaryl; and

the at least one ionic liquid contains 2 to 16 carbon atoms, and the at least one silicate binder is present in an amount in the range from ≥10.0 wt. % to ≤50.0 wt. %, based on the total weight of the aqueous coating composition, in embodiment 3.

In another particularly preferred embodiment of the presently claimed invention, [Y]ⁿ⁻ is selected from anions of:
the group of sulfates, sulfites and sulfonates of the general formulae:

SO₄²⁻,HSO₄⁻,SO₃²⁻,HSO₃⁻,R^{c}OSO₃⁻,R^{c}SO₃⁻;
the group of phosphates of the general formulae:

PO₄³⁻,HPO₄²⁻,H₂PO₄⁻,R^{c}PO₄²⁻,HR^{c}PO₄⁻,R^{c}R^{d}PO₄⁻;
the group of carboxylates of the general formula:

R^{c}COO⁻;

wherein the radicals R^{c} and R^{d} are selected independently from each other from hydrogen, alkyl, cycloalkyl, heterocycloalkyl, aryl and heteroaryl,

and the at least one ionic liquid contains 2 to 16 carbon atoms, and

the at least one silicate binder is present in an amount in the range from ≥10.0 wt. % to ≤50.0 wt. %, based on the total weight of the aqueous coating composition, in embodiment 3.

In a more preferred embodiment of the presently claimed invention, the at least one silicate binder is present in an amount in the range from ≥15.0 wt. % to ≤30.0 wt. %, based on the total weight of the aqueous coating composition, in embodiment 3.

In another particularly preferred embodiment of the presently claimed invention, [A]^{m+} is selected from the group consisting of compounds of the formulae (V.e), (V.u), (V.y) and (V.z),

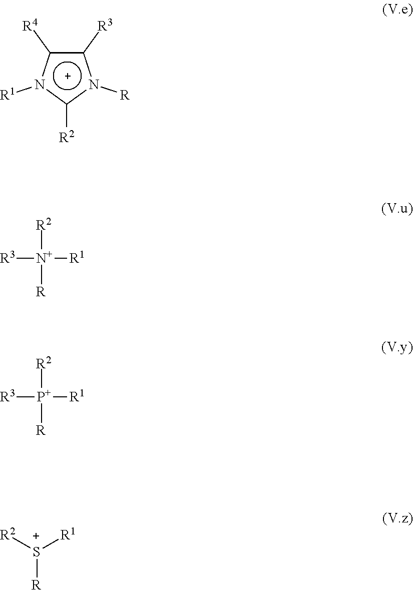

in which R is hydrogen, alkyl, alkenyl, cycloalkyl, cycloalkenyl, polycyclyl, heterocycloalkyl, aryl, or heteroaryl;

radicals R², R³ and R⁴ which are bound to a ring carbon are each, independently of one another, hydrogen, a sulfo group, COOH, carboxylate, sulfonate, acyl, alkoxycarbonyl, CO(NE¹E²), cyano, halogen, hydroxyl, SH, nitro, NE³E⁴, alkyl, alkoxy, alkylthio, alkylsulfinyl, alkylsulfonyl, alkenyl, cycloalkyl, cycloalkyloxy, cycloalkenyl, cycloalkenyloxy, polycyclyl, polycyclyloxy, heterocycloalkyl, aryl, aryloxy, or heteroaryl, wherein E¹, E², E³ and E⁴ are each, independently of one another, hydrogen, alkyl, cycloalkyl, heterocycloalkyl, aryl, or hetaryl; and

the at least one ionic liquid contains 2 to 16 carbon atoms, and the at least one silicate binder is present in an amount in the range from ≥15.0 wt. % to ≤30.0 wt. %, based on the total weight of the aqueous coating composition, in embodiment 3.

In another particularly preferred embodiment of the presently claimed invention, [Y]ⁿ⁻ is selected from anions of:
the group of sulfates, sulfites and sulfonates of the general formulae:

SO₄²⁻,HSO₄⁻,SO₃²⁻,HSO₃⁻,R^{c}OSO₃⁻,R^{c}SO₃⁻;
the group of phosphates of the general formulae:

PO₄³⁻,HPO₄²⁻,H₂PO₄⁻,R^{c}PO₄²⁻,HR^{c}PO₄⁻,R^{c}R^{d}PO₄⁻;
the group of carboxylates of the general formula:

R^{c}COO⁻;

wherein the radicals R^{c} and R^{d} are selected independently from each other from hydrogen, alkyl, cycloalkyl, heterocycloalkyl, aryl and heteroaryl,

and the at least one ionic liquid contains 2 to 16 carbon atoms, and

the at least one silicate binder is present in an amount in the range from ≥15.0 wt. % to ≤30.0 wt. %, based on the total weight of the aqueous coating composition, in embodiment 3.

In a preferred embodiment of the presently claimed invention, the aqueous coating composition further comprises at least one thickener selected from the group consisting of carboxymethyl cellulose, polyurethane, carboxymethyl cellulose, hydroxyethylcellulose, hydrophobized urethane, xanthan gum, micro fibrillated cellulose, and combinations thereof, in embodiment 3.

In a preferred embodiment of the presently claimed invention, the aqueous coating composition further comprises at least one thickener selected from carboxymethyl cellulose, in embodiment 3.

In a preferred embodiment of the presently claimed invention, wherein the at least one thickener is present in an amount in the range from ≥0.08 wt. % to ≤1.0 wt. %, based on the total weight of the aqueous coating composition, in embodiment 3.

In another particularly preferred embodiment of the presently claimed invention, [A]^{m+} is selected from the group consisting of compounds of the formulae (V.e), (V.u), (V.y) and (V.z),

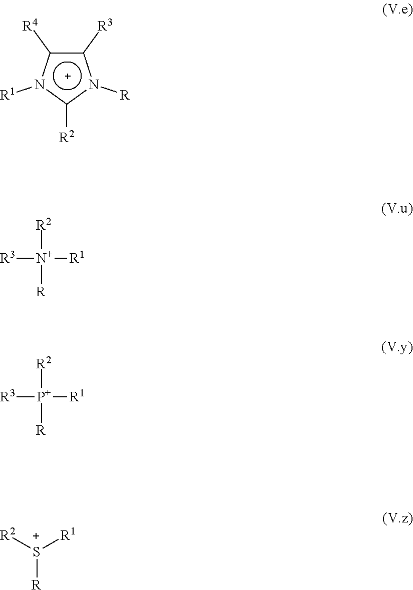

in which R is hydrogen, alkyl, alkenyl, cycloalkyl, cycloalkenyl, polycyclyl, heterocycloalkyl, aryl, or heteroaryl;

radicals R², R³ and R⁴ which are bound to a ring carbon are each, independently of one another, hydrogen, a sulfo group, COOH, carboxylate, sulfonate, acyl, alkoxycarbonyl, CO(NE¹E²), cyano, halogen, hydroxyl, SH, nitro, NE³E⁴, alkyl, alkoxy, alkylthio, alkylsulfinyl, alkylsulfonyl, alkenyl, cycloalkyl, cycloalkyloxy, cycloalkenyl, cycloalkenyloxy, polycyclyl, polycyclyloxy, heterocycloalkyl, aryl, aryloxy, or heteroaryl, wherein E¹, E², E³ and E⁴ are each, independently of one another, hydrogen, alkyl, cycloalkyl, heterocycloalkyl, aryl, or hetaryl; and

the at least one ionic liquid contains 2 to 16 carbon atoms, and wherein the at least one thickener is present in an amount in the range from ≥0.08 wt. % to ≤1.0 wt. %, based on the total weight of the aqueous coating composition, in embodiment 3.

In another particularly preferred embodiment of the presently claimed invention, [Y]ⁿ⁻ is selected from anions of:
the group of sulfates, sulfites and sulfonates of the general formulae:

SO₄²⁻,HSO₄⁻,SO₃²⁻,HSO₃⁻,R^{c}OSO₃⁻,R^{c}SO₃⁻;
the group of phosphates of the general formulae:

PO₄³⁻,HPO₄²⁻,H₂PO₄⁻,R^{c}PO₄²⁻,HR^{c}PO₄⁻,R^{c}R^{d}PO₄⁻;
the group of carboxylates of the general formula:

R^{c}COO⁻;

wherein the radicals R^{c} and R^{d} are selected independently from each other from hydrogen, alkyl, cycloalkyl, heterocycloalkyl, aryl and heteroaryl,

and the at least one ionic liquid contains 2 to 16 carbon atoms, and wherein the at least one thickener is present in an amount in the range from ≥0.08 wt. % to ≤1.0 wt. %, based on the total weight of the aqueous coating composition, in embodiment 3.

In a more preferred embodiment of the presently claimed invention, the at least one thickener is present in an amount in the range from ≥0.2 wt. % to ≤0.6 wt. %, based on the total weight of the aqueous coating composition, in embodiment 3.

In another particularly preferred embodiment of the presently claimed invention, [A]^{m+} is selected from the group consisting of compounds of the formulae (V.e), (V.u), (V.y) and (V.z),

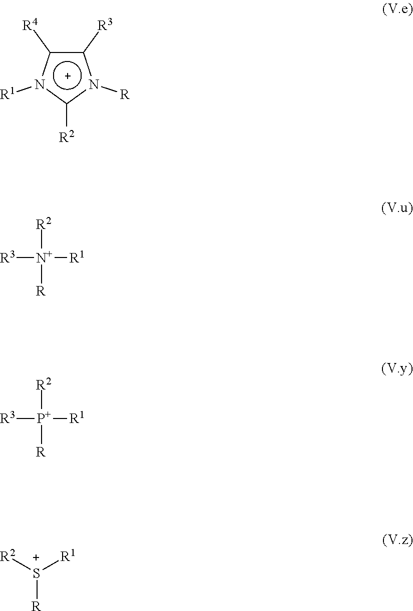

in which R is hydrogen, alkyl, alkenyl, cycloalkyl, cycloalkenyl, polycyclyl, heterocycloalkyl, aryl, or heteroaryl;

radicals R², R³ and R⁴ which are bound to a ring carbon are each, independently of one another, hydrogen, a sulfo group, COOH, carboxylate, sulfonate, acyl, alkoxycarbonyl, CO(NE¹E²), cyano, halogen, hydroxyl, SH, nitro, NE³E⁴, alkyl, alkoxy, alkylthio, alkylsulfinyl, alkylsulfonyl, alkenyl, cycloalkyl, cycloalkyloxy, cycloalkenyl, cycloalkenyloxy, polycyclyl, polycyclyloxy, heterocycloalkyl, aryl, aryloxy, or heteroaryl, wherein E¹, E², E³ and E⁴ are each, independently of one another, hydrogen, alkyl, cycloalkyl, heterocycloalkyl, aryl, or hetaryl; and

the at least one ionic liquid contains 2 to 16 carbon atoms, and the at least one thickener is present in an amount in the range from ≥0.2 wt. % to ≤0.6 wt. %, based on the total weight of the aqueous coating composition, in embodiment 3.

In another particularly preferred embodiment of the presently claimed invention, [Y]ⁿ⁻ is selected from anions of:
the group of sulfates, sulfites and sulfonates of the general formulae:

SO₄²⁻,HSO₄⁻,SO₃²⁻,HSO₃⁻,R^{c}OSO₃⁻,R^{c}SO₃⁻;
the group of phosphates of the general formulae:

PO₄³⁻,HPO₄²⁻,H₂PO₄⁻,R^{c}PO₄²⁻,HR^{c}PO₄⁻,R^{c}R^{d}PO₄⁻;
the group of carboxylates of the general formula:

R^{c}COO⁻;

wherein the radicals R^{c} and R^{d} are selected independently from each other from hydrogen, alkyl, cycloalkyl, heterocycloalkyl, aryl and heteroaryl,

and the at least one ionic liquid contains 2 to 16 carbon atoms, and

the at least one thickener is present in an amount in the range from ≥0.2 wt. % to ≤0.6 wt. %, based on the total weight of the aqueous coating composition, in embodiment 3.

In a preferred embodiment of the presently claimed invention, the weight ratio of the at least one ionic liquid to the at least one filler is in the range from 1:1600 to 1:1, in embodiment 3.

In another particularly preferred embodiment of the presently claimed invention, [A]^{m+} is selected from the group consisting of compounds of the formulae (V.e), (V.u), (V.y) and (V.z),

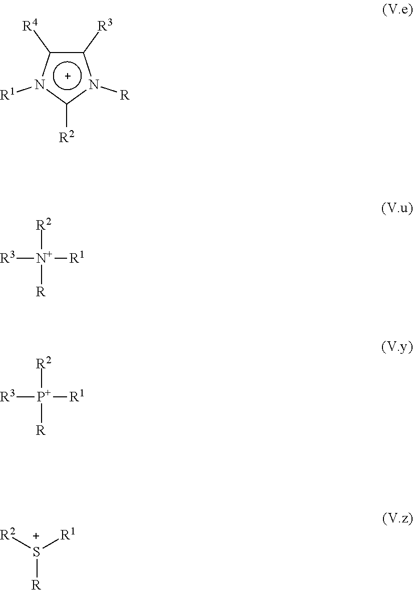

in which R is hydrogen, alkyl, alkenyl, cycloalkyl, cycloalkenyl, polycyclyl, heterocycloalkyl, aryl, or heteroaryl;

radicals R², R³ and R⁴ which are bound to a ring carbon are each, independently of one another, hydrogen, a sulfo group, COOH, carboxylate, sulfonate, acyl, alkoxycarbonyl, CO(NE¹E²), cyano, halogen, hydroxyl, SH, nitro, NE³E⁴, alkyl, alkoxy, alkylthio, alkylsulfinyl, alkylsulfonyl, alkenyl, cycloalkyl, cycloalkyloxy, cycloalkenyl, cycloalkenyloxy, polycyclyl, polycyclyloxy, heterocycloalkyl, aryl, aryloxy, or heteroaryl, wherein E¹, E², E³ and E⁴ are each, independently of one another, hydrogen, alkyl, cycloalkyl, heterocycloalkyl, aryl, or hetaryl; and

the at least one ionic liquid contains 2 to 16 carbon atoms, and the weight ratio of the at least one ionic liquid to the at least one filler is in the range from 1:1600 to 1:1, in embodiment 3.

In another particularly preferred embodiment of the presently claimed invention, [Y]ⁿ⁻ is selected from anions of:
the group of sulfates, sulfites and sulfonates of the general formulae:

SO₄²⁻,HSO₄⁻,SO₃²⁻,HSO₃⁻,R^{c}OSO₃⁻,R^{c}SO₃⁻;
the group of phosphates of the general formulae:

PO₄³⁻,HPO₄²⁻,H₂PO₄⁻,R^{c}PO₄²⁻,HR^{c}PO₄⁻,R^{c}R^{d}PO₄⁻;
the group of carboxylates of the general formula:

R^{c}COO⁻;

wherein the radicals R^{c} and R^{d} are selected independently from each other from hydrogen, alkyl, cycloalkyl, heterocycloalkyl, aryl and heteroaryl,

and the at least one ionic liquid contains 2 to 16 carbon atoms, and

the weight ratio of the at least one ionic liquid to the at least one filler is in the range from 1:1600 to 1:1, in embodiment 3.

In a more preferred embodiment of the presently claimed invention, the weight ratio of the at least one ionic liquid to the at least one filler is in the range from 1:300 to 1:15, in embodiment 3.

In another particularly preferred embodiment of the presently claimed invention, [A]^{m+} is selected from the group consisting of compounds of the formulae (V.e), (V.u), (V.y) and (V.z),

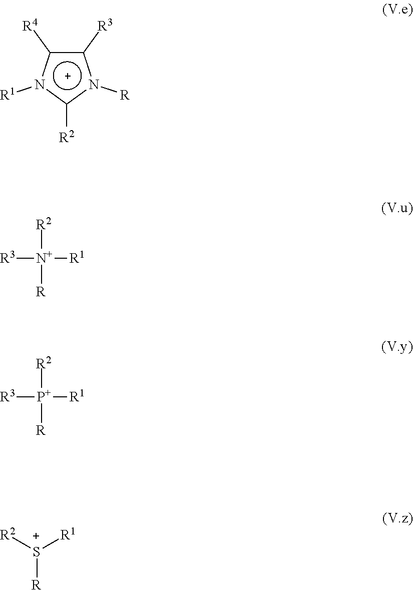

in which R is hydrogen, alkyl, alkenyl, cycloalkyl, cycloalkenyl, polycyclyl, heterocycloalkyl, aryl, or heteroaryl;

radicals R², R³ and R⁴ which are bound to a ring carbon are each, independently of one another, hydrogen, a sulfo group, COOH, carboxylate, sulfonate, acyl, alkoxycarbonyl, CO(NE¹E²), cyano, halogen, hydroxyl, SH, nitro, NE³E⁴, alkyl, alkoxy, alkylthio, alkylsulfinyl, alkylsulfonyl, alkenyl, cycloalkyl, cycloalkyloxy, cycloalkenyl, cycloalkenyloxy, polycyclyl, polycyclyloxy, heterocycloalkyl, aryl, aryloxy, or heteroaryl, wherein E¹, E², E³ and E⁴ are each, independently of one another, hydrogen, alkyl, cycloalkyl, heterocycloalkyl, aryl, or hetaryl; and

the at least one ionic liquid contains 2 to 16 carbon atoms, and the weight ratio of the at least one ionic liquid to the at least one filler is in the range from 1:300 to 1:15, in embodiment 3.

In another particularly preferred embodiment of the presently claimed invention, [Y]ⁿ⁻ is selected from anions of:
the group of sulfates, sulfites and sulfonates of the general formulae:

SO₄²⁻,HSO₄⁻,SO₃²⁻,HSO₃⁻,R^{c}OSO₃⁻,R^{c}SO₃⁻;
the group of phosphates of the general formulae:

PO₄³⁻,HPO₄²⁻,H₂PO₄⁻,R^{c}PO₄²⁻,HR^{c}PO₄⁻,R^{c}R^{d}PO₄⁻;
the group of carboxylates of the general formula:

R^{c}COO⁻;

wherein the radicals R^{c} and R^{d} are selected independently from each other from hydrogen, alkyl, cycloalkyl, heterocycloalkyl, aryl and heteroaryl,

and the at least one ionic liquid contains 2 to 16 carbon atoms, and

the weight ratio of the at least one ionic liquid to the at least one filler is in the range from 1:300 to 1:15, in embodiment 3.

In a preferred embodiment of the presently claimed invention, the weight ratio of the at least one ionic liquid to the at least one dispersant is in the range from 1:40 to 100:1, in embodiment 3.

In another particularly preferred embodiment of the presently claimed invention, [A]^{m+} is selected from the group consisting of compounds of the formulae (V.e), (V.u), (V.y) and (V.z),

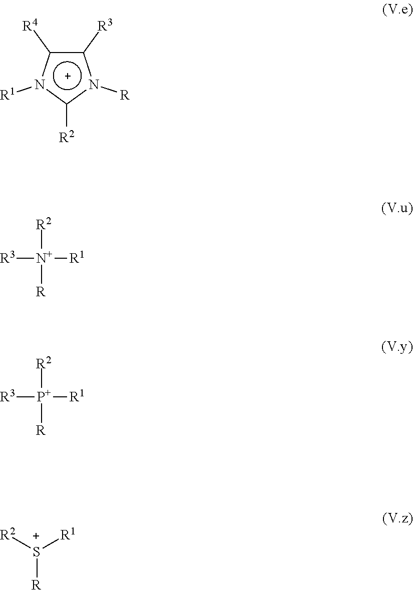

in which R is hydrogen, alkyl, alkenyl, cycloalkyl, cycloalkenyl, polycyclyl, heterocycloalkyl, aryl, or heteroaryl;

radicals R², R³ and R⁴ which are bound to a ring carbon are each, independently of one another, hydrogen, a sulfo group, COOH, carboxylate, sulfonate, acyl, alkoxycarbonyl, CO(NE¹E²), cyano, halogen, hydroxyl, SH, nitro, NE³E⁴, alkyl, alkoxy, alkylthio, alkylsulfinyl, alkylsulfonyl, alkenyl, cycloalkyl, cycloalkyloxy, cycloalkenyl, cycloalkenyloxy, polycyclyl, polycyclyloxy, heterocycloalkyl, aryl, aryloxy, or heteroaryl, wherein E¹, E², E³ and E⁴ are each, independently of one another, hydrogen, alkyl, cycloalkyl, heterocycloalkyl, aryl, or hetaryl; and

the at least one ionic liquid contains 2 to 16 carbon atoms, and the weight ratio of the at least one ionic liquid to the at least one dispersant is in the range from 1:40 to 100:1, in embodiment 3.

In another particularly preferred embodiment of the presently claimed invention, [Y]ⁿ⁻ is selected from anions of:
the group of sulfates, sulfites and sulfonates of the general formulae:

SO₄²⁻,HSO₄⁻,SO₃²⁻,HSO₃⁻,R^{c}OSO₃⁻,R^{c}SO₃⁻;
the group of phosphates of the general formulae:

PO₄³⁻,HPO₄²⁻,H₂PO₄⁻,R^{c}PO₄²⁻,HR^{c}PO₄⁻,R^{c}R^{d}PO₄⁻;
the group of carboxylates of the general formula:

R^{c}COO⁻;

wherein the radicals R^{c} and R^{d} are selected independently from each other from hydrogen, alkyl, cycloalkyl, heterocycloalkyl, aryl and heteroaryl,

and the at least one ionic liquid contains 2 to 16 carbon atoms, and

the weight ratio of the at least one ionic liquid to the at least one dispersant is in the range from 1:40 to 100:1, in embodiment 3.

In a more preferred embodiment of the presently claimed invention, the weight ratio of the at least one ionic liquid to the at least one dispersant is in the range from 1:5 to 20:1, in embodiment 3

In another particularly preferred embodiment of the presently claimed invention, [A]^{m+} is selected from the group consisting of compounds of the formulae (V.e), (V.u), (V.y) and (V.z),

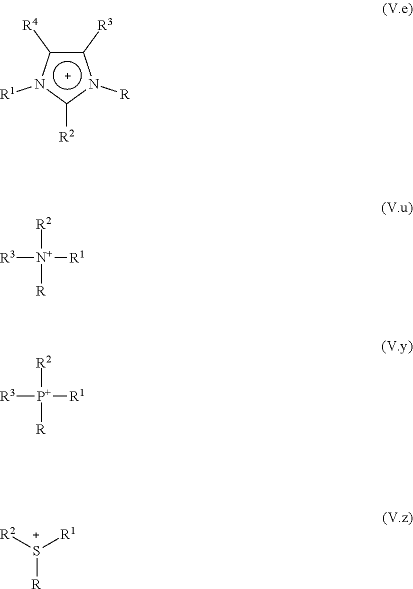

in which R is hydrogen, alkyl, alkenyl, cycloalkyl, cycloalkenyl, polycyclyl, heterocycloalkyl, aryl, or heteroaryl;

radicals R², R³ and R⁴ which are bound to a ring carbon are each, independently of one another, hydrogen, a sulfo group, COOH, carboxylate, sulfonate, acyl, alkoxycarbonyl, CO(NE¹E²), cyano, halogen, hydroxyl, SH, nitro, NE³E⁴, alkyl, alkoxy, alkylthio, alkylsulfinyl, alkylsulfonyl, alkenyl, cycloalkyl, cycloalkyloxy, cycloalkenyl, cycloalkenyloxy, polycyclyl, polycyclyloxy, heterocycloalkyl, aryl, aryloxy, or heteroaryl, wherein E¹, E², E³ and E⁴ are each, independently of one another, hydrogen, alkyl, cycloalkyl, heterocycloalkyl, aryl, or hetaryl; and

the at least one ionic liquid contains 2 to 16 carbon atoms, and the weight ratio of the at least one ionic liquid to the at least one dispersant is in the range from 1:5 to 20:1, in embodiment 3.

In another particularly preferred embodiment of the presently claimed invention, [Y]ⁿ⁻ is selected from anions of:
the group of sulfates, sulfites and sulfonates of the general formulae:

SO₄²⁻,HSO₄⁻,SO₃²⁻,HSO₃⁻,R^{c}OSO₃⁻,R^{c}SO₃⁻;
the group of phosphates of the general formulae:

PO₄³⁻,HPO₄²⁻,H₂PO₄⁻,R^{c}PO₄²⁻,HR^{c}PO₄⁻,R^{c}R^{d}PO₄⁻;
the group of carboxylates of the general formula:

R^{c}COO⁻;

wherein the radicals R^{c} and R^{d} are selected independently from each other from hydrogen, alkyl, cycloalkyl, heterocycloalkyl, aryl and heteroaryl,

and the at least one ionic liquid contains 2 to 16 carbon atoms, and

the weight ratio of the at least one ionic liquid to the at least one dispersant is in the range from 1:5 to 20:1, in embodiment 3.

In a preferred embodiment of the presently claimed invention, the weight ratio of the at least one ionic liquid to the at least one silicate binder is in the range from 1:1000 to 1:2, in embodiment 3.

In another particularly preferred embodiment of the presently claimed invention, [A]^{m+} is selected from the group consisting of compounds of the formulae (V.e), (V.u), (V.y) and (V.z),

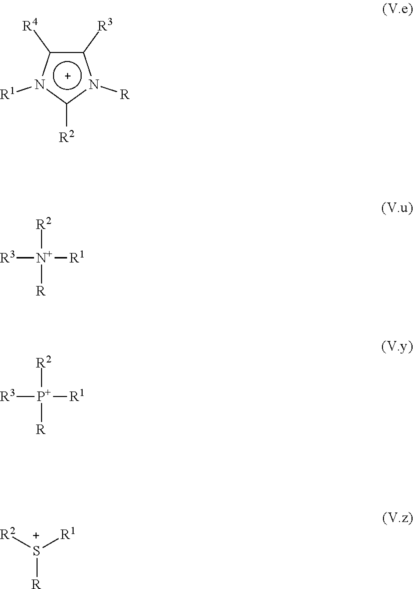

in which R is hydrogen, alkyl, alkenyl, cycloalkyl, cycloalkenyl, polycyclyl, heterocycloalkyl, aryl, or heteroaryl;

radicals R², R³ and R⁴ which are bound to a ring carbon are each, independently of one another, hydrogen, a sulfo group, COOH, carboxylate, sulfonate, acyl, alkoxycarbonyl, CO(NE¹E²), cyano, halogen, hydroxyl, SH, nitro, NE³E⁴, alkyl, alkoxy, alkylthio, alkylsulfinyl, alkylsulfonyl, alkenyl, cycloalkyl, cycloalkyloxy, cycloalkenyl, cycloalkenyloxy, polycyclyl, polycyclyloxy, heterocycloalkyl, aryl, aryloxy, or heteroaryl, wherein E¹, E², E³ and E⁴ are each, independently of one another, hydrogen, alkyl, cycloalkyl, heterocycloalkyl, aryl, or hetaryl; and

the at least one ionic liquid contains 2 to 16 carbon atoms, and the weight ratio of the at least one ionic liquid to the at least one silicate binder is in the range from 1:1000 to 1:2, in embodiment 3.

In another particularly preferred embodiment of the presently claimed invention, [Y]ⁿ⁻ is selected from anions of:
the group of sulfates, sulfites and sulfonates of the general formulae:

SO₄²⁻,HSO₄⁻,SO₃²⁻,HSO₃⁻,R^{c}OSO₃⁻,R^{c}SO₃⁻;
the group of phosphates of the general formulae:

PO₄³⁻,HPO₄²⁻,H₂PO₄⁻,R^{c}PO₄²⁻,HR^{c}PO₄⁻,R^{c}R^{d}PO₄⁻;
the group of carboxylates of the general formula:

R^{c}COO⁻;

wherein the radicals R^{c} and R^{d} are selected independently from each other from hydrogen, alkyl, cycloalkyl, heterocycloalkyl, aryl and heteroaryl,

and the at least one ionic liquid contains 2 to 16 carbon atoms, and

the weight ratio of the at least one ionic liquid to the at least one silicate binder is in the range from 1:1000 to 1:2, in embodiment 3.

In a more preferred embodiment of the presently claimed invention, the weight ratio of the at least one ionic liquid to the at least one silicate binder is in the range from 1:150 to 1:7.5, in embodiment 3.

In another particularly preferred embodiment of the presently claimed invention, [A]^{m+} is selected from the group consisting of compounds of the formulae (V.e), (V.u), (V.y) and (V.z),

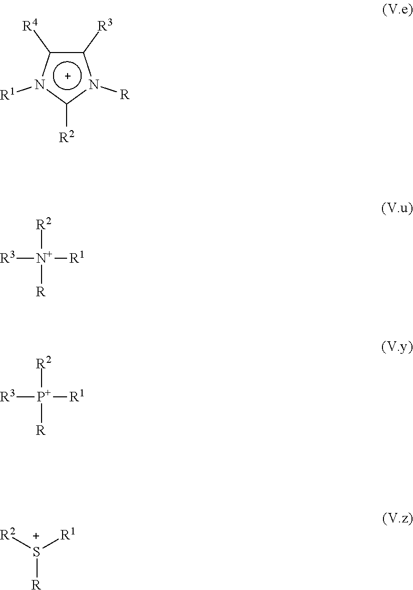

in which R is hydrogen, alkyl, alkenyl, cycloalkyl, cycloalkenyl, polycyclyl, heterocycloalkyl, aryl, or heteroaryl;

radicals R², R³ and R⁴ which are bound to a ring carbon are each, independently of one another, hydrogen, a sulfo group, COOH, carboxylate, sulfonate, acyl, alkoxycarbonyl, CO(NE¹E²), cyano, halogen, hydroxyl, SH, nitro, NE³E⁴, alkyl, alkoxy, alkylthio, alkylsulfinyl, alkylsulfonyl, alkenyl, cycloalkyl, cycloalkyloxy, cycloalkenyl, cycloalkenyloxy, polycyclyl, polycyclyloxy, heterocycloalkyl, aryl, aryloxy, or heteroaryl, wherein E¹, E², E³ and E⁴ are each, independently of one another, hydrogen, alkyl, cycloalkyl, heterocycloalkyl, aryl, or hetaryl; and

the at least one ionic liquid contains 2 to 16 carbon atoms, and the weight ratio of the at least one ionic liquid to the at least one silicate binder is in the range from 1:150 to 1:7.5, in embodiment 3.

In another particularly preferred embodiment of the presently claimed invention, [Y]ⁿ⁻ is selected from anions of:
the group of sulfates, sulfites and sulfonates of the general formulae:

SO₄²⁻,HSO₄⁻,SO₃²⁻,HSO₃⁻,R^{c}OSO₃⁻,R^{c}SO₃⁻;
the group of phosphates of the general formulae:

PO₄³⁻,HPO₄²⁻,H₂PO₄⁻,R^{c}PO₄²⁻,HR^{c}PO₄⁻,R^{c}R^{d}PO₄⁻;
the group of carboxylates of the general formula:

R^{c}COO⁻;

wherein the radicals R^{c} and R^{d} are selected independently from each other from hydrogen, alkyl, cycloalkyl, heterocycloalkyl, aryl and heteroaryl,

and the at least one ionic liquid contains 2 to 16 carbon atoms, and

the weight ratio of the at least one ionic liquid to the at least one silicate binder is in the range from 1:150 to 1:7.5, in embodiment 3.

In a preferred embodiment of the presently claimed invention, the aqueous coating composition further comprises at least one anti-foaming agent selected from the group consisting of mineral oil, silicone oil, soybean oil, linseed oil, palm oil, coconut oil, rapeseed oil, canola oil, rice bran oil, olive oil, and combinations thereof and the at least one anti foaming agent is present in an amount in the range from ≥0.08 wt. % to ≤1.0 wt. %, based on the total weight of the aqueous coating composition, in embodiment 3.

In a more preferred embodiment of the presently claimed invention, the at least one anti foaming agent is present in an amount in the range from ≥0.2 wt. % to ≤0.6 wt. %, based on the total weight of the aqueous coating composition, in embodiment 3.

In a most preferred embodiment of the presently claimed invention, the aqueous coating composition further comprises at least one anti-foaming agent selected from mineral oil, in embodiment 3.

In a preferred embodiment of the presently claimed invention, the aqueous coating composition further comprises at least one organic binder selected from the group consisting of styrene acrylate, 2-ethylhexyl acrylate, n-butyl acrylate, ethyl acrylate, methyl acrylate, vinyl acrylate, vinyl propionate, and combinations thereof and the at least one organic binder is present in an amount in the range from ≥2.0 wt. % to ≤20.0 wt. %, based on the total weight of the aqueous coating composition, in embodiment 3.

In a more preferred embodiment of the presently claimed invention, the at least one organic binder is present in an amount in the range from ≥2.0 wt. % to ≤10.0 wt. %, based on the total weight of the aqueous coating composition, in embodiment 3.

In a preferred embodiment of the presently claimed invention, the aqueous composition has a viscosity in the range of 20 to 120 SKT, after three weeks of measurement, in embodiment 3.

In a more preferred embodiment of the presently claimed invention, the aqueous composition has a viscosity in the range of 30 to 100 SKT, after three weeks of measurement, in embodiment 3.

In a most preferred embodiment of the presently claimed invention, the aqueous composition has a viscosity in the range of 30 to 80 SKT, after three weeks of measurement, in embodiment 3.

In a most preferred embodiment of the presently claimed invention, the aqueous coating composition further comprises at least one organic binder selected from styrene acrylate, in embodiment 3.

In a preferred embodiment of the presently claimed invention, the aqueous coating composition further comprises an additive selected from the group consisting of viscosity regulator, hydrophobing agent, and combinations thereof, in embodiment 3.

In a preferred embodiment of the presently claimed invention, the aqueous coating composition further comprises an additive selected from the group consisting of film forming solvent selected from any solvent suitable for lowering Tg of binder is suitable, in embodiment 3.

In a preferred embodiment of the presently claimed invention, the viscosity regulator is selected from the group consisting of siliconate and complexing agents. The preferred siliconate is potassium siliconate. The preferred complexing agents is methylglycinate. The complexing agent helps prevent unwanted side reaction capturing metal cations such as Mg²⁺, in embodiment 3.

In a preferred embodiment of the presently claimed invention, the hydrophobing agent is selected from the group consisting of silicone oil, potassium methyl siliconate, polymethylhydrogensiloxane, octyltriethoxysilanes, iso-octyltriethoxysilane, and combinations thereof, in embodiment 3. The hydrophobing agent is a beneficial additive in exterior application.

In a preferred embodiment of the presently claimed invention, the aqueous composition may be dispensed in the form of interior paint, exterior paint, in embodiment 3.

The presently claimed invention offers one or more of the following advantages:

1) The use of ionic liquid of the presently claimed invention prevents unwanted increase in viscosity of the coating compositions, by stabilizing the viscosity of coating compositions, such that the compositions have a viscosity in the range of 30 to 80 SKT after 3 weeks of measurement.

2) The ionic liquid of the presently claimed invention is capable of being useful for a wide-variety of coating compositions, such as interior paints, exterior paints, among others.

3) The ionic liquid of the presently claimed invention is compatible with the common ingredients used as part of coating compositions. For instance, the ionic liquids are noted to be compatible with a variety of fillers, thus increasing their applicability.

4) The use of ionic liquid of the presently claimed invention ensures adherence to safety norms, since ionic liquids don't have hazardous classification and are non-toxic.

5) Further, the ionic liquid of the presently claimed invention are capable of being processed in pure or undiluted form, thereby increasing their industrial applicability.

In the following, there is provided a list of embodiments to further illustrate the present disclosure without intending to limit the disclosure to the specific embodiments listed below.
1. Use of at least one ionic liquid for stabilizing the viscosity of an aqueous coating composition comprising at least one silicate binder, wherein the at least one ionic liquid is selected from the group consisting of:
   (IL1) salts of the general formula (I)

[A]ₚ^{m+}[Y]_{q}ⁿ⁻ (I),
wherein
m, n, p, and q are each 1, 2, 3, or 4 and the product of p and m is equal to the product of q and n;
[A]^{m+} is
i) a monovalent, divalent, trivalent, or tetravalent cation selected from ammonium groups, oxonium groups, sulfonium groups, and phosphonium groups; or
ii) a cationic compound comprising two or more cationic groups which are selected independently from ammonium groups, oxonium groups, sulfonium groups, and phosphonium groups; and
[Y]ⁿ⁻ is a monovalent, divalent, trivalent, or tetravalent anion or a mixture of these anions;
(IL2) mixed salts of the general formulae (II.a), (II.b) or (II.c)

[A¹]⁺[A²]⁺[Y]ⁿ⁻ (II.a),
wherein n=2,

[A¹]⁺[A²]⁺[A³]⁺[Y]ⁿ⁻ (II.b),
wherein n=3,

[A¹]⁺[A²]⁺[A³]⁺[A⁴]⁺[Y]ⁿ⁻ (II.c),
wherein n=4, and
wherein [A¹]⁺, [A²]⁺, [A³]⁺, and [A⁴]⁺ are monovalent cations selected from [A]^{m+}; and
[Y]⁺ is a monovalent, divalent, trivalent, or tetravalent anion or a mixture of these anions;
(IL3) mixed salts of the general formulae (III.a) to (III.h)

[A¹]²⁺[A²]⁺[Y]ⁿ⁻ (III.a),
wherein n=3,

[A¹]²⁺[A²]⁺[A³]⁺[Y]ⁿ⁻ (III.b),
wherein n=4,

[A¹]²⁺[A⁴]²⁺[Y]ⁿ⁻ (III.c),
wherein n=4,

[A⁵]³⁺[A²]⁺[Y]ⁿ⁻ (III.d),
wherein n=4,

[A¹]²⁺[A²]⁺[A³]⁺[A⁶]⁺[Y]ⁿ⁻ (III.e),
wherein n=5,

[A¹]²⁺[A⁴]²⁺[A⁶]⁺[Y]ⁿ⁻ (III.f),
wherein n=5,

[A⁵]³⁺[A²]⁺[A³]⁺[Y]ⁿ⁻ (III.g),
wherein n=5,

[A⁷]⁴⁺[A²]⁺[Y]ⁿ⁻ (III.h),
wherein n=5, and
wherein [A¹]²⁺, [A²]⁺, [A³]⁺, [A⁴]²⁺, [A⁵]³⁺, [A⁶]⁺, and [A⁷]⁴⁺ are monovalent, divalent, trivalent or tetravalent cations selected from [A]^{m+}; and [Y]ⁿ⁻ is a monovalent, divalent, trivalent, or tetravalent anion; and
(IL4) mixed salts of the general formulae (IV.a) to (IV.j)

[A¹]⁺[A²]⁺[A³]⁺[M¹]⁺[Y]ⁿ⁻ (IV.a),
wherein n=4,

[A¹]⁺[A²]⁺[M¹]⁺[M²]⁺[Y]ⁿ⁻ (IV.b),
wherein n=4,

[A¹]⁺[M¹]⁺[M²]⁺[M³]⁺[Y]ⁿ⁻ (IV.c),
wherein n=4,

[A¹]⁺[A²]⁺[M¹]⁺[Y]ⁿ⁻ (IV.d),
wherein n=3,

[A¹]⁺[M¹]⁺[M²]⁺[Y]ⁿ⁻ (IV.e),
wherein n=3,

[A¹]⁺[M¹]⁺[Y]ⁿ⁻ (IV.f),
wherein n=2,

[A¹]⁺[A²]⁺[M⁴]²⁺[Y]ⁿ⁻ (IV.g),
wherein n=4,

[A¹]⁺[M¹]⁺[M⁴]²⁺[Y]ⁿ⁻ (IV.h),
wherein n=4,

[A¹]⁺[M⁵]³⁺[Y]ⁿ⁻ (IV.i),
wherein n=4,

[A¹]⁺[M⁴]²⁺[Y]ⁿ⁻ (IV.j),
wherein n=3, and
wherein [A¹]⁺, [A²]⁺, and [A³]⁺ are monovalent, divalent, trivalent, or tetravalent cations selected from [A]^{m+}; [Y]ⁿ⁻ is a monovalent, divalent, trivalent, or tetravalent anion; and
[M¹]⁺, [M²]⁺, and [M³]⁺ are monovalent metal cations, [M⁴]²⁺ are divalent metal cations and [M⁵]³⁺ are trivalent metal cations.
2. A method for stabilizing the viscosity of an aqueous coating composition comprising at least one silicate binder and at least one white pigment, wherein the method comprises at least the step of adding to the aqueous coating composition, at least one ionic liquid selected from the group consisting of:
   (IL1) salts of the general formula (I)

[A]ₚ^{m+}[Y]_{q}ⁿ⁻ (I),
wherein
m, n, p, and q are each 1, 2, 3, or 4 and the product of p and m is equal to the product of q and n;
[A]^{m+} is
i) a monovalent, divalent, trivalent, or tetravalent cation selected from ammonium groups, oxonium groups, sulfonium groups, and phosphonium groups; or
ii) a cationic compound comprising two or more cationic groups which are selected independently from ammonium groups, oxonium groups, sulfonium groups, and phosphonium groups; and
[Y]ⁿ⁻ is a monovalent, divalent, trivalent, or tetravalent anion or a mixture of these anions;
(IL2) mixed salts of the general formulae (II.a), (II.b) or (II.c)

[A¹]⁺[A²]⁺[Y]ⁿ⁻ (II.a),
wherein n=2,

[A¹]⁺[A²]⁺[A³]⁺[Y]ⁿ⁻ (II.b),
wherein n=3,

[A¹]⁺[A²]⁺[A³]⁺[A⁴]⁺[Y]ⁿ⁻ (II.c),
wherein n=4, and
wherein [A¹]⁺, [A²]⁺, [A³]⁺ and [A⁴]⁺ are monovalent cations selected from [A]^{m+}; and [Y]ⁿ⁻ is a monovalent, divalent, trivalent, or tetravalent anion or a mixture of these anions;
(IL3) mixed salts of the general formulae (III.a) to (III.h)

[A¹]²⁺[A²]⁺[Y]ⁿ⁻ (III.a),
wherein n=3,

[A¹]²⁺[A²]⁺[A³]⁺[Y]ⁿ⁻ (III.b),
wherein n=4,

[A¹]²⁺[A⁴]²⁺[Y]ⁿ⁻ (III.c),
wherein n=4,

[A⁵]³⁺[A²]⁺[Y]ⁿ⁻ (III.d),
wherein n=4,

[A¹]²⁺[A²]⁺[A³]⁺[A⁶]⁺[Y]ⁿ⁻ (III.e),
wherein n=5,

[A¹]²⁺[A⁴]²⁺[A⁶]⁺[Y]ⁿ⁻ (III.f),
wherein n=5,

[A⁵]³⁺[A²]⁺[A³]⁺[Y]ⁿ⁻ (III.g),
wherein n=5,

[A⁷]⁴⁺[A²]⁺[Y]ⁿ⁻ (III.h),
wherein n=5, and
wherein [A¹]²⁺, [A²]⁺, [A³]⁺, [A⁴]²⁺, [A⁵]³⁺, [A⁶]⁺, and [A⁷]⁴⁺ are monovalent, divalent, trivalent, or tetravalent cations selected from [A]^{m+}; and [Y]ⁿ⁻ is a monovalent, divalent, trivalent, or tetravalent anion or a mixture of these anions; and
(IL4) mixed salts of the general formulae (IV.a) to (IV.j)

[A¹]⁺[A²]⁺[A³]⁺[M¹]⁺[Y]ⁿ⁻ (IV.a),
wherein n=4,

[A¹]⁺[A²]⁺[M¹]⁺[M²]⁺[Y]ⁿ⁻ (IV.b),
wherein n=4,

[A¹]⁺[M¹]⁺[M²]⁺[M³]⁺[Y]ⁿ⁻ (IV.c),
wherein n=4,

[A¹]⁺[A²]⁺[M¹]⁺[Y]ⁿ⁻ (IV.d),
wherein n=3,

[A¹]⁺[M¹]⁺[M²]⁺[Y]ⁿ⁻ (IV.e),
wherein n=3,

[A¹]⁺[M¹]⁺[Y]ⁿ⁻ (IV.f),
wherein n=2,

[A¹]⁺[A²]⁺[M⁴]²⁺[Y]ⁿ⁻ (IV.g),
wherein n=4,

[A¹]⁺[M¹]⁺[M⁴]²⁺[Y]ⁿ⁻ (IV.h),
wherein n=4,

[A¹]⁺[M⁵]³⁺[Y]ⁿ⁻ (IV.i),
wherein n=4,

[A¹]⁺[M⁴]²⁺[Y]ⁿ⁻ (IV.j),
wherein n=3, and
wherein [A¹]⁺, [A²]⁺, and [A³]⁺ are monovalent, divalent, trivalent, or tetravalent cations selected from [A]^{m+}; [Y]ⁿ⁻ is a monovalent, divalent, trivalent, or tetravalent anion or a mixture of these anions; and [M¹]⁺, [M²]⁺, and [M³]⁺ are monovalent metal cations, [M⁴]²⁺ are divalent metal cations and [M⁵]³⁺ are trivalent metal cations.
3. The use or method according to embodiments 1 or 2, wherein m, n, p, and q are each 1, 2, 3, or 4 and the product of p and m is equal to the product of q and n; and [A]^{m+} is a monovalent, divalent, trivalent or tetravalent cation selected from ammonium groups, oxonium groups, sulfonium groups, and phosphonium groups.
4. The use or method according to embodiment 3, wherein m, n, p, and q are each 1, 2, 3, or 4 and the product of p and m is equal to the product of q and n; [A]^{m+} is a monovalent cation selected from ammonium groups, oxonium groups, sulfonium groups, and phosphonium groups.
5. The use or method according to any of the embodiments 1 to 4, wherein [A]^{m+} is selected from the group consisting of compounds of the formulae (V.a) to (V.z),

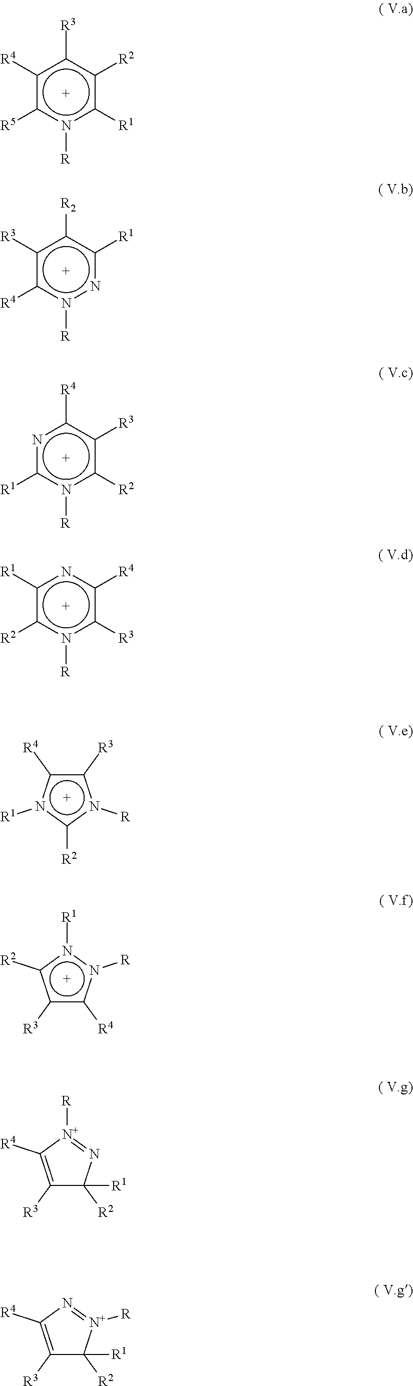

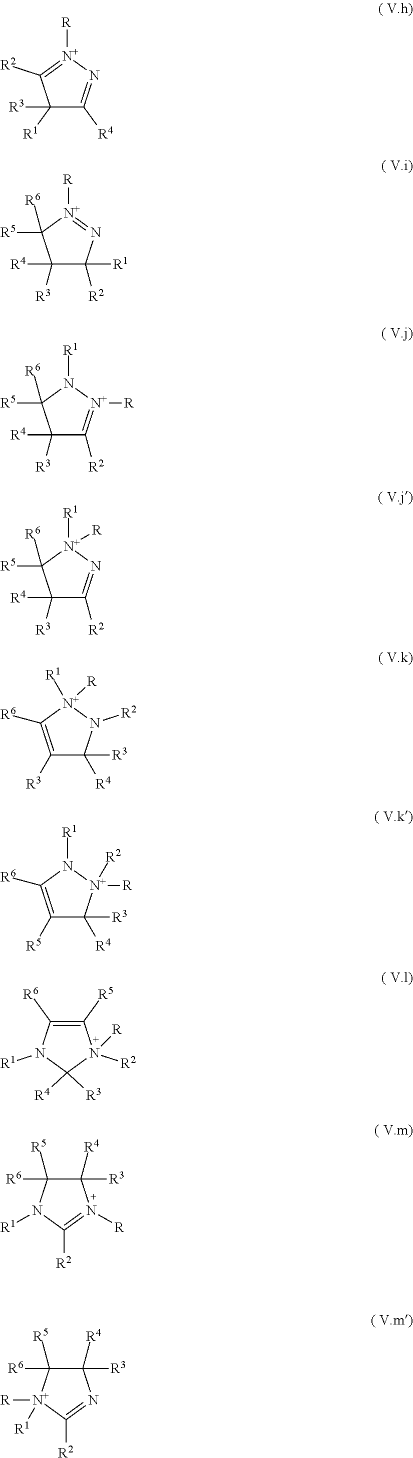

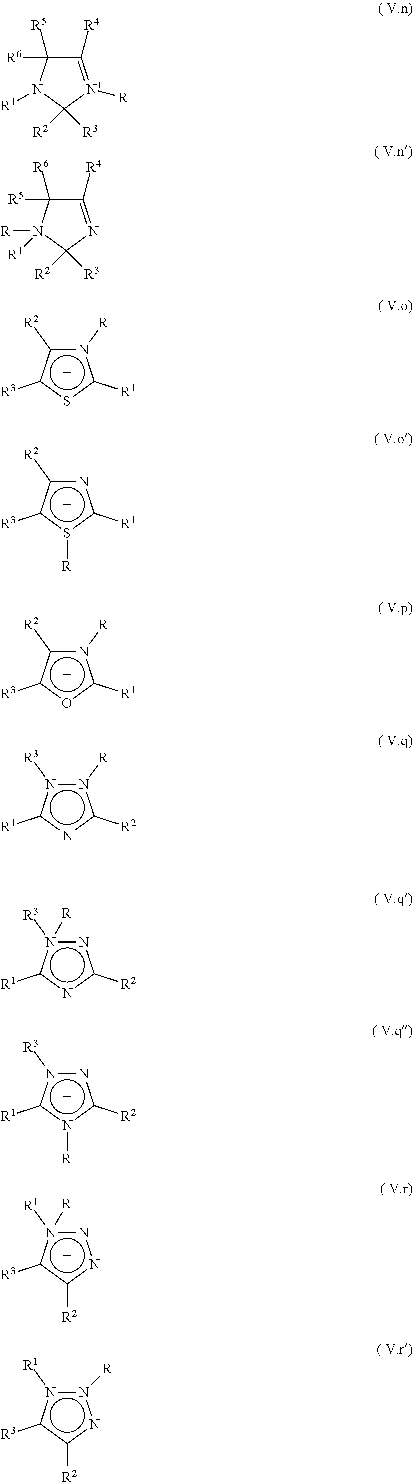

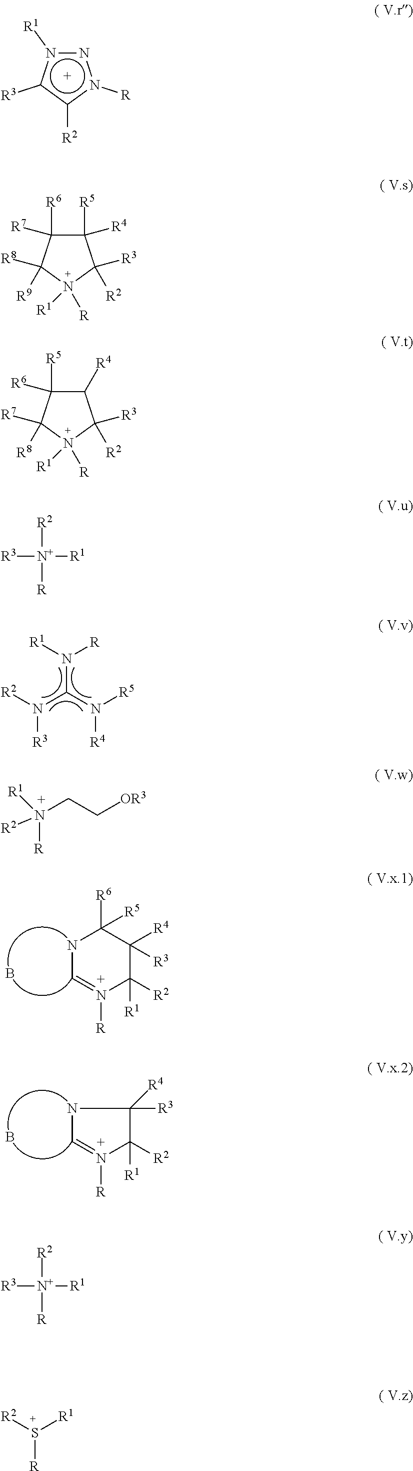

and oligomers comprising these structures, wherein
R is hydrogen, alkyl, alkenyl, cycloalkyl, cycloalkenyl, polycyclyl, heterocycloalkyl, aryl, or heteroaryl;
radicals R¹, R², R³, R⁴, R⁵, R⁶, R⁷, R⁸ and R⁹ which are bound to a ring carbon are each, independently of one another, hydrogen, a sulfo group, COOH, carboxylate, sulfonate, acyl, alkoxycarbonyl, CO(NE¹E²), cyano, halogen, hydroxyl, SH, nitro, NE³E⁴, alkyl, alkoxy, alkylthio, alkylsulfinyl, alkylsulfonyl, alkenyl, cycloalkyl, cycloalkyloxy, cycloalkenyl, cycloalkenyloxy, polycyclyl, polycyclyloxy, heterocycloalkyl, aryl, aryloxy, or heteroaryl, wherein E¹, E², E³ and E⁴ are each, independently of one another, hydrogen, alkyl, cycloalkyl, heterocycloalkyl, aryl, or hetaryl,
radicals R¹, R², R³, R⁴, R⁵, R⁶, R⁷, R⁸ and R⁹ which are bound to a heteroatom are each, independently of one another, hydrogen, a sulfo group, NE¹E², sulfonate, alkyl, alkoxy, alkenyl, cycloalkyl, cycloalkenyl, polycyclyl, heterocycloalkyl, aryl, or heteroaryl, wherein E¹ and E² are each, independently of one another, hydrogen, alkyl, cycloalkyl, heterocycloalkyl, aryl, or heteroaryl, or
   two adjacent radicals R¹ to R⁹ together with the ring atoms to which they are bound form at least one fused-on, saturated, unsaturated, or aromatic ring or a ring system having from 1 to 12 carbon atoms, wherein the ring or the ring system optionally has from 1 to 5 non-adjacent heteroatoms or heteroatom-comprising groups and the ring or the ring system is unsubstituted or substituted,
   wherein two geminal radicals R¹ to R⁹ together are ═O, ═S or ═NR^{b}, wherein R^{b} is hydrogen, alkyl, cycloalkyl, aryl, or heteroaryl, and
   R¹ and R³ or R³ and R⁵ in the compounds of the formula (V.x.1) together represent the second bond of a double bond between the ring atoms bearing these radicals, or
the radicals R, R¹, R², R³, R⁴, R⁵, R⁶, R⁷, R⁸ and R⁹ are alkanediyl, cycloalkanediyl, alkenediyl or cycloalkenediyl which links a cation of one of the formulae (V.a) to (V.z) to a further cation of one of the formulae (V.a) to (V.z); wherein these radicals additionally function, via their second point of bonding, as radical R, R¹, R², R³, R⁴, R⁵, R⁶, R¹, R^{a} or R⁹ of said further cation; and the radicals alkanediyl, cycloalkanediyl, alkenediyl and cycloalkenediyl are branched or linear, substituted and/or interrupted by at least one heteroatom or heteroatom-comprising group;
B in the compounds of the formulae (V.x.1) and (V.x.2) together with the C—N group to which it is bound forms a 4- to 8-membered saturated or unsaturated or aromatic ring which is optionally substituted and/or is optionally containing further heteroatoms or heteroatom-comprising groups and/or optionally comprise the further fused-on saturated, unsaturated or aromatic carbocycles or heterocycles.
6. The use or method according to embodiment 5, wherein [A]^{m+} is selected from the group consisting of compounds of the formulae (V.e), (V.u), (V.y) and (V.z),

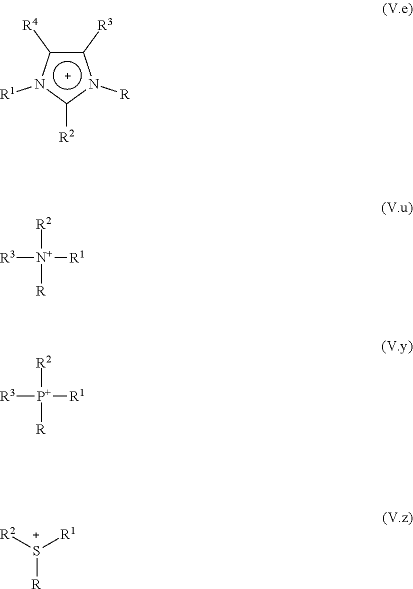

wherein R is hydrogen, alkyl, alkenyl, cycloalkyl, cycloalkenyl, polycyclyl, heterocycloalkyl, aryl, or heteroaryl;
radicals R², R³ and R⁴ which are bound to a ring carbon are each, independently of one another, hydrogen, a sulfo group, COOH, carboxylate, sulfonate, acyl, alkoxycarbonyl, CO(NE¹E²), cyano, halogen, hydroxyl, SH, nitro, NE³E⁴, alkyl, alkoxy, alkylthio, alkylsulfinyl, alkylsulfonyl, alkenyl, cycloalkyl, cycloalkyloxy, cycloalkenyl, cycloalkenyloxy, polycyclyl, polycyclyloxy, heterocycloalkyl, aryl, aryloxy, or heteroaryl, wherein E¹, E², E³ and E⁴ are each, independently of one another, hydrogen, alkyl, cycloalkyl, heterocycloalkyl, aryl, or hetaryl; and
radicals R¹, R² and R³ which are bound to a heteroatom are each, independently of one another, hydrogen, a sulfo group, NE¹E², sulfonate, alkyl, alkoxy, alkenyl, cycloalkyl, cycloalkenyl, polycyclyl, heterocycloalkyl, aryl, or heteroaryl, wherein E¹ and E² are each, independently of one another, hydrogen, alkyl, cycloalkyl, heterocycloalkyl, aryl, or hetaryl.
7. The use or method according to embodiment 6, wherein the radicals R, R¹, R² and R³ which are bound to a heteroatom are each, independently of one another, C₁-C₈-alkyl, or cycloalkyl, and the radicals R², R³ and R⁴ which are bound to a carbon atom are each hydrogen.
8. The use or method according to embodiment 7, wherein the radicals R, R¹, R² and R³ which are bound to a heteroatom are each, independently of one another, C₁-C₅-alkyl, or cycloalkyl, and the radicals R², R³ and R⁴ which are bound to a carbon atom are each hydrogen.
9. The use or method according to any of the embodiments 5 to 8, wherein the compound of formula (V.e) is 1-ethyl-3-methylimidazolium.
10. The use or method according to any of the embodiments 5 to 8, wherein the compounds of the formula (V.u), are selected from the group consisting of methyltriethanolammonium, and dimethylcyclohexylammonium.
11. The use or method according to any of the embodiments 5 to 8, wherein the compounds of formula (V.y), are selected from the group consisting of tributylethylphosphonium, and tetrakis(hydroxymethyl)phosphonium.
12. The use or method according to any of the embodiments 1 to 11, wherein [Y]ⁿ⁻ is selected from anions of:

the group of sulfates, sulfites and sulfonates of the general formulae:

SO₄²⁻,HSO₄⁻,SO₃²⁻,HSO₃⁻,R^{c}OSO₃⁻,R^{c}SO₃⁻;
the group of phosphates of the general formulae:

PO₄³⁻,HPO₄²⁻,H₂PO₄⁻,R^{c}PO₄²⁻,HR^{c}PO₄⁻,R^{c}R^{d}PO₄⁻;
the group of phosphonates and phosphinates of the general formulae:

R^{c}HPO₃⁻,R^{c}R^{d}PO₂⁻,R^{c}R^{d}PO₃⁻;
the group of phosphites of the general formulae:

PO₃³⁻,HPO₃²⁻,H₂PO₃⁻,R^{c}PO₃²⁻,R^{c}HPO₃⁻,R^{c}R^{d}PO₃⁻;
the group of phosphonites and phosphinites of the general formulae:

R^{c}R^{d}PO₂⁻,R^{c}HPO₂⁻,R^{c}R^{d}PO⁻,R^{c}HPO⁻;
the group of carboxylates of the general formula:

R^{c}COO⁻;
anions of hydroxycarboxylic acids and sugar acids;
the group of carbonates and carbonic esters of the general formulae:

HCO₃,CO₃²⁻,R^{c}CO₃⁻;

wherein the radicals R^{c} and R^{d} are selected independently from each other from hydrogen, alkyl, cycloalkyl, heterocycloalkyl, aryl and heteroaryl.
13. The use or method according to embodiment 12, wherein [Y]ⁿ⁻ is selected from anions of:
   the group of sulfates, sulfites and sulfonates of the general formulae:

SO₄²⁻,HSO₄⁻,SO₃²⁻,HSO₃⁻,R^{c}OSO₃⁻,R^{c}SO₃⁻;
the group of phosphates of the general formulae:

PO₄³⁻,HPO₄²⁻,H₂PO₄⁻,R^{c}PO₄²⁻,HR^{c}PO₄⁻,R^{c}R^{d}PO₄⁻;
the group of carboxylates of the general formula:

R^{c}COO⁻;
wherein the radicals R^{c} and R^{d} are selected independently from each other from hydrogen, alkyl, cycloalkyl, heterocycloalkyl, aryl and heteroaryl.
14. The use or method according to embodiment 13, wherein [Y]ⁿ⁻ is selected from R^{c}COSO₃⁻, R^{c}R^{d}PO₄⁻ and R^{c}COO⁻;
   wherein the radicals R^{c} and R^{d} are selected independently from each other from hydrogen, alkyl, cycloalkyl, heterocycloalkyl, aryl, and heteroaryl.
15. The use or method according to any of embodiments 12 to 14, wherein R^{c} and R^{d} are selected independently from each other from hydrogen and C₁-C₈-alkyl.
16. The use or method according to embodiment 15, wherein R^{c} and R^{d} are selected independently from each other from hydrogen and C₁-C₅-alkyl.
17. The use or method according to any of the embodiments 1 to 16, wherein the at least one ionic liquid contains 2 to 16 carbon atoms.
18. The use or method according to any of the embodiments 1 to 17, wherein the at least one ionic liquid is selected from the group consisting of 1-ethyl-3-methylimidazolium acetate, methyltriethanolammonium methosulfate, tributylethylphosphonium diethylphosphate, bis(dimethylcyclohexylammonium) sulfate, and tetrakis(hydroxymethyl)phosphonium sulfate.
19. The use or method according to any of the embodiments 1 to 18, wherein the at least one ionic liquid is present in an amount in the range from ≥0.05 wt. % to ≤5.0 wt. %, based on the total weight of the aqueous coating composition.
20. The use or method according to embodiment 19, wherein the at least one ionic liquid is present in an amount in the range from ≥0.2 wt. % to ≤2.0 wt. %, based on the total weight of the aqueous coating composition.
21. The use or method according to any of the embodiments 1 to 20, wherein the at least one silicate binder is selected from the group consisting of colloidal silica, potassium silicate, sodium silicate, lithium silicate, and combinations thereof.
22. The use or method according to any of the embodiments 1 to 21, wherein the at least one silicate binder is present in an amount in the range from ≥10.0 wt. % to ≤50.0 wt. %, based on the total weight of the aqueous coating composition.
23. The use or method according to embodiment 22, wherein the at least one silicate binder is present in an amount in the range from ≥15.0 wt. % to ≤30.0 wt. %, based on the total weight of the aqueous coating composition.
24. The use or method according to any of the embodiments 1 to 23, wherein the weight ratio of the at least one ionic liquid to the at least one silicate binder is in the range from 1:1000 to 1:2.
25. The use or method according to embodiment 24, wherein the weight ratio of the at least one ionic liquid to the at least one silicate binder is in the range from 1:150 to 1:7.5.
26. An aqueous coating composition comprising:
   iii) at least one ionic liquid selected from the group consisting of (IL1), (IL2), (IL3), and (IL4),
   iv) at least one white pigment; and
   iii) at least one silicate binder,
   wherein
   (IL1) salts of the general formula (I)

[A]ₚ^{m+}[Y]_{q}ⁿ⁻ (I),
wherein
m, n, p, and q are each 1, 2, 3, or 4 and the product of p and m is equal to the product of q and n;
[A]^{m+} is
i) a monovalent, divalent, trivalent, or tetravalent cation selected from ammonium groups, oxonium groups, sulfonium groups, and phosphonium groups; or
ii) a cationic compound comprising two or more cationic groups which are selected independently from ammonium groups, oxonium groups, sulfonium groups, and phosphonium groups; and
[Y]ⁿ⁻ is a monovalent, divalent, trivalent, or tetravalent anion or a mixture of these anions;
(IL2) mixed salts of the general formulae (II.a), (II.b) or (II.c)

[A¹]⁺[A²]⁺[Y]ⁿ⁻ (II.a),
wherein n=2,

[A]⁺[A²]⁺[A³]⁺[Y]ⁿ⁻ (II.b),
wherein n=3,

[A¹]⁺[A²]⁺[A³]⁺[A⁴]⁺[Y]ⁿ⁻ (II.c),
wherein n=4, and
wherein [A¹]⁺, [A²]⁺, [A³] and [A⁴]⁺ is are monovalent cations selected from [A]^{m+}; and [Y]ⁿ⁻ is a monovalent, divalent, trivalent, or tetravalent anion or a mixture of these anions;
(IL3) mixed salts of the general formulae (III.a) to (III.h)

[A¹]²⁺[A²]⁺[Y]ⁿ⁻ (III.a),
wherein n=3,

[A¹]²⁺[A²]⁺[A³]⁺[Y]ⁿ⁻ (III.b),
wherein n=4,

[A¹]²⁺[A⁴]²⁺[Y]ⁿ⁻ (III.c),
wherein n=4,

[A⁵]³⁺[A²]⁺[Y]ⁿ⁻ (III.d),
wherein n=4,

[A¹]²⁺[A²]⁺[A³]⁺[A⁶]⁺[Y]ⁿ⁻ (III.e),
wherein n=5,

[A¹]²⁺[A⁴]²⁺[A⁶]⁺[Y]ⁿ⁻ (III.f),
wherein n=5,

[A⁵]³⁺[A²]⁺[A³]⁺[Y]ⁿ⁻ (III.g),
wherein n=5,

[A⁷]⁴⁺[A²]⁺[Y]ⁿ⁻ (III.h),
wherein n=5, and

wherein [A¹]²⁺, [A²]⁺, [A³]⁺, [A⁴]²⁺, [A⁵]³⁺, [A⁶]⁺, and [A⁷]⁴⁺ are monovalent, divalent, trivalent, or tetravalent cations selected from [A]^{m+}; and [Y]ⁿ⁻ is a monovalent, divalent, trivalent, or tetravalent anion or a mixture of these anions; and
(IL4) mixed salts of the general formulae (IV.a) to (IV.j)

[A¹]⁺[A²]⁺[A³]⁺[M¹]⁺[Y]ⁿ⁻ (IV.a),
wherein n=4,

[A¹]⁺[A²]⁺[M¹]⁺[M²]⁺[Y]ⁿ⁻ (IV.b),
wherein n=4,

[A¹]⁺[M¹]⁺[M²]⁺[M³]⁺[Y]ⁿ⁻ (IV.c),
wherein n=4,

[A¹]⁺[A²]⁺[M¹]⁺[Y]ⁿ⁻ (IV.d),
wherein n=3,

[A¹]⁺[M¹]⁺[M²]⁺[Y]ⁿ⁻ (IV.e),
wherein n=3,

[A¹]⁺[M¹]⁺[Y]ⁿ⁻ (IV.f),
wherein n=2,

[A¹]⁺[A²]⁺[M⁴]²⁺[Y]ⁿ⁻ (IV.g),
wherein n=4,

[A¹]⁺[M¹]⁺[M⁴]²⁺[Y]ⁿ⁻ (IV.h),
wherein n=4,

[A¹]⁺[M⁵]³⁺[Y]ⁿ⁻ (IV.i),
wherein n=4,

[A¹]⁺[M⁴]²⁺[Y]ⁿ⁻ (IV.j),
wherein n=3, and

wherein [A¹]⁺, [A²]⁺, and [A³]⁺ are monovalent, divalent, trivalent or tetravalent cations selected from [A]^{m+}; [Y]ⁿ⁻ is a monovalent, divalent, trivalent, or tetravalent anion or a mixture of these anions; and [M¹]⁺, [M²]⁺, and [M³]⁺ are monovalent metal cations, [M⁴]²⁺ are divalent metal cations and [M⁵]³⁺ are trivalent metal cations.
27. The aqueous coating composition according to embodiment 26, wherein m, n, p, and q are each 1, 2, 3, or 4 and the product of p and m is equal to the product of q and n; [A]^{m+} is a monovalent, divalent, trivalent or tetravalent cation selected from ammonium groups, oxonium groups, sulfonium groups, and phosphonium groups.
28. The aqueous coating composition according to embodiments 27, wherein m, n, p, and q are each 1, 2, 3, or 4 and the product of p and m is equal to the product of q and n; [A]^{m+} is a monovalent cation selected from ammonium groups, oxonium groups, sulfonium groups, and phosphonium groups.
29. The aqueous coating composition according to any of the embodiments 26 to 28,
   wherein [A]^{m+} is selected from the group consisting of compounds of the formulae (V.a) to (V.z),

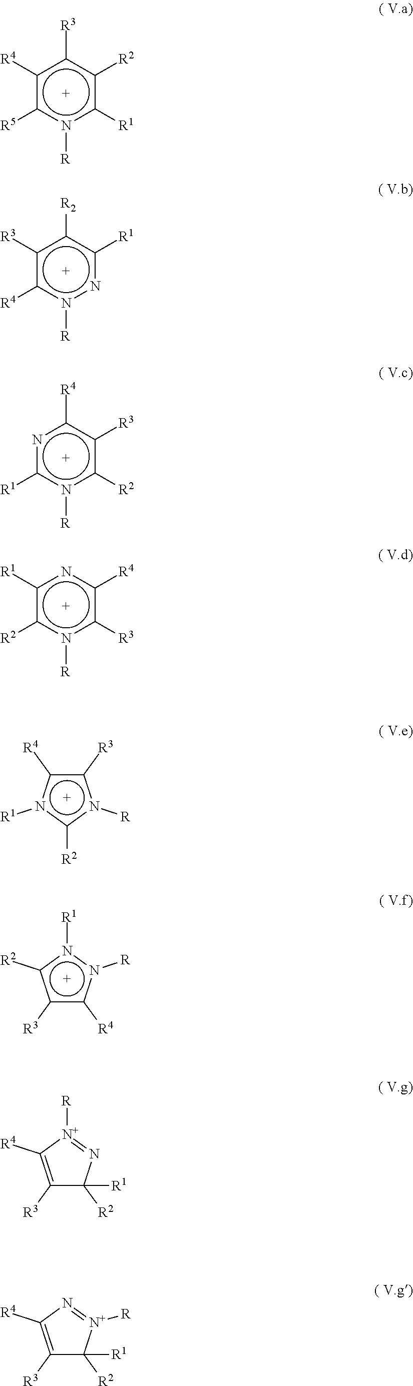

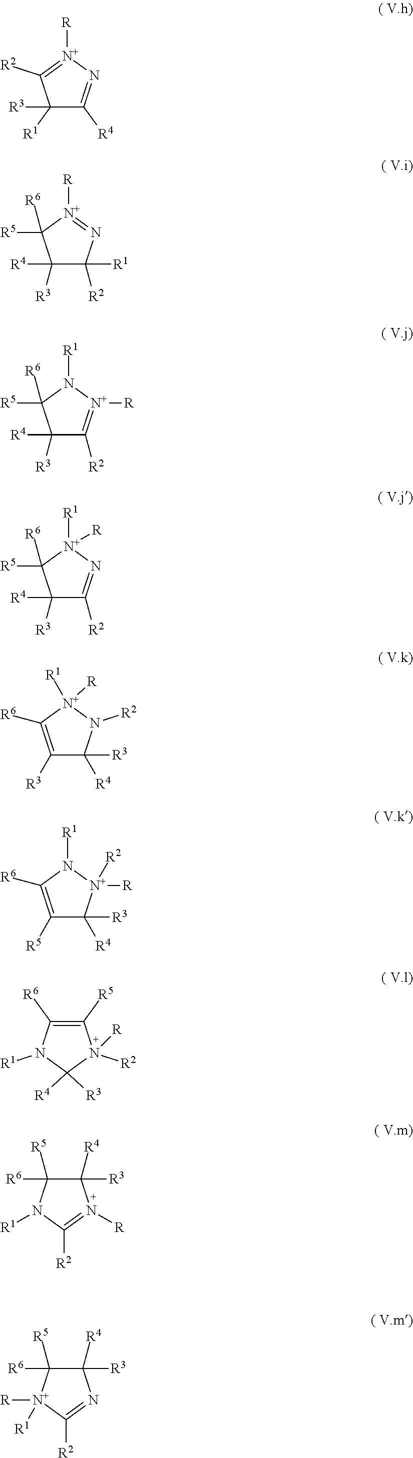

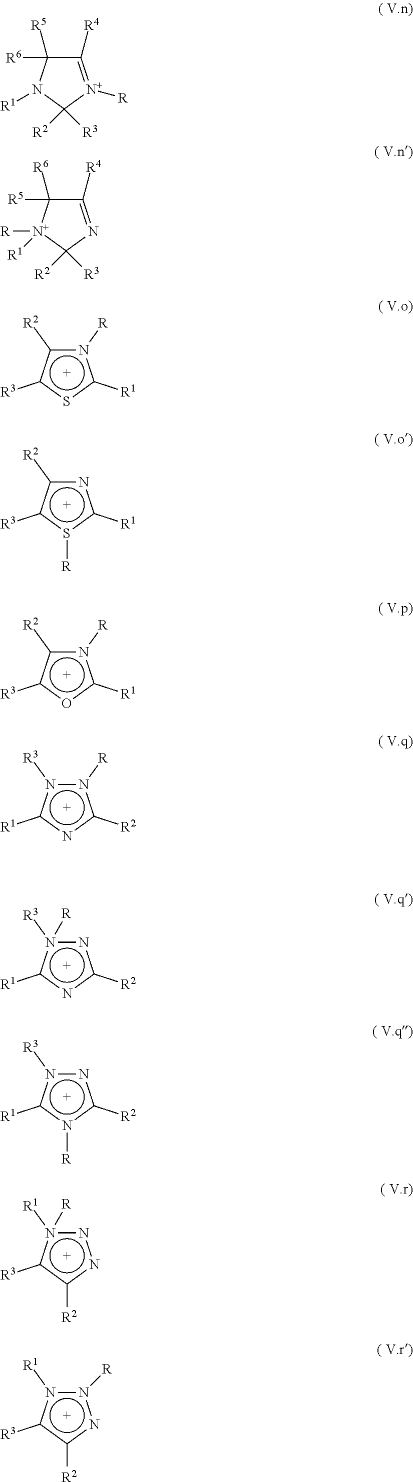

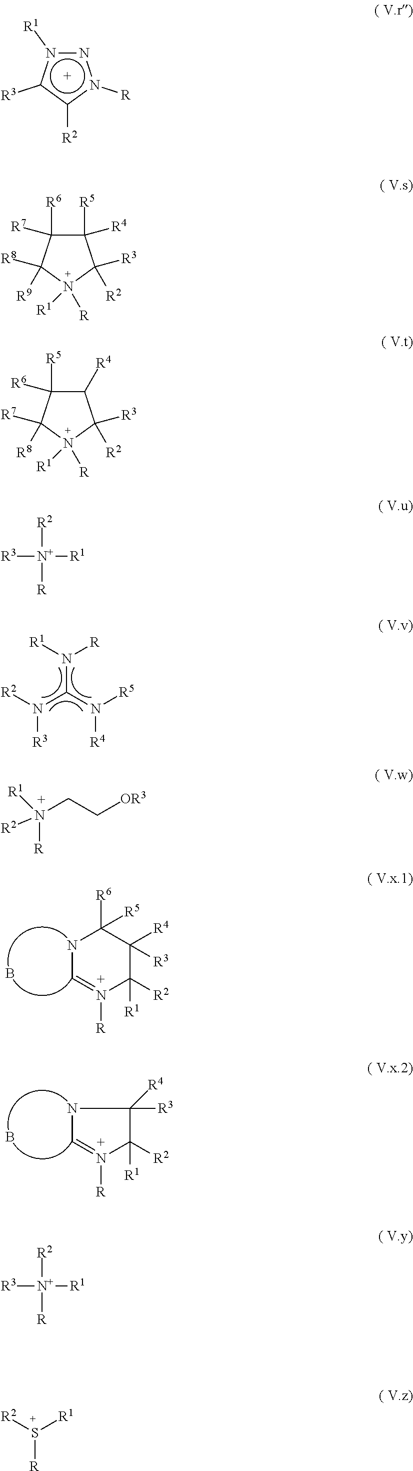

and oligomers comprising these structures, wherein
R is hydrogen, alkyl, alkenyl, cycloalkyl, cycloalkenyl, polycyclyl, heterocycloalkyl, aryl, or heteroaryl;
radicals R¹, R², R³, R⁴, R⁵, R⁶, R⁷, R^{a} and R⁹ which are bound to a ring carbon are each, independently of one another, hydrogen, a sulfo group, COOH, carboxylate, sulfonate, acyl, alkoxycarbonyl, CO(NE¹E²), cyano, halogen, hydroxyl, SH, nitro, NE³E⁴, alkyl, alkoxy, alkylthio, alkylsulfinyl, alkylsulfonyl, alkenyl, cycloalkyl, cycloalkyloxy, cycloalkenyl, cycloalkenyloxy, polycyclyl, polycyclyloxy, heterocycloalkyl, aryl, aryloxy, or heteroaryl, wherein E¹, E², E³ and E⁴ are each, independently of one another, hydrogen, alkyl, cycloalkyl, heterocycloalkyl, aryl, or hetaryl,
radicals R¹, R², R³, R⁴, R⁵, R⁶, R⁷, R^{a} and R⁹ which are bound to a ring heteroatom are each, independently of one another, hydrogen, a sulfo group, NE¹E², sulfonate, alkyl, alkoxy, alkenyl, cycloalkyl, cycloalkenyl, polycyclyl, heterocycloalkyl, aryl, or heteroaryl, wherein E¹ and E² are each, independently of one another, hydrogen, alkyl, cycloalkyl, heterocycloalkyl, aryl, or hetaryl, or
   two adjacent radicals R¹ to R⁹ together with the ring atoms to which they are bound form at least one fused-on, saturated, unsaturated or aromatic ring or a ring system having from 1 to 12 carbon atoms, wherein the ring or the ring system optionally has from 1 to 5 nonadjacent heteroatoms or heteroatom-comprising groups and the ring or the ring system is unsubstituted or substituted,
   wherein two geminal radicals R¹ to R⁹ together are ═O, ═S, or ═NR^{b}, wherein R^{b} is hydrogen, alkyl, cycloalkyl, aryl, or heteroaryl, and
   R¹ and R³ or R³ and R⁵ in the compounds of the formula (V.x.1) together represent the second bond of a double bond between the ring atoms bearing these radicals or,
the radicals R, R¹, R², R³, R⁴, R⁵, R⁶, R⁷, R⁸ and R⁹ are alkanediyl, cycloalkanediyl, alkenediyl, or cycloalkenediyl which links a cation of one of the formulae (V.a) to (V.z) to a further cation of one of the formulae (V.a) to (V.z); wherein these radicals additionally function, via their second point of bonding, as radical R, R¹, R², R³, R⁴, R⁵, R⁶, R¹, R^{a} or R⁹ of said further cation; and the radicals alkanediyl, cycloalkanediyl, alkenediyl, and cycloalkenediyl are branched or linear, substituted and/or interrupted by at least one heteroatom or heteroatom-comprising group;
B in the compounds of the formulae (V.x.1) and (V.x.2) together with the C—N group to which it is bound forms a 4- to 8-membered saturated or unsaturated or aromatic ring which is optionally substituted and/or is optionally containing further heteroatoms or heteroatom-comprising groups and/or optionally comprise the further fused-on saturated, unsaturated or aromatic carbocycles or heterocycles.
30. The aqueous coating composition according to embodiment 29, wherein [A]^{m+} is selected from the group consisting of compounds of the formulae (V.e), (V.u), (V.y) and (V.z),

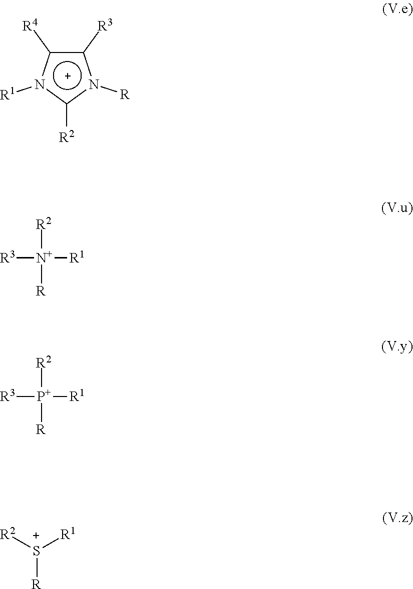

in which R is hydrogen, alkyl, alkenyl, cycloalkyl, cycloalkenyl, polycyclyl, heterocycloalkyl, aryl, or heteroaryl;
radicals R², R³ and R⁴ which are bound to a ring carbon are each, independently of one another, hydrogen, a sulfo group, COOH, carboxylate, sulfonate, acyl, alkoxycarbonyl, CO(NE¹E²), cyano, halogen, hydroxyl, SH, nitro, NE³E⁴, alkyl, alkoxy, alkylthio, alkylsulfinyl, alkylsulfonyl, alkenyl, cycloalkyl, cycloalkyloxy, cycloalkenyl, cycloalkenyloxy, polycyclyl, polycyclyloxy, heterocycloalkyl, aryl, aryloxy, or heteroaryl, wherein E¹, E², E³ and E⁴ are each, independently of one another, hydrogen, alkyl, cycloalkyl, heterocycloalkyl, aryl, or hetaryl; and
radicals R¹, R² and R³ which are bound to a heteroatom are each, independently of one another, hydrogen, a sulfo group, NE¹E², sulfonate, alkyl, alkoxy, alkenyl, cycloalkyl, cycloalkenyl, polycyclyl, heterocycloalkyl, aryl, or heteroaryl, wherein E¹ and E² are each, independently of one another, hydrogen, alkyl, cycloalkyl, heterocycloalkyl, aryl, or hetaryl.
31. The aqueous coating composition according to embodiments 29 or 30, wherein the radicals R, R¹, R² and R³ which are bound to a heteroatom are each, independently of one another, C₁-C₈-alkyl, or cycloalkyl, and the radicals R², R³ and R⁴ which are bound to a carbon atom are each hydrogen.
32. The aqueous coating composition according to any of embodiments 29 to 31, wherein the radicals R, R¹, R² and R³ which are bound to a heteroatom are each, independently of one another, C₁-C₅-alkyl, or cycloalkyl, and the radicals R², R³ and R⁴ which are bound to a carbon atom are each hydrogen.
33. The aqueous coating composition according to any of the embodiments 29 to 32, wherein the compounds of formula (V.e) is 1-ethyl-3-methylimidazolium.
34. The aqueous coating composition according to any of the embodiments 29 to 32, wherein the compounds of formula (V.u), are selected from the group consisting of methyltriethanolammonium, and dimethylcyclohexylammonium.
35. The aqueous coating composition according to any of the embodiments 29 to 32, wherein the compounds of formula (V.y), are selected from the group consisting of tributylethylphosphonium, and tetrakis(hydroxymethyl)phosphonium.
36. The aqueous coating composition according to embodiment 26, wherein [Y]ⁿ⁻ is selected from anions of:
   the group of sulfates, sulfites and sulfonates of the general formulae:

SO₄²⁻,HSO₄⁻,SO₃²⁻,HSO₃⁻,R^{c}OSO₃⁻,R^{c}SO₃⁻;
the group of phosphates of the general formulae:

PO₄³⁻,HPO₄²⁻,H₂PO₄⁻,R^{c}PO₄²⁻,HR^{c}PO₄⁻,R^{c}R^{d}PO₄⁻;
the group of phosphonates and phosphinates of the general formulae:

R^{c}HPO₃⁻,R^{c}R^{d}PO₂⁻,R^{c}R^{d}PO₃⁻;
the group of phosphites of the general formulae:

PO₃³⁻,HPO₃²⁻,H₂PO₃—,R^{c}PO₃²⁻,R^{c}HPO₃⁻,R^{c}R^{d}PO₃⁻;
the group of phosphonites and phosphinites of the general formulae:

R^{c}R^{d}PO₂⁻,R^{c}HPO₂⁻,R^{c}R^{d}PO⁻,R^{c}HPO⁻;
the group of carboxylates of the general formula:

R^{c}COO⁻;
anions of hydroxycarboxylic acids and sugar acids;
the group of carbonates and carbonic esters of the general formulae:

HCO₃⁻,CO₃²⁻,R^{c}CO₃⁻;

wherein the radicals R^{c} and R^{d} are selected independently from each other from hydrogen, alkyl, cycloalkyl, heterocycloalkyl, aryl and heteroaryl.
37. The aqueous coating composition according to embodiment 36, wherein [Y]ⁿ⁻ is selected from anions of:
   the group of sulfates, sulfites and sulfonates of the general formulae:

SO₄²⁻,HSO₄⁻,SO₃²⁻,HSO₃⁻,R^{c}OSO₃⁻,R^{c}SO₃⁻;
the group of phosphates of the general formulae:

PO₄³⁻,HPO₄²⁻,H₂PO₄⁻,R^{c}PO₄²⁻,HR^{c}PO₄⁻,R^{c}R^{d}PO₄⁻;
the group of carboxylates of the general formula:

R^{c}COO⁻;

wherein the radicals R^{c} and R^{d} are selected independently from each other from hydrogen, alkyl, cycloalkyl, heterocycloalkyl, aryl and heteroaryl.
38. The aqueous coating composition according to embodiment 36, wherein [Y]ⁿ⁻ is selected from R^{c}OSO₃⁻, R^{c}R^{d}PO₄⁻ and R^{c}COO⁻;
   wherein the radicals R^{c} and R^{d} are selected independently from each other from hydrogen, alkyl, cycloalkyl, heterocycloalkyl, aryl and heteroaryl.
39. The aqueous coating composition according to any of embodiments 36 to 38, wherein the radicals R^{c} and R^{d} are selected independently from each other from hydrogen, C₁-C₈-alkyl.
40. The aqueous coating composition according to embodiment 39, wherein the radicals RC and R^{d} are selected independently from each other from hydrogen, C₁-C₅-alkyl.
41. The aqueous coating composition according to any of the embodiment 26 to 40, wherein the at least one ionic liquid contains 2 to 16 carbon atoms.
42. The aqueous coating composition according to any of the embodiments 26 to 41, wherein the at least one ionic liquid is selected from the group consisting of 1-ethyl-3-methylimidazolium acetate, methyltriethanolammonium methosulfate, tributylethylphosphonium diethylphosphate, bis(dimethylcyclohexylammonium) sulfate, and tetrakis(hydroxymethyl)phosphonium sulfate.
43. The aqueous coating composition according to any of the embodiments 26 to 42, wherein the at least one ionic liquid is present in an amount in the range from ≥0.05 wt. % to ≤5.0 wt. %, based on the total weight of the aqueous coating composition.
44. The aqueous coating composition according to embodiment 43, wherein the at least one ionic liquid is present in an amount in the range from ≥0.2 wt. % to ≤2.0 wt. %, based on the total weight of the aqueous coating composition.
45. The aqueous coating composition according to any of the embodiments 26 to 44, wherein the halide content of the aqueous coating composition is in the range from 0.0001 to 0.1 wt. % based on the total weight of the aqueous coating composition.
46. The aqueous coating composition according to any of the embodiments 26 to 44, wherein the aqueous coating composition further comprises at least one dispersant selected from the group of alkoxylated polycarboxylates.
47. The aqueous coating composition according to embodiment 46, wherein the alkoxylated polycarboxylate is an ammonium polyacrylate.
48. The aqueous coating composition according to embodiments 46 or 47, wherein the at least one dispersant is present in an amount in the range from ≥0.05 wt. % to ≤2.0 wt. %, based on the total weight of the aqueous coating composition.
49. The aqueous coating composition according to embodiment 48, wherein the at least one dispersant is present in an amount in the range from ≥0.1 wt. % to ≤1.0 wt. %, based on the total weight of the aqueous coating composition.
50. The aqueous coating composition according to any of the embodiments 26 to 49, wherein the aqueous coating composition further comprises at least one filler selected from the group consisting of natural calcium carbonate, calcite, marble, chalk, mica, feldspar, beryl, wollastonite, quartz, talc, kaolin, pozzolanic earth, calcium silicate, aluminum silicate, magnesium silicate, zinc silicate, barium sulfate, and combinations thereof.
51. The aqueous coating composition according to embodiment 50, wherein the at least one filler is present in an amount in the range from ≥5.0 wt. % to ≤80.0 wt. %, based on the total weight of the aqueous coating composition.
52. The aqueous coating composition according to embodiment 51 wherein the at least one filler is present in an amount in the range from ≥30.0 wt. % to ≤60.0 wt. %, based on the total weight of the aqueous coating composition.
53. The aqueous coating composition according to any of the embodiments 26 to 52, wherein the at least one white pigment is selected from the group consisting of titanium dioxide, rutile, anatase, barium sulfate, zinc oxide, zinc sulfide, and combinations thereof.
54. The aqueous coating composition according to embodiments 26 to 53, wherein the at least one white pigment is present in an amount in the range from ≥1.0 wt. % to ≤10.0 wt. %, based on the total weight of the aqueous coating composition.
55. The aqueous coating composition according to embodiment 54, wherein the at least one white pigment is present in an amount in the range from ≥3.0 wt. % to ≤9.0 wt. %, based on the total weight of the aqueous coating composition.
56. The aqueous coating composition according to any of the embodiments 26 to 55, wherein the at least one silicate binder is selected from the group consisting of colloidal silica, potassium silicate, sodium silicate, lithium silicate, and combinations thereof.
57. The aqueous coating composition according to any of the embodiments 26 to 56, wherein the at least one silicate binder is present in an amount in the range from ≥10.0 wt. % to ≤50.0 wt. %, based on the total weight of the aqueous coating composition.
58. The aqueous coating composition according to embodiment 57, wherein the at least one silicate binder is present in an amount in the range from ≥15.0 wt. % to ≤30.0 wt. %, based on the total weight of the aqueous coating composition.
59. The aqueous coating composition according to any of the embodiments 26 to 58, wherein the aqueous coating composition further comprises at least one thickener selected from the group consisting of carboxymethyl cellulose, polyurethane, carboxymethyl cellulose, hydroxyethylcellulose, hydrophobized urethane, xanthan gum, micro fibrillated cellulose, and combinations thereof.
60. The aqueous coating composition according to embodiment 59, wherein the at least one thickener is present in an amount in the range from ≥0.08 wt. % to ≤1.0 wt. %, based on the total weight of the aqueous coating composition.
61. The aqueous coating composition according to embodiment 60, wherein the at least one thickener is present in an amount in the range from ≥0.2 wt. % to ≤0.6 wt. %, based on the total weight of the aqueous coating composition.
62. The aqueous coating composition according to any of the embodiments 26 to 61, wherein the weight ratio of the at least one ionic liquid to the at least one filler is in the range from 1:1600 to 1:1.
63. The aqueous coating composition according to any of the embodiments 26 to 62, wherein the weight ratio of the at least one ionic liquid to the at least one dispersant is in the range from 1:40 to 100:1.
64. The aqueous coating composition according to any of the embodiments 26 to 63, wherein weight ratio of the at least one ionic liquid to the at least one silicate binder is in the range from 1:1000 to 1:2.
65. The aqueous coating composition according to any of the embodiments 26 to 64, wherein the aqueous coating composition further comprises at least one anti-foaming agent selected from the group consisting of mineral oil, silicone oil, soybean oil, linseed oil, palm oil, coconut oil, rapeseed oil, canola oil, rice bran oil, olive oil, and combinations thereof and the at least one anti foaming agent is present in an amount in the range from ≥0.08 wt. % to ≤1.0 wt. %, based on the total weight of the aqueous coating composition.
66. The aqueous coating composition according to any of the embodiments 26 to 65, wherein the aqueous coating composition further comprises at least one organic binder selected from the group consisting of styrene acrylate, 2-ethylhexyl acrylate, n-butyl acrylate, ethyl acrylate, methyl acrylate, vinyl acrylate, vinyl propionate, and combinations thereof and the at least one organic binder is present in an amount in the range from ≥2.0 wt. % to ≤20.0 wt. %, based on the total weight of the aqueous coating composition.
67. The aqueous coating composition according to any of the embodiments 26 to 66, wherein the aqueous coating composition further comprises an additive selected from the group consisting of viscosity regulator, hydrophobing agent, and combinations thereof.

While the presently claimed invention has been described in terms of its specific embodiments, certain modifications and equivalents will be apparent to those skilled in the art and are intended to be included within the scope of the presently claimed invention.

### EXAMPLES

The presently claimed invention is illustrated in detail by non-restrictive working examples which follow. More particularly, the test methods specified hereinafter are part of the general disclosure of the application and are not restricted to the specific working examples.

Materials

| | |
|---|---|
| Cycloquart ® | 20% strength aqueous solution of propoxylated N,N,N′N′-tetra- |
| | methylhexanediammonium hydroxide; |
| Dispersogen ® | tetraalkyl-alkylenediammonium hydroxide 17% aq |
| Lopon ® ST | tetraalkyl-alkylenediammonium hydroxide 17% aq |
| Betolin ® Q44 | dimethyltetraethanol-hexamethylenediammonium chloride 20% aq |
| Betolin ® Q40 | tetrahydroxypropylethylenediamine 20% aq |
| Lopon ® 827 | tetrahydroxypropylethylenediamine 20% aq |
| Quadrol ® L | tetrakis-[N-(2-hydroxy-propyl)]-ethylenediamine |
| Walocel ® CRT 10000PA | hydroxyethyl cellulose, granulated 100%; |
| Dispex ® AA4040 | ammonium polycarboxylate 40% aq. |
| Kronos ® 2056 ,2160 | titanium dioxide, rutile |
| Acronal ® S559 | alkali-stable styrene-acrylate dispersion 50% |
| Foamaster ® MO 2114 | mineral oil-based antifoam 100% |
| Trasol ® KW-N | aqueous solution of potassium silicate (K2O content 7.8-8.3 %) |
| Trasol ® KH-K | aqueous solution of potassium silicate (K2O content 10.5-11.2 %) |
| Levasil ® 200 | aqueous colloidal silica solution (40%) |
| Wacker ® BS1306 | polydimethylsiloxane dispersion 50% |
| Basionic ® BC01 | 1-ethyl-3-imidazolinium acetate, EMIM OAc, >98% |
| Basionic ® FS01 | methyltriethanolammonium methosulfates, >97% |
| Basionic ® LQ01 | 1-ethyl-3-methylimidazolinium ethosulfate >97% |
| EMIM-MC ® | 1-ethyl-3-methylimidazolinium methylcarbonate |
| Cytec ® IL169 | tributylethylphosphonium diethylphosphate 100% |
| Albrite ® AD | tributylethylphosphonium diethylphosphate 100% |
| Trilon ® P | modified polyamine |
| PolCarb ®, Argiric ® | kaolin |
| Omyacarb ®, Durcal ®, | calcium carbonate |
| Omyacoat ®, ImerCarb ®, | |
| ImeXtend ®, ImerSpecWhite ®, | |
| Argiric ®, Calplex ®, | |
| Siliplast 910 | naturally occurring combination of aluminium silicate and quartz |

Methods

Viscosity: The viscosity was determined by analogy to DIN 53019-1:2008-09, using a ThermoHaake® RotoVisco® 1 rotational rheometer equipment under the CR mode at 22° C. at rotational speed of 180 U/min equivalent to 1 Ncm shear rate (setting 1); and rotational speed of 0.5 Ncm (setting 4).

### Example 1: Preparation of the Aqueous Coating Composition and its Testing

The compositions were produced by mixing in the order mentioned hereinbelow to obtain 1 kg samples. The mixing was carried out in PE beakers by means of a laboratory disperser at 1000 rpm at room temperature. After addition was complete, the mixture was stirred for another 10 minutes to ensure homogenization.

In a daily cycle, the development of the viscosity was determined at two different shear rates, as indication of in-can stability. Further the testing was carried out over a period of 4 weeks to establish the effectiveness of the stabilizers.

A well stabilized silicate coating or paint composition would show a typical increase of viscosity from initial reading ˜20-40 (Stormer Krebs Units) (eq. to about 2000 mPa*s) to about 50-60 (eq. to about 6000 mPa*s) after a few days, that would stay constant at that level over the remaining test period indicating in-can stability of the composition. In this regard, any interference of silicate binders with other ingredients would lead to gelling of soluble silicate resulting in an unrestricted increase of viscosity. Coating compositions of such high viscosity could not be applied by paint brush or roller any more (i.e., viscosity >150 SKT). In fact, compositions with readings >120 SKT would already mean cumbersome work in applying by roller to a wall to be painted.

### Example 1A: Paint Composition a (for Exterior Use)

Values in grams-

| | | |
|---|---|---|
| Mixing water | 221 | |
| Thickener | 4 | Walocel CRT10000 |
| Dispersant | 3 | Dispex AA4040 |
| Silicate stabilizer(s) | 5 | |
| White pigment TiO2 | 100 | Kronos 2160 |
| Organic binder | 80 | Acronal S559 |
| Antifoam | 2 | Fomaster MO2114 |
| Filler coarse about 3-5μ | 160 | Durcal 5 |
| Filler fine about 1-2μ | 120 | Durcal 2, Omyacoat 850OG |
| Siliceous filler | 50 | Siliplast 910 |
| Potassium silicate binder | 245 | Trasol KH-K |
| Hydrophobisization | 10 | BS1306 |

The viscosity was measured as mentioned above and the results are presented below.

TABLE 1
Composition A
Speed of rotation setting 1

| Viscosity | | | | | | | |
|---|---|---|---|---|---|---|---|
| profile | | | | | | | |
| SKT measure- | Comparative examples | | | | Present invention | | |
| ment/storage | A- | A- | A- | A- | A- | A- | A- |
| time (days) | CQT | Q40 | Q44 | QdL | LQ01 | FS01 | Cyp169 |
| 0 | 38 | 39 | 42 | 80 | 36 | 39 | 39 |
| 1 | 42 | 45 | 44 | 120 | 40 | 43 | 43 |
| 2 | 45 | | | | | | 44 |
| 3 | | 53 | 54 | 150 | 46 | 47 | |
| 7 | 53 | 67 | 70 | | 51 | 54 | 56 |
| 14 | 58 | 91 | 90 | | 54 | 59 | 64 |
| 22 | 61 | 107 | 94 | | 57 | 62 | 68 |
| 28 | 62 | 122 | 95 | | 57 | 64 | 69 |
| Comment: | Good | Too | High | Too | V. | Good | Good |
| | | high | | high | Good | | |

Speed of rotation setting 4

| Viscosity | | | | | | | |
|---|---|---|---|---|---|---|---|
| profile | | | | | | | |
| SKT measure- | | | | | | | |
| ment/storage | A- | A- | A- | A- | A- | A- | A- |
| time (days) | CQT | Q40 | Q44 | QdL | LQ01 | FS01 | Cyp169 |
| 0 | 18 | 19 | 19 | 46 | 18 | 17 | 19 |
| 1 | 20 | 23 | 24 | 86 | 20 | 18 | 22 |
| 2 | 23 | 27 | 28 | | 23 | | |
| 3 | | | | 125 | | 24 | 29 |
| 7 | 32 | 42 | 41 | 140 | 33 | 30 | 35 |
| 14 | 38 | 60 | 65 | | 38 | 35 | 42 |
| 22 | 40 | 78 | 72 | | 40 | 37 | 46 |
| 28 | 40 | 93 | 75 | | 41 | 36 | 46 |
| Comment: | V. | High | Good | Too | V. | V. | V. |
| | good | | | high | good | good | good |

Overall, a stabilizer is considered acceptable if the aqueous coating composition has a viscosity in the most preferred range of 30 to 80 SKT, after 3 weeks of measurement.

The Table 1 above identifies the viscosity of silicate-based exterior paint stabilized with a number of stabilizers. The compatibility of stabilizers along with mentioned ingredients plays a crucial role in establishing a stable coating composition. Herein, the use of ethylenediamine-based stabilizers such as tetra hydroxypropylethylenediamine (QDL) was found to lead to an abnormal increase in viscosity (>150 within 3 days), thus indicating its incompatibility with the other ingredients present in the composition.

On the other hand, N,N,N′,N′-tetramethylhexamethylenediammonium hydroxide (CQT) was considered as a standard for comparison. As can be observed from the Table 1 above, the use of ionic liquids as stabilizer leads to achieving aqueous coating compositions that attain stability within 4 weeks. In fact, imidazolinium-type, ammonium-type and phosphonium-type ionic liquids (LQ01, FS01 and Gyp 169) were found to be effective in stabilizing viscosity with minimal increase in viscosity, in spite varying shear rates, such that the compositions had a viscosity in the range of 30 to 80 SKT, after 3 weeks of measurement.

### Example 11B: Paint Composition B (for Interior Use)

Values in grams-

| | | |
|---|---|---|
| Mixing water | 220 | |
| Thickener | 3 | Walocel CRT10000 |
| Dispersant | 5 | Dispex AA4040 |
| Silicate stabilizer(s) | 10 | |
| White pigment Ti02 | 60 | Kronos 2056 |
| Organic binder | 80 | Acronal 6292 |
| Antifoam | 2 | Foamaster MO2114 |
| Filler calcite | 260 | lmerCarb32, ImeXtend 90 |
| Siliceous filler | 120 | Argiric B24, ImerspecWhite |
| Potassium silicate binder | 140 | Trasol KW-N |
| Silica sol binder | 100 | Levasil 200 |

The viscosity was measured as mentioned above and the results are resented below.

TABLE 2
Composition B
Speed of rotation setting 1

| Viscosity | | | | | | | |
|---|---|---|---|---|---|---|---|
| profile | | | | | | | |
| SKT/storage | B- | B- | B-Dis- | B-Pro- | B-Al- | B- | B- |
| time (days) | LopST | Lop827 | SPS | EMIMEC | bAD | FS01 | BasBC01 |
| 0 | 18 | 39 | 20 | 36 | 40 | 39 | 38 |
| 1 | 34 | 59 | 40 | 41 | 47 | 43 | 44 |
| 2 | 43 | | 50 | | | | |
| 3 | | 75 | | 51 | 54 | 47 | 53 |
| 7 | 63 | 120 | 63 | | 59 | 54 | 57 |
| 14 | 69 | | 63 | 69 | 61 | 59 | 61 |
| 22 | 78 | | 65 | | 64 | 62 | 64 |
| 28 | 86 | | 65 | 75 | 67 | 63 | 65 |
| Comment: | High | Too | V. | Good | V. | V. | V. |
| | | high | good | | good | good | good |

Speed of rotation setting 4

| Viscosity | | | | | Present invention | | |
|---|---|---|---|---|---|---|---|
| profile | Comparative examples | | | | | | B- |
| SKT/storage | B- | B- | B-Dis- | B-Pro- | B-Al- | B- | BasBC |
| time (days) | LopST | Lop827 | SPS | EMIMEC | bAD | FS01 | 01 |
| 0 | 18 | 19 | 19 | 46 | 18 | 17 | 19 |
| 1 | 20 | 23 | 22 | 86 | 20 | 18 | 24 |
| 2 | 23 | 27 | | | 23 | | 28 |
| 3 | | | 29 | 125 | | 24 | |
| 7 | 32 | 42 | 35 | 140 | 33 | 30 | 41 |
| 14 | 38 | 60 | 42 | | 38 | 35 | 65 |
| 22 | 40 | 78 | 46 | | 40 | 37 | 72 |
| 28 | 40 | 93 | 46 | | 41 | 36 | 75 |
| Comment: | V. | High | V. | Too | V. | V. | Good |
| | good | | good | high | good | good | |

In a manner similar to the results enlisted above in The Table 1, the Table 2 above identifies the viscosity of silicate-based interior paint stabilized with a number of stabilizers. Herein, the use of ethyl enediamine-based stabilizers such as LOP 827 was found to lead to a high viscosity (120 after 7 days).

On the other hand, N,N,N′,N′-tetraalkyl-alkylenediammonium hydroxide (Lop ST and Disp SPS) was considered as standard for comparison. As can be observed from the Table 2 above, the use of ionic liquids as stabilizer leads to achieving aqueous coating compositions that attain stability within 4 weeks. In fact, imidazolinium-type, ammonium-type and phosphonium-type ionic liquids (BC01, FS01, EMIM and Alb AD) were found to be effective in stabilizing viscosity, such that the compositions had a viscosity in the range of 30 to 80 SKT, after 3 weeks of measurement. Specifically, EMIM was found to show high viscosity at higher shear rate, but at low shear rates the viscosity was found to be within required limits.

### Example 1C: Paint Composition C (for Interior Use)

Values in grams-

| | | |
|---|---|---|
| Mixing water | 100 | |
| Thickener | 3 | Tylose H10000 |
| Dispersant | 5 | Dispex UltraFa 4404 |
| Silicate stabilizers | 10 | |
| White pigment | 60 | Kronos 2056 |
| Fillers calcitic | 160 | BLP2 |
| Fillers siliceous | 320 | Sibelite flour, mica, Plastorit |
| Potassium silicate binder | | 240 Trasol KWN |
| Silica sol binder | 50 | Levasil 200/40 |
| Hydrophobisization | 10 | Wacker BS16 |
| Residual water | 37-47 | |

The viscosity was measured as mentioned above and the results are presented below.

TABLE 3
Composition C

| Viscosity | | | | | | | |
|---|---|---|---|---|---|---|---|
| profile | | | | | | | |
| SKT | Comparative examples | | | | | | |
| measure- | Without | | | | Present invention | | |
| ment/storage | stabi- | C- | C- | C- | C- | B- | C- |
| time (days) | lizer | Lop827 | CQT | BQ40 | CyplL169 | FS01 | BC01 |

Speed of rotation setting 1

| | | | | | | | |
|---|---|---|---|---|---|---|---|
| 0 | 37 | 39 | 20 | 36 | 40 | 39 | 38 |
| 1 | 73 | 57 | 40 | 52 | 48 | 45 | 44 |
| 2 | 103 | | 50 | | | | |
| 3 | | 76 | | 72 | 57 | 48 | 56 |
| 4 | 140 | | 62 | 76 | | | |
| 7 | | | 65 | | 63 | 53 | 58 |
| 14 | | | 65 | 150 | | 59 | 64 |
| 21 | | | | | 72 | 62 | 66 |
| 28 | | | 68 | | 74 | 64 | 67 |
| Comment: | Too | Too | V. | Too | V. | V. | V. |
| | high | high | good | high | good | good | good |

Speed of rotation setting 4

| | | | | | | | |
|---|---|---|---|---|---|---|---|
| 0 | 47 | 29 | 19 | 29 | 23 | 17 | 19 |
| 1 | 98 | 43 | 22 | 42 | 24 | 19 | 23 |
| 2 | | 48 | | | 28 | | 26 |
| 3 | | | 29 | 53 | | 27 | |
| 4 | 150 | 67 | | | 35 | | 31 |
| 7 | | 86 | 35 | | 40 | 31 | 40 |
| 14 | | 150 | 42 | 140 | 46 | 37 | 45 |
| 28 | | | 46 | | 53 | 40 | 49 |
| Comment: | Too | Too | V. | Too | V. | V. | V. |
| | high | high | good | high | good | good | good |

In a manner similar to the results enlisted above in The Table 1, the Table 3 above identifies the viscosity of silicate-based interior paint stabilized with a number of stabilizers. As may be seen, the composition without stabilizer is noted to yield abnormally high viscosity. Additionally, high viscosity was also found for the aqueous coating having ethylenediamine-based stabilizers such as LOP 827 and BQ40. On the other hand, N,N,N′,N′-tetraalkyl-alkylenediammonium hydroxide (CQT) was considered as standard for comparison. As can be observed from the Table 3 above, the use of ionic liquids as stabilizer leads to achieving aqueous coating compositions that attain stability within 4 weeks. In fact, imidazolinium-type, ammonium-type and phosphonium-type ionic liquids (FS01, BC01 and Cyp 169) were found to be effective in stabilizing viscosity in spite varying shear rates, such that the compositions had a viscosity in the range of 30 to 80 SKT, after 3 weeks of measurement. Further, the variation in viscosity on 28^{th} day versus the viscosity measured at 0 day was also found to be remarkably minimal.

The results from the above Tables 1-3 clearly identify wide applicability of the ionic liquids, i.e., the ionic liquids are useful as stabilizers irrespective of the type of coating composition being formulated. The person skilled in the art would thus find it reasonable to incorporate the ionic liquids as part of other paint or coating compositions not listed herein.

### Example 2: Testing the Compatibility of Stabilizer with Dispersant

As mentioned above, the compatibility of stabilizer with ingredients is critical. Incompatibility with the dispersant may result in unwanted high viscosity, rendering the composition ineffective.

In a standard dispersion silicate paint formulation recipe (refer Table 4 below) relative amounts of organic and inorganic binders, white pigment and fillers were kept constant. Fluctuating volumes of additives were compensated by differing water additions at end to come to same overall weight of samples. Polyacrylic dispersants and ammonium stabilizers were exchanged to test for their different interference behavior and to see efficiency differences of stabilizing in-can viscosity.

TABLE 4
(values in grams)-

| | | | | | Present |
|---|---|---|---|---|---|
| | | | | Present | invention |
| Function/ | | | Std- | invention | FS01 |
| Recipe | | | CQT | FS01 | dbl |
| 1 | Mixing water | Water | 70.0 | 70.0 | 70.0 |
| 2 | Thickener | Walocel CRT10000 | 1.0 | 1.0 | 1.0 |
| | | PA | | | |
| | | Rheovis PU 1256 | 0.3 | 0.3 | 0.3 |
| | | Σ | 71.3 | 71.3 | 71.3 |
| 3 | Dispersant | Dispex AA4040 | 2.0 | | |
| | | Melpers 0045 | | | 2.0 |
| | | Melpers 2454 | | 2.0 | |
| 4 | Stabilizer | Cycloquart | 1.5 | | |
| | | B.FS01 | | 1.5 | 3.0 |
| 5 | White pigment | Kronos 2056 | 20.0 | 20.0 | 20.0 |
| 6 | Dispersion | Acronal S559 | 22.0 | 22.0 | 22.0 |
| 7 | Antifoamer | Foamaster MO | 1.0 | 1.0 | 1.0 |
| | | 2114 | | | |
| 8 | Coarse filler | Polcarb 32 | 42.0 | 42.0 | 42.0 |
| 9 | Inorg. Binder | Trasol KW-N | 30.0 | 30.0 | 30.0 |
| 10 | Co-Binder | Levasil 200/40 | 10.0 | 10.0 | 10.0 |
| 11 | Fine filler | Polcarb 90 | 25.0 | 25.0 | 25.0 |
| 12 | Fine filler | Imextend 90 | 10.0 | 10.0 | 10.0 |
| | (additional) | | | | |
| | | Argiric Kaolin B24 | 10.0 | 10.0 | 10.0 |
| | Remaining | H2O | 5.2 | 5.2 | 5.2 |
| | water | | | | |
| | Sum/Total (in | | 250.0 | 250.0 | 251.5 |
| | grams) | | | | |

Lab paint sample mixtures were admixed with a lab disperser in sequence of recipe into 200 ml PE cups, homogenized at end for 5 minutes. Sample in PE cups were capped to avoid any loss of solvent-water. Viscosity of samples were checked with a Haake Rotovisco with anchor probe at two different speeds of rotation over a period of 4 weeks at room temperature. Coating compositions are noted to reveal an increase in viscosity over a period of four weeks post preparation.

Subsequently, the viscosity of the compositions was measured as mentioned in example 1 above (refer table 5 below).

TABLE 5
viscosity measurement

| | | | |
|---|---|---|---|
| Measurement/ | | Present | Present |
| Storage time | | invention | invention B- |
| (days) | Std-CQT | B-FS01 | FSdbl |

Rotation speed Setting 1

| | | | |
|---|---|---|---|
| 0 | 29 | 24 | 27 |
| 1 | 38 | 29 | 29 |
| 2 | 50 | 37 | 30 |
| 3 | 60 | 43 | 30 |
| 7 | 69 | 66 | 30 |
| 14 | 72 | 77 | 31 |
| 21 | 72 | 77 | 35 |
| 27 | 70 | 74 | 37 |
| 28 | 71 | 75 | 37 |
| Comment | Good | Good | V. Good |

Rotation speed setting 4

| | | | |
|---|---|---|---|
| 0 | 19 | 13 | 15 |
| 1 | 25 | 17 | 17 |
| 2 | 36 | 25 | 17 |
| 3 | 44 | 34 | 17 |
| 7 | 49 | 53 | 17 |
| 14 | 52 | 59 | 19 |
| 21 | 52 | 57 | 23 |
| 28 | 50 | 55 | 27 |
| Comment | V. Good | V. Good | V. Good |

As can be observed from the results enlisted in the Table 5 above, the ionic liquid (FS01) indicated an ability to stabilize viscosity of the composition, such that the viscosity of the composition was in the range of 30 to 80 SKT, after 3 weeks of measurement. However, the stabilization was found to be comparable to the tetraalkylammonium hydroxide standard (CQT).

Furthermore, the ionic liquid of the presently claimed invention have the additional benefit of being usable in pure undiluted form, therefore minor increase in amounts may be sufficient in effecting desired viscosity changes in the composition. Herein, doubling of concentration of ionic liquid (i.e. from 1.5 g to 3 g in 250 g sample; FS01 dbl) was found to result in a composition that had a negligible increase in viscosity (about 15 SKT to about 27 SKT). The results clearly indicated an existence of synergism between the ionic liquids (ammonium-type; FS01) and dispersant (alkoxylated polycarboxylate).

### Example 3: Testing the Compatibility of Stabilizer with Filler

Similar to the example 2 above, the compatibility of stabilizer with filler was tested. In standard silicate paint composition recipes (refer Table 6 below) dispersing agents, white pigment and relative amounts of agents were kept constant. Fluctuating volumes of additives were compensated by differing water additions at end to come to same overall weight of samples. Fillers were exchanged to test for their different interference behavior and to see efficiency differences of stabilizers.

### Example 3A—Composition Comprising Kaolin

TABLE 6
(values in grams)-

| | | | | | | | | B- | |
|---|---|---|---|---|---|---|---|---|---|
| | | | | | | | B- | FS01 | |
| Function/Ingredients | | | CQT | Q44 | Q40 | TrP | FS01 | dbl | Lop827 |
| 1 | Mixing water | Water | 70 | 70 | 70 | 70 | 70 | 70 | 70 |
| 2 | Thickener | Walocel CRT | 1.5 | 1.5 | 1.5 | 1.5 | 1.5 | 1.5 | 1.5 |
| | | 10000G | | | | | | | |
| | | Σ | 71.5 | 71.5 | 71.5 | 71.5 | 71.5 | 71.5 | 71.5 |
| 3 | Dispersant | Dispex Ultra | 2 | 2 | 2 | 2 | 2 | 2 | 2 |
| | | FA4404 | | | | | | | |
| 4 | Stabilizer | Cycloquart | 1 | | | | | | |
| | | Betolin | | 3 | | | | | |
| | | Quat44 | | | | | | | |
| | | Betolin | | | 3 | | | | |
| | | Quat40 | | | | | | | |
| | | Trilon P | | | | 3 | | | |
| | | B-FS01 | | | | | 1.2 | 2.5 | |
| | | Lopon 827 | | | | | | | 3 |
| 5 | White | Kronos 2056 | 15 | 15 | 15 | 15 | 15 | 15 | 15 |
| | pigment | | | | | | | | |
| 6 | Org. Binder | Acronal 6292 | 25 | 25 | 25 | 25 | 25 | 25 | 25 |
| 7 | Anti-foamer | Foamaster | | | | | | | |
| | | MO 2114 | | | | | | | |
| | | Foamaster | 1 | 1 | 1 | 1 | 1 | 1 | 1 |
| | | MO 2150 | | | | | | | |
| 8 | Coarse filler | PolCrb 32 | 60 | 60 | 60 | 60 | 60 | 60 | 60 |
| 9 | Inorg. Binder | Trasol KW-N | 40 | 40 | 40 | 40 | 40 | 40 | 40 |
| 10 | Fine filler | PolCarb 90 | 15 | 15 | 15 | 15 | 15 | 15 | 15 |
| | | Sylowhite | 5 | 5 | 5 | 5 | 5 | 5 | 5 |
| | | SM405 Grace | | | | | | | |
| | | Argiric B24 | 5 | 5 | 5 | 5 | 5 | 5 | 5 |
| | | Kaolin | | | | | | | |
| | | Siliplast 910 | 5 | 5 | 5 | 5 | 5 | 5 | 5 |
| 11 | Remaining | water | 4.5 | 2.5 | 2.5 | 2.5 | 4.3 | 3 | 2.5 |
| | Water | | | | | | | | |

| | | | | | | | |
|---|---|---|---|---|---|---|---|
| Sum/Total (in grams) | 250 | 250 | 250 | 250 | 250 | 250 | 250 |

The compatibility of stabilizers was tested for aqueous coating compositions comprising kaolin fillers refer Table 7 below.

TABLE 7
viscosity measurement

| | | | | | | | |
|---|---|---|---|---|---|---|---|
| | | | | | | Present | Present |
| Measurement/Storage | | | | | | invention | invention |
| (days) | Std. CQT | Q44 | Q40 | TrP | Lop827 | FS01 | FS01 dbl |

Rotation speed setting 1

| | | | | | | | |
|---|---|---|---|---|---|---|---|
| 0 | 65 | 63 | 62 | 117 | 71 | 66 | 60 |
| 1 | 62 | 66 | 150 | | | | |
| 2 | | | | 150 | 150 | 80 | 60 |
| 3 | 67 | 92 | | | | 87 | 60 |
| 4 | 72 | 102 | | | | | |
| 7 | 86 | 129 | | 146 | | 96 | 64 |
| 14 | 122 | 139 | | 128 | | 102 | 78 |
| 21 | | | | 121 | | 101 | 85 |
| 28 | 126 | 132 | | 119 | | 101 | 91 |
| Comment | Too High | Too High | Too High | Too high | Too High | High | Good |

Rotation speed setting 4

| | | | | | | | |
|---|---|---|---|---|---|---|---|
| 0 | 45 | 43 | 42 | 94 | 45 | 43 | 42 |
| 1 | 44 | 47 | 150 | | | | |
| 2 | | | | 130 | 142 | 52 | 40 |
| 3 | 43 | 60 | 145 | 128 | 150 | 58 | 40 |
| 4 | 46 | 73 | 137 | | | | |
| 7 | 63 | 96 | 150 | 103 | | 65 | 41 |
| 14 | 87 | 97 | | 87 | | 67 | 50 |
| 20 | | | | 83 | | 66 | 53 |
| 21 | 91 | | | | | | 54 |
| 28 | 92 | 94 | | 80 | | 66 | 58 |
| Comment | Good | Good | Too | V. | Too | V. | V. |
| | | | High | Good | High | Good | Good |

As can be seen from the results enlisted in Table 7 above, the measured viscosity of said compositions indicated surprising compatibility of ionic liquid (ammonium-type; FS1), wherein the viscosity of the composition was in the range of 30 to 80 SKT, after 3 weeks of measurement.

As noted above in Example 2, increase in concentration of ionic liquid to about 1% by weight (2.5 g in 250 g composition) was found to result in a remarkably better effect, such that the increase in viscosity after preparation was found to have a minimal increase (from about 42 SKT to about 58 SKT). The viscosity profile was found to resemble the standard compositions comprising 0.4% Cycloquart+0.5% Cycloquart-HS).

On the other hand, the usage of polyamine as stabilizer (Trilon P) yielded a yellowish composition. Additionally, the addition of Trilon P led to an immediate increase in viscosity. Without being bound by theory, it is suggested that there may be an interference of polymeric anionic ingredients (acrylates) with the polymeric-aminic compound (Trilon P). Therefore, the wide compatibility of ionic liquid with commonly used coating compositions is highlighted.

### Example 31B—Composition Comprising Kaolin

Calcite marble flower (Calplex) are quite inert and are suitable as fillers for silicate paints. Herein, the compatibility of stabilizers was tested for aqueous coating compositions comprising calcite fillers (refer Table 8 below).

TABLE 8
(values in grams)-

| Function/Ingredients | | | CQT | LopST | D. SPS | TrP | IonL | lonLdpl | Lop. 827 |
|---|---|---|---|---|---|---|---|---|---|
| 1 | Mixing water | water | 75 | 75 | 75 | 75 | 75 | 75 | 75 |
| 2 | Thickener | Walocel | 1.5 | 1.5 | 1.5 | 1.5 | 1.5 | 1.5 | 1.5 |
| | | CRT10000 | | | | | | | |
| 3 | Dispersant | Dispex | 2 | 2 | 2 | 2 | 2 | 2 | 2 |
| | | AA4040 | | | | | | | |
| | | Σ | 76.5 | 76.5 | 76.5 | 76.5 | 76.5 | 76.5 | 76.5 |
| 4 | Stabilizer | Cycloquart | 1 | | | | | | |
| | | LoponST, ICL | | 1 | | | | | |
| | | DispersogenSPS | | | 1.2 | | | | |
| | | Trilon P | | | | 3 | | | |
| | | B- FS01 | | | | | 1.5 | 3 | |
| | | Lopon827, ICL | | | | | | | 3 |
| 5 | White pigment | Kronos 2056 | 20 | 20 | 20 | 20 | 20 | 20 | 20 |
| 6 | Org. Binder | Acronal S559 | 20 | 20 | 20 | 20 | 20 | 20 | 20 |
| 7 | Anti-foamer | Foamaster | 1 | 1 | 1 | 1 | 1 | 1 | 1 |
| | | MO2114 | | | | | | | |
| 8 | Coarse filler | Calplex 5 | 45 | 45 | 45 | 45 | 45 | 45 | 45 |
| 9 | Inorg. Binder | Trasol KH-K | 40 | 40 | 40 | 40 | 40 | 40 | 40 |
| 10 | Fine filler | Calplex 2 | 25 | 25 | 25 | 25 | 25 | 25 | 25 |
| | | Calplex O | 10 | 10 | 10 | 10 | 10 | 10 | 10 |
| | | Plastorit | 5 | 5 | 5 | 5 | 5 | 5 | 5 |
| | | OOOO | | | | | | | |
| 11 | Remaining water | water | 4.5 | 4.5 | 4.3 | 2.5 | 4 | 2.5 | 2.5 |

| | | | | | | | |
|---|---|---|---|---|---|---|---|
| Sum/Total (in grams) | 250 | 250 | 250 | 250 | 250 | 250 | 250 |

Further, the viscosity of the composition was measured in a manner as described in the example 1 above (refer Table 9 below).

TABLE 9
viscosity measurement

| | | | | | | | |
|---|---|---|---|---|---|---|---|
| | | | | | | Present | Present |
| Measurement/Storage | Std. | | | | | invention | invention |
| (days) | CQT | LopST | D. SPS | TrP | Lop 827 | FS01 | FS01 dbl |

Rotation speed setting 1

| | | | | | | | |
|---|---|---|---|---|---|---|---|
| 0 | 39 | 39 | 42 | 55 | 39 | 39 | 38 |
| 1 | 39 | 41 | 41 | 50 | 45 | 41 | 41 |
| 2 | 41 | 42 | 42 | | | | |
| 3 | | | | 54 | 49 | 42 | 42 |
| 4 | 42 | 43 | 43 | | | | |
| 7 | 46 | 45 | 45 | 69 | 61 | 44 | 42 |
| 14 | 55 | 55 | 55 | 90 | 91 | 52 | 48 |
| 22 | 67 | 69 | 67 | 94 | 98 | 67 | 55 |
| 28 | 69 | 74 | 69 | 90 | 102 | 71 | 57 |
| Comment | V. Good | V. Good | V. Good | Good | Too High | V. Good | V. Good |

Rotation speed setting 4

| | | | | | | | |
|---|---|---|---|---|---|---|---|
| 0 | 18 | 18 | 21 | 32 | 21 | 18 | 17 |
| 1 | 19 | 21 | 21 | 27 | 22 | 20 | 20 |
| 2 | 20 | 21 | 20 | | | | |
| 3 | | | | 39 | 27 | 21 | 20 |
| 4 | 20 | 21 | 21 | | | | |
| 7 | 24 | 22 | 21 | 42 | 34 | 21 | 21 |
| 14 | 31 | 29 | 29 | 59 | 59 | 27 | 25 |
| 22 | 40 | 43 | 41 | 59 | 65 | 41 | 29 |
| 28 | 41 | 45 | 41 | 57 | 70 | 42 | 30 |
| Bemerkung: | V. | V. | V. | V. | V. | V. | V. |
| | Good | Good | Good | Good | Good | Good | Good |

As can be seen from the results enlisted in the Table 9 above, the measured viscosity of said compositions indicated surprising compatibility of ionic liquid (ammonium-type; FS01), wherein the viscosity of the composition was in the range of 30 to 80 SKT, after 3 weeks of measurement. Tetraalkylammonium hydroxide was considered as standard (Cycloquart, Dispersogen SPS and Lopon ST).

Ionic liquid (FS01) was found to be similar to the standard bis-quaternary ammonium hydroxide solutions at same amount of dosage in formula. Furthermore, as noted above, by increasing the concentration of ionic liquid, the viscosity levels could be reduced. Since ionic liquids can be added to compositions in pure undiluted form, even low concentrations may be enough to effect a required change in viscosity. Herein, an addition of 3 g ionic liquid, i.e. FS01 dbl (per 250 g composition) was found yield a composition, wherein the viscosity showed a minor increase from about 38 SKT (at day 0) to 57 SKT (at day 28).

As can be seen from the Tables 1-9 above, ionic liquids perform admirably in comparison to the standard tetraalkyl ammonium hydroxide stabilizers and are able to stabilize the viscosity of composition, such that the viscosity is in the range of 30 to 80 SKT, after 3 weeks of measurement. However, the ionic liquids of the presently claimed invention, are non-hazardous and also possess the ability to be processed in pure undiluted form, thus enhancing their industrial applicability.

1.-26. (canceled)

27. A method for stabilizing the viscosity of an aqueous coating composition comprising at least one silicate binder and at least one white pigment, wherein the method comprises at least the step of adding to the aqueous coating composition, at least one ionic liquid selected from the group consisting of:
(IL1) salts of the general formula (I)
[A]ₚ^{m+}[Y]_{q}ⁿ⁻ (I),
wherein
m, n, p, and q are each 1, 2, 3, or 4 and the product of p and m is equal to the product of q and n;
[A]^{m+} is
i) a monovalent, divalent, trivalent, or tetravalent cation selected from ammonium groups, oxonium groups, sulfonium groups, and phosphonium groups;
or
ii) a cationic compound comprising two or more cationic groups which are selected independently from ammonium groups, oxonium groups, sulfonium groups, and phosphonium groups; and
[Y]ⁿ⁻ is a monovalent, divalent, trivalent, or tetravalent anion or a mixture of these anions;
(IL2) mixed salts of the general formulae (II.a), (II.b) or (II.c)
[A¹]⁺[A²]⁺[Y]ⁿ⁻ (II.a),
wherein n=2,
[A¹]⁺[A²]⁺[A³]⁺[Y]ⁿ⁻ (II.b),
wherein n=3,
[A¹]⁺[A²]⁺[A³]⁺[A⁴]⁺[Y]ⁿ⁻ (II.c),
wherein n=4, and
wherein [A¹]⁺, [A²]⁺, [A³]⁺ and [A⁴]⁺ are monovalent cations selected from [A]^{m+}; and [Y]ⁿ⁻ is a monovalent, divalent, trivalent, or tetravalent anion or a mixture of these anions;
(IL3) mixed salts of the general formulae (III.a) to (III.h)
[A¹]²⁺[A²]⁺[Y]ⁿ⁻ (III.a),
wherein n=3,
[A¹]²⁺[A²]⁺[A³]⁺[Y]ⁿ⁻ (III.b),
wherein n=4,
[A¹]²⁺[A⁴]²⁺[Y]ⁿ⁻ (III.c),
wherein n=4,
[A5]3+[A2]+[Y]n− (III.d),
wherein n=4,
[A1]2+[A2]+[A3]+[A6]+[Y]n− (III.e),
wherein n=5,
[A1]2+[A4]2+[A6]+[Y]n− (III.f),
wherein n=5,
[A5]3+[A2]+[A3]+[Y]n− (III.g),
wherein n=5,
[A7]4+[A2]+[Y]n− (III.h),
wherein n=5, and
wherein [A¹]²⁺, [A²]⁺, [A³]⁺, [A⁴]²⁺, [A⁵]³⁺, [A⁶]⁺, and [A⁷]⁴⁺ are monovalent, divalent, trivalent, or tetravalent cations selected from [A]^{m+}; and [Y]ⁿ⁻ is a monovalent, divalent, trivalent, or tetravalent anion or a mixture of these anions; and
(IL4) mixed salts of the general formulae (IV.a) to (IV.j)
[A¹]⁺[A²]⁺[A³]⁺[M¹]⁺[Y]ⁿ⁻ (IV.a),
wherein n=4,
[A1]+[A2]+[M1]+[M2]+[Y]n− (IV.b),
wherein n=4,
[A1]+[M1]+[M2]+[M3]+[Y]n− (IV.c),
wherein n=4,
[A1]+[A2]+[M1]+[Y]n− (IV.d),
wherein n=3,
[A1]+[M1]+[M2]+[Y]n− (IV.e),
wherein n=3,
[A1]+[M1]+[Y]n− (IV.f),
wherein n=2,
[A1]+[A2]+[M4]2+[Y]n− (IV.g),
wherein n=4,
[A1]+[M1]+[M4]2+[Y]n− (IV.h),
wherein n=4,
[A1]+[M5]3+[Y]n− (IV.i),
wherein n=4,
[A1]+[M4]2+[Y]n− (IV.j),
wherein n=3, and
wherein [A¹]⁺, [A²]⁺, and [A³]⁺ are monovalent, divalent, trivalent, or tetravalent cations selected from [A]^{m+}; [Y]ⁿ⁻ is a monovalent, divalent, trivalent, or tetravalent anion or a mixture of these anions; and [M¹]⁺, [M²]⁺, and [M³]⁺ are monovalent metal cations, [M⁴]²⁺ are divalent metal cations and [M⁵]³⁺ are trivalent metal cations.

28. The method according to claim 27, wherein m, n, p, and q are each 1, 2, 3, or 4 and the product of p and m is equal to the product of q and n; and [A]^{m+} is a monovalent, divalent, trivalent or tetravalent cation selected from ammonium groups, oxonium groups, sulfonium groups, and phosphonium groups.

29. The method according to claim 28, wherein m, n, p, and q are each 1, 2, 3, or 4 and the product of p and m is equal to the product of q and n; [A]^{m+} is a monovalent cation selected from ammonium groups, oxonium groups, sulfonium groups, and phosphonium groups.

30. The method according to claim 27, wherein [A]^{m+} is selected from the group consisting of compounds of the formulae (V.a) to (V.z), 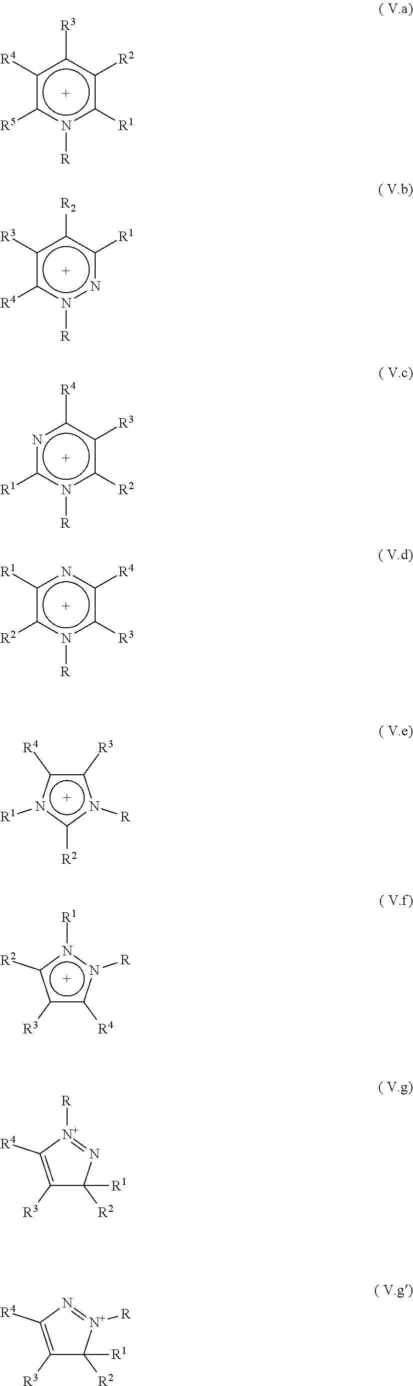 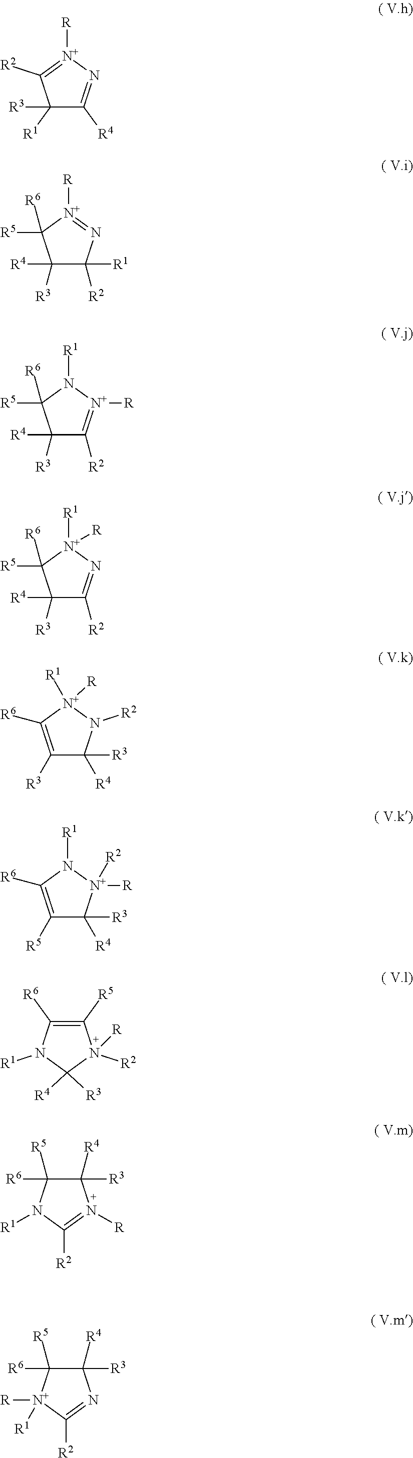 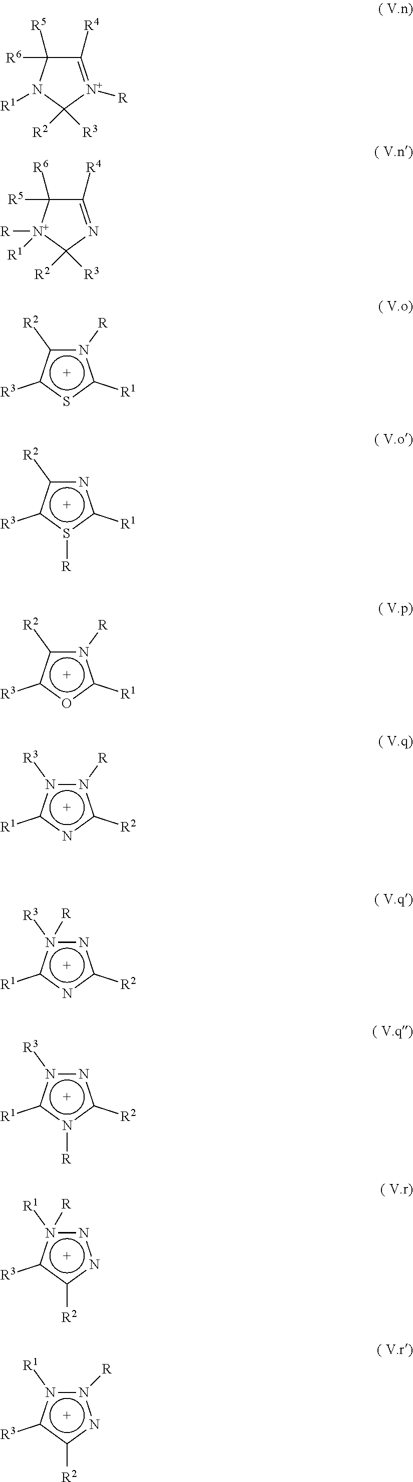 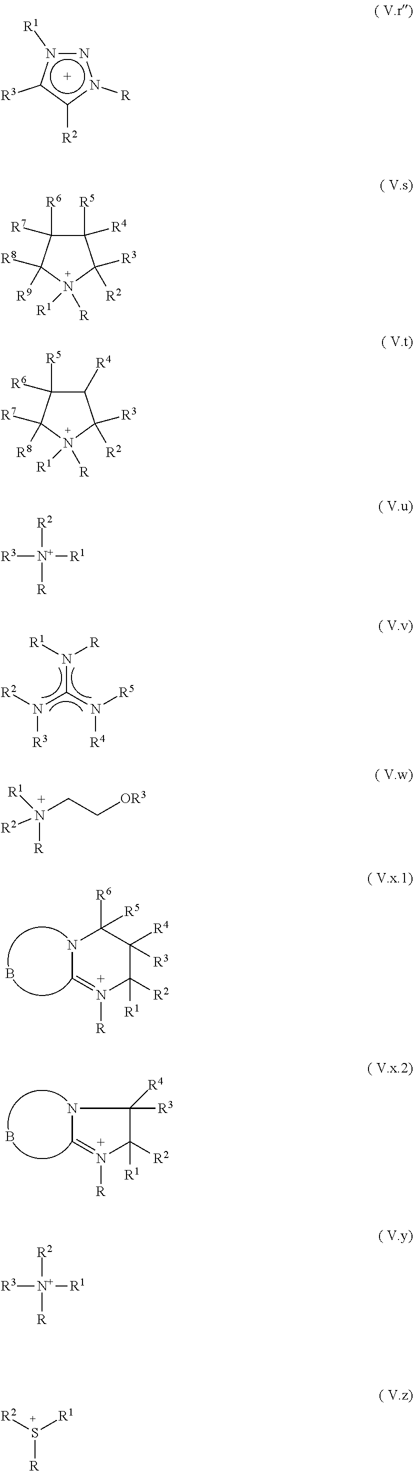
and oligomers comprising these structures, wherein
R is hydrogen, alkyl, alkenyl, cycloalkyl, cycloalkenyl, polycyclyl, heterocycloalkyl, aryl, or heteroaryl;
radicals R¹, R^{Z}, R³, R⁴, R⁵, R⁶, R⁷, R⁸ and R⁹ which are bound to a ring carbon are each, independently of one another, hydrogen, a sulfo group, COOH, carboxylate, sulfonate, acyl, alkoxycarbonyl, CO(NE¹E²), cyano, halogen, hydroxyl, SH, nitro, NE³E⁴, alkyl, alkoxy, alkylthio, alkylsulfinyl, alkylsulfonyl, alkenyl, cycloalkyl, cycloalkyloxy, cycloalkenyl, cycloalkenyloxy, polycyclyl, polycyclyloxy, heterocycloalkyl, aryl, aryloxy, or heteroaryl, wherein E¹, E², E³ and E⁴ are each, independently of one another, hydrogen, alkyl, cycloalkyl, heterocycloalkyl, aryl, or hetaryl,
radicals R¹, R², R³, R⁴, R⁵, R⁶, R⁷, R⁸ and R⁹ which are bound to a heteroatom are each, independently of one another, hydrogen, a sulfo group, NE¹E², sulfonate, alkyl, alkoxy, alkenyl, cycloalkyl, cycloalkenyl, polycyclyl, heterocycloalkyl, aryl, or heteroaryl,
wherein E¹ and E² are each, independently of one another, hydrogen, alkyl, cycloalkyl, heterocycloalkyl, aryl, or heteroaryl,
or
two adjacent radicals R¹ to R⁹ together with the ring atoms to which they are bound form at least one fused-on, saturated, unsaturated, or aromatic ring or a ring system having from 1 to 12 carbon atoms, wherein the ring or the ring system optionally has from 1 to 5 non-adjacent heteroatoms or heteroatom-comprising groups and the ring or the ring system is unsubstituted or substituted,
wherein two geminal radicals R¹ to R⁹ together are ═O, ═S or ═NR^{b}, wherein R^{b} is hydrogen, alkyl, cycloalkyl, aryl, or heteroaryl,
and
R¹ and R³ or R³ and R⁵ in the compounds of the formula (V.x.1) together represent the second bond of a double bond between the ring atoms bearing these radicals, or
the radicals R, R¹, R², R³, R⁴, R⁵, R⁶, R⁷, R⁸ and R⁹ are alkanediyl, cycloalkanediyl, alkenediyl or cycloalkenediyl which links a cation of one of the formulae (V.a) to (V.z) to a further cation of one of the formulae (V.a) to (V.z); wherein these radicals additionally function, via their second point of bonding, as radical R, R¹, R², R³, R⁴, R⁵, R⁶, R⁷, R⁸ or R⁹ of said further cation; and the radicals alkanediyl, cycloalkanediyl, alkenediyl and cycloalkenediyl are branched or linear, substituted and/or interrupted by at least one heteroatom or heteroatom-comprising group;
B in the compounds of the formulae (V.x.1) and (V.x.2) together with the C—N group to which it is bound forms a 4- to 8-membered saturated or unsaturated or aromatic ring which is optionally substituted and/or is optionally containing further heteroatoms or heteroatom-comprising groups and/or optionally comprise the further fused-on saturated, unsaturated or aromatic carbocycles or heterocycles.

31. The method according to claim 30, wherein [A]^{m+} is selected from the group consisting of compounds of the formulae (V.e), (V.u), (V.y) and (V.z), 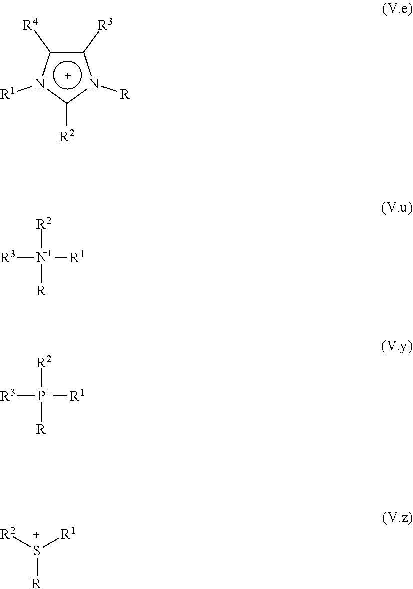
wherein R is hydrogen, alkyl, alkenyl, cycloalkyl, cycloalkenyl, polycyclyl, heterocycloalkyl, aryl, or heteroaryl;
radicals R², R³ and R⁴ which are bound to a ring carbon are each, independently of one another, hydrogen, a sulfo group, COOH, carboxylate, sulfonate, acyl, alkoxycarbonyl, CO(NE¹E²), cyano, halogen, hydroxyl, SH, nitro, NE³E⁴, alkyl, alkoxy, alkylthio, alkylsulfinyl, alkylsulfonyl, alkenyl, cycloalkyl, cycloalkyloxy, cycloalkenyl, cycloalkenyloxy, polycyclyl, polycyclyloxy, heterocycloalkyl, aryl, aryloxy, or heteroaryl, wherein E¹, E², E³ and E⁴ are each, independently of one another, hydrogen, alkyl, cycloalkyl, heterocycloalkyl, aryl, or hetaryl; and
radicals R¹, R² and R³ which are bound to a heteroatom are each, independently of one another, hydrogen, a sulfo group, NE¹E², sulfonate, alkyl, alkoxy, alkenyl, cycloalkyl, cycloalkenyl, polycyclyl, heterocycloalkyl, aryl, or heteroaryl, wherein E¹ and E² are each, independently of one another, hydrogen, alkyl, cycloalkyl, heterocycloalkyl, aryl, or hetaryl.

32. The method according to claim 31, wherein the radicals R, R¹, R² and R³ which are bound to a heteroatom are each, independently of one another, C₁-C₈-alkyl, or cycloalkyl, and the radicals R², R³ and R⁴ which are bound to a carbon atom are each hydrogen.

33. The method according to claim 32, wherein the radicals R, R¹, R² and R³ which are bound to a heteroatom are each, independently of one another, C₁-C₈-alkyl, or cycloalkyl, and the radicals R², R³ and R⁴ which are bound to a carbon atom are each hydrogen.

34. The method according to claim 30, wherein the compound of formula (V.e) is 1-ethyl-3-methylimidazolium.

35. The method according to claim 30, wherein the compounds of formula (V.y), are selected from the group consisting of tributylethylphosphonium, and tetrakis(hydroxymethyl)phosphonium.

36. The method according to claim 27, wherein the at least one ionic liquid contains 2 to 16 carbon atoms.

37. The method according to claim 27, wherein the at least one ionic liquid is selected from the group consisting of 1-ethyl-3-methylimidazolium acetate, methyltriethanolammonium methosulfate, tributylethylphosphonium diethylphosphate, bis(dimethylcyclohexylammonium) sulfate, and tetrakis(hydroxymethyl)phosphonium sulfate.

38. The method according to claim 27, wherein the at least one ionic liquid is present in an amount in the range from ≥0.05 wt. % to ≤5.0 wt. %, based on the total weight of the aqueous coating composition.

39. The method according to claim 27, wherein the at least one silicate binder is selected from the group consisting of colloidal silica, potassium silicate, sodium silicate, lithium silicate, and combinations thereof.

40. An aqueous coating composition comprising:
i) at least one ionic liquid selected from the group consisting of (IL1), (IL2), (IL3), and (IL4),
ii) at least one white pigment; and
iii) at least one silicate binder,
wherein
(IL1) salts of the general formula (I)
[A]ₚ^{m+}[Y]_{q}ⁿ⁻ (I),
wherein
m, n, p, and q are each 1, 2, 3, or 4 and the product of p and m is equal to the product of q and n;
[A]^{m+} is
i) a monovalent, divalent, trivalent, or tetravalent cation selected from ammonium groups, oxonium groups, sulfonium groups, and phosphonium groups;
or
ii) a cationic compound comprising two or more cationic groups which are selected independently from ammonium groups, oxonium groups, sulfonium groups, and phosphonium groups; and
[Y]ⁿ⁻ is a monovalent, divalent, trivalent, or tetravalent anion or a mixture of these anions;
(IL2) mixed salts of the general formulae (II.a), (II.b) or (II.c)
[A¹]⁺[A²]⁺[Y]ⁿ⁻ (II.a),
wherein n=2,
[A¹]⁺[A²]⁺[A³]⁺[Y]ⁿ⁻ (II.b),
wherein n=3,
[A¹]⁺[A²]⁺[A³]⁺[A⁴]⁺[Y]ⁿ⁻ (II.c),
wherein n=4, and
wherein [A¹]⁺, [A²]⁺, [A³]⁺ and [A⁴]⁺ is are monovalent cations selected from [A]^{m+}; and [Y]ⁿ⁻ is a monovalent, divalent, trivalent, or tetravalent anion or a mixture of these anions;
(IL3) mixed salts of the general formulae (III.a) to (III.h)
[A1]2+[A2]+[Y]n− (III.a),
wherein n=3,
[A1]2+[A2]+[A3]+[Y]n− (III.b),
wherein n=4,
[A1]2+[A4]2+[Y]n− (III.c),
wherein n=4,
[A5]3+[A2]+[Y]n− (III.d),
wherein n=4,
[A1]2+[A2]+[A3]+[A6]+[Y]n− (III.e),
wherein n=5,
[A1]2+[A4]2+[A6]+[Y]n− (III.f),
wherein n=5,
[A5]3+[A2]+[A3]+[Y]n− (III.g),
wherein n=5,
[A7]4+[A2]+[Y]n− (III.h),
wherein n=5, and
wherein [A¹]²⁺, [A²]⁺, [A³]⁺, [A⁴]²⁺, [A⁵]³⁺, [A⁶]⁺, and [A⁷]⁴⁺ are monovalent, divalent, trivalent, or tetravalent cations selected from [A]^{m+}; and [Y]ⁿ⁻ is a monovalent, divalent, trivalent, or tetravalent anion or a mixture of these anions; and
(IL4) mixed salts of the general formulae (IV.a) to (IV.j)
[A1]+[A2]+[A3]+[M1]+[Y]n− (IV.a),
wherein n=4,
[A1]+[A2]+[M1]+[M2]+[Y]n− (IV.b),
wherein n=4,
[A1]+[M1]+[M2]+[M3]+[Y]n− (IV.c),
wherein n=4,
[A1]+[A2]+[M1]+[Y]n− (IV.d),
wherein n=3,
[A1]+[M1]+[M2]+[Y]n− (IV.e),
wherein n=3,
[A1]+[M1]+[Y]n− (IV.f),
wherein n=2,
[A1]+[A2]+[M4]2+[Y]n− (IV.g),
wherein n=4,
[A1]+[M1]+[M4]2+[Y]n− (IV.h),
wherein n=4,
[A1]+[M5]3+[Y]n− (IV.i),
wherein n=4,
[A1]+[M4]2+[Y]n− (IV.j),
wherein n=3, and
wherein [A¹]⁺, [A²]⁺, and [A³]⁺ are monovalent, divalent, trivalent or tetravalent cations selected from [A]^{m+}; [Y]ⁿ⁻ is a monovalent, divalent, trivalent, or tetravalent anion or a mixture of these anions; and [M¹]⁺, [M²]⁺, and [M³]⁺ are monovalent metal cations, [M⁴]²⁺ are divalent metal cations and [M⁵]³⁺ are trivalent metal cations.

41. The aqueous coating composition according to claim 40, wherein [A]^{m+} is selected from the group consisting of compounds of the formulae (V.e), (V.u), (V.y) and (V.z), 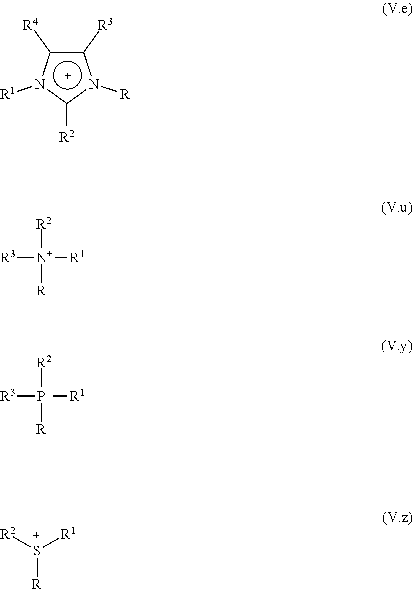
in which R is hydrogen, alkyl, alkenyl, cycloalkyl, cycloalkenyl, polycyclyl, heterocycloalkyl, aryl, or heteroaryl;
radicals R², R³ and R⁴ which are bound to a ring carbon are each, independently of one another, hydrogen, a sulfo group, COOH, carboxylate, sulfonate, acyl, alkoxycarbonyl, CO(NE¹E²), cyano, halogen, hydroxyl, SH, nitro, NE³E⁴, alkyl, alkoxy, alkylthio, alkylsulfinyl, alkylsulfonyl, alkenyl, cycloalkyl, cycloalkyloxy, cycloalkenyl, cycloalkenyloxy, polycyclyl, polycyclyloxy, heterocycloalkyl, aryl, aryloxy, or heteroaryl, wherein E¹, E², E³ and E⁴ are each, independently of one another, hydrogen, alkyl, cycloalkyl, heterocycloalkyl, aryl, or hetaryl; and
radicals R¹, R² and R³ which are bound to a heteroatom are each, independently of one another, hydrogen, a sulfo group, NE¹E², sulfonate, alkyl, alkoxy, alkenyl, cycloalkyl, cycloalkenyl, polycyclyl, heterocycloalkyl, aryl, or heteroaryl, wherein E¹ and E² are each, independently of one another, hydrogen, alkyl, cycloalkyl, heterocycloalkyl, aryl, or hetaryl.

42. The aqueous coating composition according to claim 40, wherein [Y]ⁿ⁻ is selected from anions of:
the group of sulfates, sulfites and sulfonates of the general formulae:
SO₄²⁻,HSO₄⁻,SO₃²⁻,HSO₃⁻,R^{c}OSO₃⁻,R^{c}SO₃⁻;
the group of phosphates of the general formulae:
PO₄³⁻,HPO₄²⁻,H₂PO₄⁻,R^{c}PO₄²⁻,HR^{c}PO₄⁻,R^{c}R^{d}PO₄⁻;
the group of carboxylates of the general formula:
R^{c}COO⁻;
wherein the radicals R^{c} and R^{d} are selected independently from each other from hydrogen, alkyl, cycloalkyl, heterocycloalkyl, aryl and heteroaryl.

43. The aqueous coating composition according to claim 40, wherein the at least one ionic liquid is selected from the group consisting of 1-ethyl-3-methylimidazolium acetate, methyltriethanolammonium methosulfate, tributylethylphosphonium diethylphosphate, bis(dimethylcyclohexylammonium) sulfate, and tetrakis(hydroxymethyl)phosphonium sulfate.

44. The aqueous coating composition according to claim 40, wherein the at least one ionic liquid is present in an amount in the range from ≥0.05 wt. % to ≤5.0 wt. %, based on the total weight of the aqueous coating composition.

45. The aqueous coating composition according to claim 40, wherein the halide content of the aqueous coating composition is in the range from 0.0001 to 0.1 wt. % based on the total weight of the aqueous coating composition.

46. The aqueous coating composition according to claim 40, wherein the aqueous coating composition further comprises at least one dispersant selected from the group of alkoxylated polycarboxylates.

47. The aqueous coating composition according to claim 40, wherein the aqueous coating composition further comprises at least one filler selected from the group consisting of natural calcium carbonate, calcite, marble, chalk, mica, feldspar, beryl, wollastonite, quartz, talc, kaolin, pozzolanic earth, calcium silicate, aluminum silicate, magnesium silicate, zinc silicate, barium sulfate, and combinations thereof.

48. The aqueous coating composition according to claim 40, wherein the at least one silicate binder is selected from the group consisting of colloidal silica, potassium silicate, sodium silicate, lithium silicate, and combinations thereof.

49. The aqueous coating composition according to claim 40, wherein the aqueous coating composition further comprises at least one anti-foaming agent selected from the group consisting of mineral oil, silicone oil, soyabean oil, linseed oil, palm oil, coconut oil, rapeseed oil, canola oil, rice bran oil, olive oil, and combinations thereof and the at least one anti foaming agent is present in an amount in the range from ≥0.08 wt. % to ≤1.0 wt. %, based on the total weight of the aqueous coating composition.

50. The aqueous coating composition according to claim 41, wherein the aqueous coating composition further comprises at least one organic binder selected from the group consisting of styrene acrylate, 2-ethylhexyl acrylate, n-butyl acrylate, ethyl acrylate, methyl acrylate, vinyl acrylate, vinylpropionate, and combinations thereof and the at least one organic binder is present in an amount in the range from ≥2.0 wt. % to ≤20.0 wt. %, based on the total weight of the aqueous coating composition.

51. The aqueous coating composition according to claim 40, wherein the aqueous coating composition further comprises an additive selected from the group consisting of viscosity regulator, hydrophobing agent, and combinations thereof.
